(19) United States
(12) Patent Application Publication
(10) Pub. No.: US 2021/0042635 A1
(43) Pub. Date: Feb. 11, 2021

(54) SEMANTIC OPERATIONS AND REASONING SUPPORT OVER DISTRIBUTED SEMANTIC DATA

(71) Applicant: CONVIDA WIRELESS, LLC, Wilmington, DE (US)

(72) Inventors: Xu LI, Plainsboro, NJ (US); Chonggang WANG, Princeton, NJ (US); Quang LY, North Wales, PA (US)

(21) Appl. No.: 16/975,522

(22) PCT Filed: Feb. 27, 2019
(86) PCT No.: PCT/US19/19743

§ 371 Date: Aug. 25, 2020

Related U.S. Application Data
(60) Provisional application No. 62/635,827, filed on Feb. 27, 2018.

(51) Int. Cl. G06N 5/02; G06N 5/04; G06F 16/36; G06F 16/955; G06F 40/30

(52) U.S. Cl. CPC G06N 5/025; G06N 5/022; G06F 40/30; G06F 16/367; G06F 16/955; G06N 5/04

(57) ABSTRACT

Methods, systems, and apparatuses address issues regarding semantic reasoning operations. Different customized or user-defined rules can be defined based on application needs, which may lead to different inferred facts, even if they are based on the same initial facts.

### CROSS-REFERENCE TO RELATED APPLICATIONS

This application claims the benefit of U.S. Provisional Patent Application No. 62/635,827, filed on Feb. 27, 2018, entitled “Semantic Operations and Reasoning Support Over Distributed Semantic Data,” the contents of which are hereby incorporated by reference herein.

### BACKGROUND

The Semantic Web is an extension of the Web through standards by the World Wide Web Consortium (W3C). The standards promote common data formats and exchange protocols on the Web, most fundamentally the Resource Description Framework (RDF). The Semantic Web involves publishing in languages specifically designed for data: Resource Description Framework (RDF), Web Ontology Language (OWL), and Extensible Markup Language (XML). These technologies are combined to provide descriptions that supplement or replace the content of Web documents via web of linked data. Thus, content may manifest itself as descriptive data stored in Web-accessible databases, or as markup within documents, particularly, in Extensible HTML (XHTML) interspersed with XML, or, more often, purely in XML, with layout or rendering cues stored separately.

The Semantic Web Stack illustrates the architecture of the Semantic Web specified by W3C, as shown in FIG. 1. The functions and relationships of the components can be summarized as follows. XML provides an elemental syntax for content structure within documents, yet associates no semantics with the meaning of the content contained within. XML is not at present a necessary component of Semantic Web technologies in most cases, as alternative syntaxes exist, such as Turtle. Turtle is the de facto standard but has not been through a formal standardization process.

XML Schema is a language for providing and restricting the structure and content of elements contained within XML documents.

RDF is a simple language for expressing data models, which refers to objects (“web resources”) and their relationships in the form of subject-predicate-object, e.g. S-P-O triple or RDF triple. An RDF-based model can be represented in a variety of syntaxes, e.g., RDF/XML, N3, Turtle, and RDFa. RDF is a fundamental standard of the Semantic Web.

RDF Graph is a directed graph where the edges represent the “predicate” of RDF triples while the graph nodes represent “subject” or “object” of RDF triples. In other words, the linking structure as described in RDF triples forms such a directed RDF Graph.

RDF Schema (RDFS) extends RDF and is a vocabulary for describing properties and classes of RDF-based resources, with semantics for generalized-hierarchies of such properties and classes.

OWL adds more vocabulary for describing properties and classes: among others, relations between classes (e.g. disjointness), cardinality (e.g. “exactly one”), equality, richer type of properties, characteristics of properties (e.g. symmetry), and enumerated classes.

SPARQL is a protocol and query language for semantic web data sources, to query and manipulate RDF graph content (e.g. RDF triples) on the Web or in an RDF store (e.g. a Semantic Graph Store).
SPARQL 1.1 Query, a query language for RDF graph, can be used to express queries across diverse data sources, whether the data is stored natively as RDF or viewed as RDF via middleware. SPARQL may include one or more of capabilities for querying required and optional graph patterns along with their conjunctions and disjunctions. SPARQL also supports aggregation, subqueries, negation, creating values by expressions, extensible value testing, and constraining queries by source RDF graph. The results of SPARQL queries can be result sets or RDF graphs.
SPARQL 1.1 Update, an update language for RDF graphs. It uses a syntax derived from the SPARQL Query Language for RDF. Update operations are performed on a collection of graphs in a Semantic Graph Store. Operations are provided to update, create, and remove RDF graphs in a Semantic Graph Store.

Rule is a notion in computer science: it is an IF-THEN construct. If some condition (the IF part) that is checkable in some dataset holds, then the conclusion (the THEN part) is processed. While ontology can describe domain knowledge, rule is another approach to describe certain knowledge or relations that sometimes is difficult or cannot be directly described using description logic used in OWL. A rule may also be used for semantic inference/reasoning, e.g., users can define their own reasoning rules.

RIF is a rule interchange format. In the computer science and logic programming communities, though, there are two different, but closely related ways to understand rules. One is closely related to the idea of an instruction in a computer program: If a certain condition holds, then some action is carried out. Such rules are often referred to as production rules. An example of a production rule is “If a customer has flown more than 100,000 miles, then upgrade him to Gold Member status.”

Alternately, one can think of a rule as stating a fact about the world. These rules, often referred to as declarative rules, are understood to be sentences of the form “If P, then Q.” An example of a declarative rule is “If a person is currently president of the United States of America, then his or her current residence is the White House.”

There are many rule languages including SILK, OntoBroker, Eye, VampirePrime, N3-Logic, and SWRL (declarative rule languages); and Jess, Drools, IBM ILog, and Oracle Business Rules (production rule languages). Many languages incorporate features of both declarative and production rule language. The abundance of rule sets in different languages can create difficulties if one wants to integrate rule sets, or import information from one rule set to another. Considered herein is how a rule engine may work with rule sets of different languages.

The W3C Rule Interchange Format (RIF) is a standard that was developed to facilitate ruleset integration and synthesis. It comprises a set of interconnected dialects, such as RIF Core, RIF Basic Logic Dialect (BLD), RIF Production Rule Dialect (PRD), etc. representing rule languages with various features. For example, the examples discussed below are based on RIF Core (which is the most basic one). The RIF dialect BLD extends RIF-Core by allowing logically-defined functions. The RIF dialect PRD extends RIF-Core by allowing prioritization of rules, negation, and explicit statement of knowledge base modification.

Below is the example of RIF. This example concern the integration of data about films and plays across the Semantic Web. Suppose, for example, that one wants to combine data about films from IMDb, the Internet Movie Data Base (at http://imdb.com) with DBpedia (at http://dbpedia.org). Both resources contain facts about actors being in the cast of films, but DBpedia expresses these facts as a binary relation (aka predicate or RDF property).

In DBpedia, for example, one can express the fact that an actor is in the cast of a film:
starring(?Film ?Actor)

where we use ‘?’-prefixed variables as placeholders. The names of the variables used in this example are meaningful to human readers, but not to a machine. These variable names are intended to convey to readers that the first argument of the DBpedia starring relation is a film, and the second an actor who stars in the film.

In IMDb, however, one does not have an analogous relation. Rather, one can state facts of the following form about actors playing roles:
playsRole(?Actor ?Role)
   and one can state facts of the following form about roles (characters) being in films:
roleInFilm(?Role ?Film)
   Thus, for example, in DBpedia, one represents the information that Vivien Leigh was in the cast of A Streetcar Named Desire, as a fact
starring(Streetcar VivienLeigh)
   In IMDb, however, one represents two pieces of information, that Vivien Leigh played the role of Blanche DuBois:
playsRole(VivienLeigh BlancheDubois)
   and that Blanche DuBois was a character in A Streetcar Named Desire:
roleInFilm(BlancheDubois Streetcar)

There is challenge in combining this data: not only do the two data sources (IMDb and DBpedia) use different vocabulary (the relation names starring, playsRole, roleInFilm), but the structure is different. To combine this data, we essentially want to say something like the following rule: If there are two facts in the IMDb database, saying that an actor plays a role/character, and that the character is in a film, then there is a single fact in the DBpedia database, saying that the actor is in the film. This aforementioned rule can be written as a RIF rule as follows (the words in bold are the key words defined by RIF and more details about RIF specification can be found in RIF Primer, https://www.w3.org/2005/rules/wiki/Primer):

```
Document(
  Prefix(rdf <http://www.w3.org/1999/02/22-rdf-syntax-ns#>)
  Prefix(rdfs <http://www.w3.org/2000/01/rdf-schema#>)
  Prefix(imdbrel <http://example.com/imdbrelations#>)
  Prefix(dbpedia <http://dbpedia.org/ontology/>)
    Group(
    Forall ?Actor ?Film ?Role (
      If  And(?Actor # imdbrel:Actor
        ?Film # imdbrel:Film
        ?Role # imdbrel:Character
        imdbrel:playsRole(?Actor ?Role)
        imdbrel:roleInFilm(?Role ?Film))
      Then dbpedia:starring(?Film ?Actor)
    )
  )
)
```

Semantic Reasoning. In general, semantic reasoning or inference means deriving facts that are not expressed in knowledge base explicitly. In other words, it is a mechanism to derive new implicit knowledge from existing knowledge base. Example: The data set (as initial facts/knowledge) to be considered may include the relationship (Flipper is-a Dolphin—A fact about an instance). Note facts and knowledge may be used interchangeably herein. An ontology may declare that “every Dolphin is also a Mammal—A fact about a concept”. If a reasoning rule is stating that “IF A is an instance of class B and B is a subclass of class C, THEN A is also an instance of class C”, then by applying this rule over the initial facts in terms of a reasoning process, a new statement can be inferred: Flipper is-a Mammal, which is an implicit knowledge/fact derived based on reasoning, although that was not part of the initial facts, [W3C Semantic Inference, www.w3.org/standards/semanticweb/inference]. From the above example, it can be seen there are several key concepts that are involved with semantic reasoning:
1. Knowledge/fact base (fact and knowledge will be used interchangeably in this work)
2. Semantic reasoning rules and
3. Inferred facts.

The following sections give more details about knowledge base and semantic rules. To implement a semantic reasoning process for above example, a semantic reasoner may be used (Semantic Reasoner, https://en.wikipedia.org/wiki/Semantic reasoner). Typically, a semantic reasoner (reasoning engine, rules engine, or simply a reasoner), is a piece of software able to infer logical consequences from a set of asserted facts using a set of reasoning rules. There are some open-source semantic reasoners and a later section will give more details about an example reasoner provided by Apache Jena (https://jena.apache.org/documentation/inference/). In addition, semantic reasoning or inference normally refers to the abstract process of deriving additional information while semantic reasoner refers to a specific code object that performs the reasoning tasks.

Knowledge Base (KB) is a technology used to store complex structured and unstructured information used by a computer system [https://en.wikipedia.org/wiki/Abox][TBox, https://en.wikipedia.org/wiki/Tbox]. The constitution of KB has the following form:
Knowledge Base=ABox+TBox

The terms ABox and TBox are used to describe two different types of statements/facts. TBox statements describe a system in terms of controlled vocabularies, for example, a set of classes and properties (e.g., scheme or ontology definition). ABox are TBox-compliant statements about that vocabulary.
For example, ABox statements typically have the following form:
   A is an instance of B or John is a Person
In comparison, TBox statements typically have the following form, such as:
All Students are Persons or
There are two types of Persons: Students and Teachers (e.g., Students and Teachers are subclass of Persons)

In summary, TBox statements are associated with object-oriented classes (e.g., scheme or ontology definition) and ABox statements are associated with instances of those classes. In the previous example, the fact statement “Flipper isA Dolphin” is a Abox statement while “every Dolphin is also a Mammal” is a TBox statement.

Entailment is the principle that under certain conditions the truth of one statement ensures the truth of a second statement. There are different standard entailment regimes as defined by W3C, e.g., RDF entailment, RDF Schema entailment, OWL 2 RDF-Based Semantics entailment, etc. In particular, each entailment regime defines a set of entailment rules [https://www.w3.org/TR/sparql11-entailment/] and below is two of the reasoning rules (Rule 7 and Rule 11) defined by RDFS entailment regime [https://www.w3.org/TR/rdf-mt/#rules]:

Rule 7: IF aaa rdfs:subPropertyof bbb && uuu aaa yyy, THEN uuu bbb yyy

It means: IF aaa is the sub property of bbb, and uuu has the value of yyy for its aaa property, THEN uuu also have the value of yyy for its bbb property (Here, “aaa”, “uuu”, “bbb” are just variable names).

Rule 11: IF uuu rdfs:subClassOf vvv and vvv rdfs:subClassOf x, THEN uuu rdfs:subClassOf x

It means: IF uuu is the sub class of vvv and vvv is the sub class of x, THEN uuu is also the sub class of x.

When initiating a semantic reasoner in a semantic reasoning tool, it is often required to specify which entailment regime is going to be realized. For example, a semantic reasoner instance A could be a “RDFS reasoner” which will support the reasoning rules defined by RDFS entailment regime. As an example, assuming we have the following initial facts (described in RDF triples):

| | | |
|---|---|---|
| ex: dog | rdf: type | rdfs: Class |
| ex: mammal | rdf: type | rdfs: Class |
| ex: animal | rdf: type | rdfs: Class |
| ex: dog | rdfs: subClassOf | ex: mammal |
| ex: mammal | rdfs: subClassOf | ex: animal |

By inputting those facts into the semantic reasoner instance A, the following inferred fact can be derived using RDFS Rule 11 as introduced above:

| | | |
|---|---|---|
| ex: dog | rdfs: subClassOf | ex: animal |

Semantic Reasoning Tool Example: Jena Inference Support. The Jena inference is designed to allow a range of inference engines or reasoners to be plugged into Jena. Such engines are used to derive additional RDF assertions/facts which are entailed from some existing/base facts together with any optional ontology information and the rules associated with the reasoner.

The Jena distribution supports a number of predefined reasoners, such as RDFS reasoner or OWL reasoner (implementing a set of reasoning rules as defined by the corresponding entailment regimes as introduced in the previous section respectively), as well as a generic rule reasoner, which is a generic rule-based reasoner that supports “user-defined” rules.

The below code example illustrates how to use Jena API for a semantic reasoning task: Let us first create a Jena model (called rdfsExample in line 3, which is in fact the “initial facts” in this example) containing the statements that a property “p” is a subProperty of another property “q” (as defined in line 6) and that we have a resource “a” with value “foo” for “p” (as defined in line 7):

1. String NS = “urn:x-hp-jena:eg/”;
2. // Build a trivial example data set
3. Model rdfsExample = ModelFactory.createDefaultModel( );
4. Property p = rdfsExample.createProperty(NS, “p”);
5. Property q = rdfsExample.createProperty(NS, “q”);
6. rdfsExample.add(p, RDFS.subPropertyOf, q);
7. rdfsExample.createResource(NS+“a”).addProperty(p, “foo”);

Now all the initial facts are stored in variable rdfsExample. Then, we can create an inference model which performs RDFS inference over the initial facts with the following code:

8. InfModel inf=ModelFactory.createRDFSModel(rdfsExample);

As shown in line 8, a RDFS reasoner is created by using createRDFSModel( ) API and the input is the initial facts stored in the variable rdfsExample. Accordingly, the semantic reasoning process will be executed by applying the (partial) RDFS rule set onto the facts stored in rdfsExample and the inferred facts are stored in the variable inf.

We can check the inferred facts stored in the variable inf now. For example, we want to know the value of property q of resource a, which can be implemented with the following code:

9. Resource a = inf.getResource(NS+“a”);
10. System.out.println(“Statement: ” + a.getProperty(q));

The output will be:

11. Statement: [urn:x-hp-jena:eg/a, urn:x-hp-jena:eg/q, Literal<foo>]

As shown in line 11, the value of property q of resource a is “foo”, which is an inferred fact based on one of the RDFS reasoning rule: IF aaa rdfs:subPropertytyof bbb && uuu aaa yyy, THEN uuu bbb yyy (rule 7 of RDFS entailment rules). The reasoning process is as follows: for resource a, since the value of its property p is “foo” and p is the subProperty of q, then the value of property q of resource a is “foo”.

oneM2M. The oneM2M standard under development defines a Service Layer called “Common Service Entity (CSE)”. The purpose of the Service Layer is to provide “horizontal” services that can be utilized by different “vertical” M2M systems and applications. The CSE supports four reference points as shown in FIG. 2. The Mca reference point interfaces with the Application Entity (AE). The Mcc reference point interfaces with another CSE within the same service provider domain and the Mcc′ reference point interfaces with another CSE in a different service provider domain. The Mcn reference point interfaces with the underlying network service entity (NSE). An NSE provides underlying network services to the CSEs, such as device management, location services and device triggering.

CSE may include one or more of multiple logical functions called “Common Service Functions (CSFs)”, such as “Discovery” and “Data Management & Repository”. FIG. 3 illustrates some of the CSFs defined by oneM2M.

The oneM2M architecture enables the following types of Nodes:

Application Service Node (ASN): An ASN is a Node that contains one CSE and contains at least one Application Entity (AE). Example of physical mapping: an ASN could reside in an M2M Device.

Application Dedicated Node (ADN): An ADN is a Node that contains at least one AE and does not contain a CSE. There may be zero or more ADNs in the Field Domain of the oneM2M System. Example of physical mapping: an Application Dedicated Node could reside in a constrained M2M Device.

Middle Node (MN): A MN is a Node that contains one CSE and contains zero or more AEs. There may be zero or more MNs in the Field Domain of the oneM2M System. Example of physical mapping: a MN could reside in an M2M Gateway.

Infrastructure Node (IN): An IN is a Node that contains one CSE and contains zero or more AEs. There is exactly one IN in the Infrastructure Domain per oneM2M Service Provider. A CSE in an IN may contain CSE functions not applicable to other node types. Example of physical mapping: an IN could reside in an M2M Service Infrastructure.

Non-oneM2M Node (NoDN): A non-oneM2M Node is a Node that does not contain oneM2M Entities (neither AEs nor CSEs). Such Nodes represent devices attached to the oneM2M system for interworking purposes, including management.

Semantic Annotation. In oneM2M, the <semanticDescriptor> resource is used to store a semantic description pertaining to a resource. Such a description is provided according to ontologies. The semantic information is used by the semantic functionalities of the oneM2M system and is also available to applications or CSEs. In general, the <semanticDescriptor> resource (as shown in FIG. 4) is a semantic annotation of its parent resource, such as an <AE>, <container>, <CSE>, <group> resources, etc.

Semantic Filtering and Resource Discovery. Once the semantic annotation is enabled (e.g., the content in <semanticDescriptor> resource is the semantic annotation of its parent resource), the semantic resource discovery or semantic filtering can be supported. Semantic resource discovery is used to find resources in a CSE based on the semantic descriptions contained in the descriptor attribute of <semanticDescriptor> resources. In order to do so, an additional value for the request operation filter criteria has been disclosed (e.g., the “semanticsFilter” filter), with the definition shown in Table 1 below. The semantics filter stores a SPARQL statement (defining the discovery criteria/constraints based on needs), which is to be executed over the related semantic descriptions. “Needs” (e.g., requests or requirements) are often application driven. For example, there may be a request to find all the devices produced by manufacture A in a geographic area, A corresponding SPARQL statement may be written for this need. The working mechanism of semantic resource discovery is as follows: Semantic resource discovery is initiated by sending a Retrieve request with the semanticsFilter parameter. Since an overall semantic description (forming a graph) may be distributed across a set of <semanticDescriptor> resources, all the related semantic descriptions have to be retrieved first. Then the SPARQL query statement as included in the semantic filter will be executed on those related semantic descriptions. If certain resource URIs can be identified during the SPARQL processing, those resource URIs will be returned as the discovery result. Table 1 as referred to in [oneM2M-TS-0001 oneM2M Functional Architecture—V3.8.0]

TABLE 1
′semanticsFilter′ Condition Tag in filterCriteria

| | | |
|---|---|---|
| semanticsFilter | 0..n | The semantic description contained in one of the |
| | | <semanticDescriptor> child resources matches the |
| | | SPARQL statement as specified in this filter. |

Semantic Query. In general, semantic queries enable the retrieval of both explicitly and implicitly derived information based on syntactic, semantic and structural information contained in data (such as RDF data). The result of a semantic query is the semantic information/knowledge for answering/matching the query. By comparison, the result of a semantic resource discovery is a list of identified resource URIs. As an example, a semantic resource discovery is to find “all the resource URIs that represent temperature sensors in building A” (e.g., the discovery result may include the URIs of <sensor-1> and <sensor-2>) while a semantic query is to ask the question that “how many temperature sensors are in building A?” (e.g., the query result will be “2”, since there are two sensors in building A, e.g., <sensor-1> and <sensor-2>).

For a given semantic query, it may be executed on a set of RDF triples (called the “RDF data basis”), which may be distributed in different semantic resources (such as <semanticDescriptor> resources). The “query scope” associated with the semantic query is to decide which semantic resources should be included in the RDF data basis of this query.

Both semantic resource discovery and semantic query use the same semantics filter to specify a query statement that is specified in the SPARQL query language. When a CSE receives a RETRIEVE request including a semantics filter, if the Semantic Query Indicator parameter is also present in the request, the request will be processed as a semantic query; otherwise, the request shall be processed as a semantic resource discovery. In a semantic query process, given a received semantic query request and its query scope, the SPARQL query statement shall be executed over aggregated semantic information collected from the semantic resource(s) in the query scope and the produced output will be the result of this semantic query.

### SUMMARY

Conventional semantic reasoning may not be directly used in the context of SL-based platform due to new issues from a fact perspective (usually the facts are represented as semantic triples) and a reasoning rule perspective. From a fact perspective, data or facts are often fragmented or distributed in different places (e.g., RDF triples in the existing oneM2M <semanticDescriptor> resources). Disclosed herein are methods, systems, and apparatuses that may organize or integrate related “fact silos” in order to make inputs (e.g., fact sets) ready for a reasoning process. From a reasoning rule perspective, service layer (SL)-based platform is often supposed to be a horizontal platform that enables applications across different sections. Therefore, different customized or user-defined rules can be defined based on application needs, which may lead to different inferred facts (even if they are based on the same initial facts).

### BRIEF DESCRIPTION OF THE DRAWINGS

A more detailed understanding may be had from the following description, given by way of example in conjunction with the accompanying drawings wherein:

FIG. 1 illustrates an exemplary Architecture of the Semantic Web;

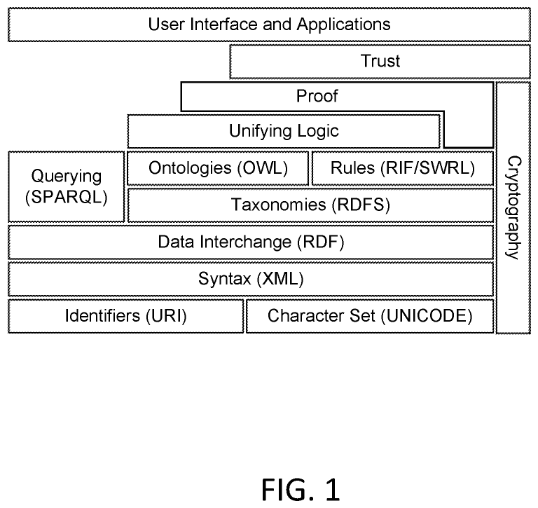

FIG. 2 illustrates an exemplary oneM2M Architecture;

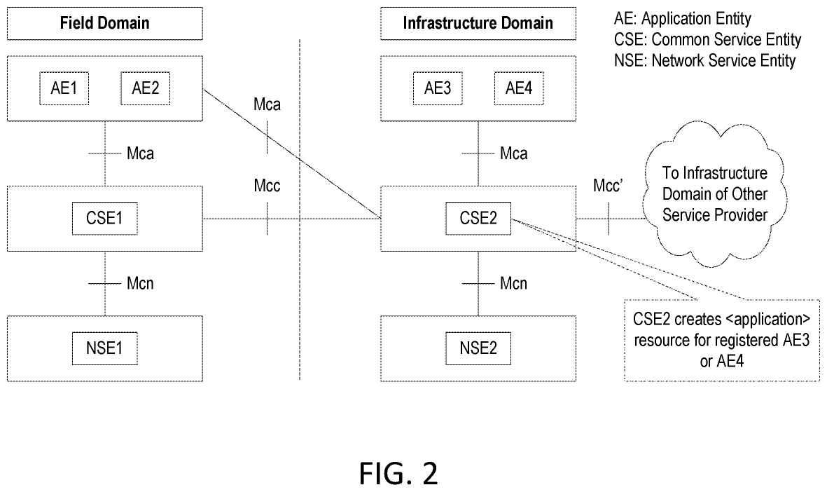

FIG. 3 illustrates an exemplary oneM2M Common Service Functions;

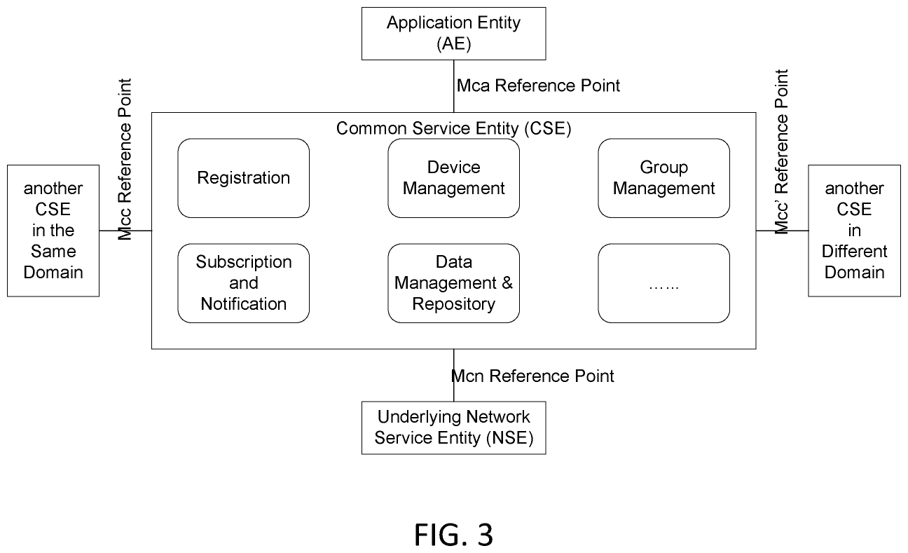

FIG. 4 illustrates an exemplary Structure of <semanticDescriptor> Resource;

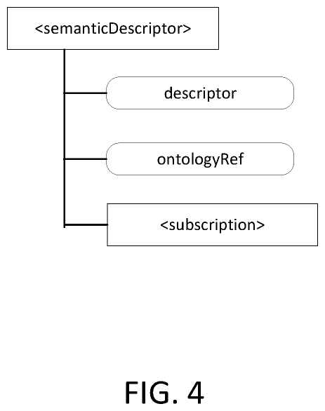

FIG. 5 illustrates an exemplary Intelligent Facility Management Use Case;

FIG. 6 illustrates exemplary Semantic Reasoning Components and Optimization with Other Semantic Operations;

FIG. 7 illustrates an exemplary The CREATE Operation for FS Publication;

FIG. 8 illustrates an exemplary The RETRIEVE Operation for FS Retrieval;

FIG. 9 illustrates an exemplary The UPDATE/DELETE Operation for FS Update/Deletion;

FIG. 10 illustrates an exemplary The CREATE Operation for RS Publication;

FIG. 11 illustrates an exemplary The RETRIEVE Operation for RS Retrieval;

FIG. 12 illustrates an exemplary The UPDATE/DELETE Operation for RS Update/Deletion;

FIG. 13 illustrates an exemplary An One-time Reasoning Triggered by RI;

FIG. 14 illustrates an exemplary Continuous Reasoning Triggered by RI;

FIG. 15 illustrates an exemplary Augmenting IDB Supported by Reasoning;

FIG. 16 illustrates an exemplary New Semantic Reasoning Service CSF for oneM2M Service Layer;

FIG. 17 illustrates an exemplary oneM2M Example for The Entities Defined for FS Enablement;

FIG. 18 illustrates an exemplary oneM2M Example for The Entities Defined for RS Enablement;

FIG. 19 illustrates an exemplary oneM2M Example for The Entities Involved in An Individual Semantic Reasoning Operation;

FIG. 20 illustrates an exemplary Alternative Example for The Entities Involved in An Individual Semantic Reasoning Operation;

FIG. 21 illustrates an exemplary oneM2M Example for The Entities Defined for Optimizing Semantic Operations with Reasoning Support;

FIG. 22 illustrates an exemplary Alternative Example for The Entities Defined for Optimizing Semantic Operations with Reasoning Support;

FIG. 23 illustrates an exemplary Alternative Example for Sematic Query with Reasoning Support Between ETSI CIM and oneM2M;

FIG. 24 illustrates an exemplary Structure of <facts> Resource;

FIG. 25 illustrates an exemplary Structure of <factRepository> Resource;

FIG. 26 illustrates an exemplary Structure of <reasoningRules> Resource;

FIG. 27 illustrates an exemplary Structure of <ruleRepository> Resource;

FIG. 28 illustrates an exemplary Structure of <semanticReasoner> Resource;

FIG. 29 illustrates an exemplary Structure of <reasoningRules> Resource;

FIG. 30 illustrates an exemplary Structure of <reasoningResult> Resource;

FIG. 31 illustrates an exemplary OneM2M Example of a One-time Reasoning Triggered by RI Disclosed in FIG. 13;

FIG. 32 illustrates an exemplary OneM2M Example of Continuous Reasoning Triggered by RI in FIG. 14;

FIG. 33A illustrates an exemplary OneM2M Example of Augmenting IDB Supported by Reasoning in FIG. 15;

FIG. 33B illustrates an exemplary OneM2M Example of Augmenting IDB Supported by Reasoning in FIG. 15;

FIG. 34 illustrates an exemplary user interface;

FIG. 35 illustrate exemplary features of semantic reasoning function (SRF);

FIG. 36 illustrates exemplary features of semantic reasoning function;

FIG. 37A illustrates an exemplary machine-to-machine (M2M) or Internet of Things (IoT) communication system in which the disclosed subject matter may be implemented;

FIG. 37B illustrates an exemplary architecture that may be used within the M2M/IoT communications system illustrated in FIG. 37A;

FIG. 37C illustrates an exemplary M2M/IoT terminal or gateway device that may be used within the communications system illustrated in FIG. 37A; and

FIG. 37D illustrates an exemplary computing system in which aspects of the communication system of FIG. 37A.

### DETAILED DESCRIPTION OF ILLUSTRATIVE EXAMPLES

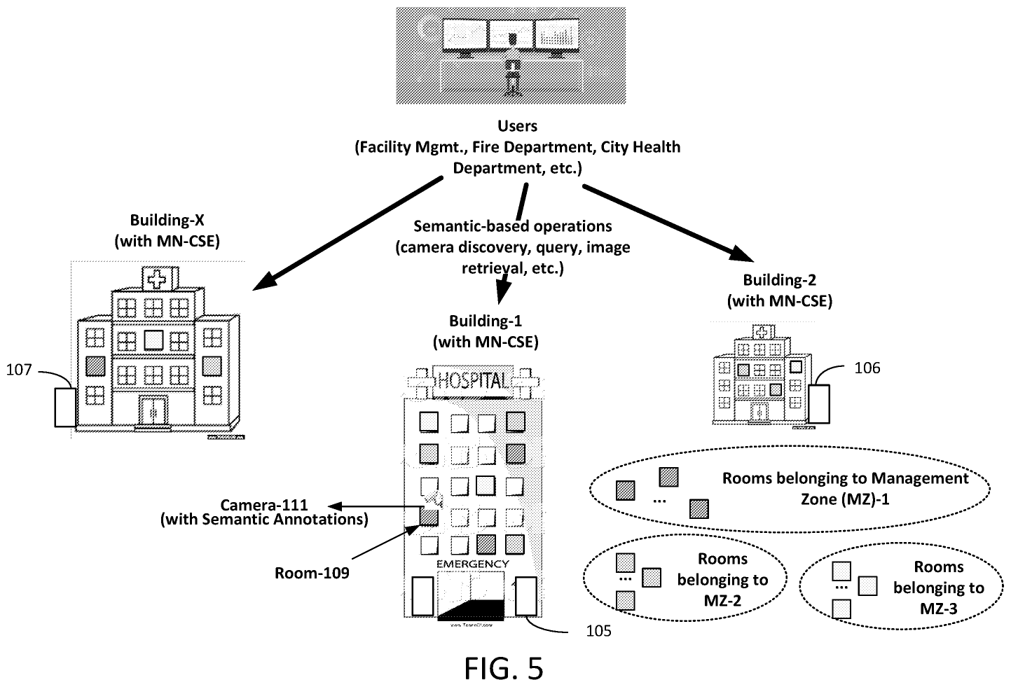

Consider an intelligent facilities management use case in the smart city scenario as shown in FIG. 5. A large hospital has built many buildings over the years. In order to enforce the surveillance and facility management purpose, the hospital also installed monitoring cameras in the rooms of those buildings. In particular, the hospital has adopted a SL-based platform (e.g., oneM2M). For example, each building (e.g., building 1, building 2, and building 3) hosts a MN-CSE (e.g., MN-CSE 105, MN-CSE 106, and MN-CSE 107) and each of the cameras deployed in building rooms registers to a corresponding MN-CSE of the building and has a SL resource representation. For example, Camera-111 deployed in Room-109 of Building-1 will have a <Camera-111> resource representation on MN-CSE 105 of Building-1, which for instance could be the <AE> type of resources as defined in oneM2M. In order to support semantics, <Camera-111> resource may be annotated with some metadata as semantic annotations. For example, some facts may be used to describe its device type and its location information, which are written as the following two RDF triples as an example:
Fact-1: Camera-111 is-a Camera (“Camera” is a concept/class defined by an ontology)
Fact-2: Camera-111 is-located-in Room-109-of-Building-1

For each concept in a domain, it corresponds to a class in its domain ontology. For example, in a university context, a teacher is a concept, and then “teacher” is defined as a class in the university ontology. Each camera may have a semantic annotation, which is stored in a semantic child resource (e.g., oneM2M <semanticDescriptor> resource). Therefore, semantic type of data may be distributed in the resource tree of MN-CSEs since different oneM2M resources may have their own semantic annotations.

The hospital integrates its facilities into the city infrastructure (e.g., as an initiative for realizing smart city) such that external users (e.g., fire department, city health department, etc.) may also manage, query, operate and monitor facilities or devices of the hospital.

In each hospital building, rooms are used for different purposes. For example, some rooms (e.g., Room-109) are to store blood testing samples while some other rooms are to store medical oxygen cylinders. Due to the different usages of rooms, the hospital has defined several “Management Zones (MZ)” and each zone includes a number of rooms. Note that, the division of MZs is not necessarily based on geographical locations, but may be based on usage purpose, among other things. For example, MZ-1 includes rooms that store blood-testing samples. Accordingly, those rooms will be more interested by city health department. In other words, city health department may request to access the cameras deployed in the rooms belonging to MZ-1. Similarly, MZ-2 includes rooms that store medical oxygen cylinders. Accordingly, the city fire department may be interested in those rooms. Therefore, city fire department may access the cameras deployed in rooms belonging to MZ-2. Rooms in each MZ may be changed over time due to room rearrangement or re-allocation by the hospital facility team. For example, Room-109 may belong to MZ-2 when it starts to be used for storing medical oxygen cylinders, e.g., not storing blood test samples any more.

Consider a scenario in which a potential user would like to retrieve real-time images from the rooms belonging to MZ-1. In order to do so, the user first does semantic resource discovery to identify those cameras using the following SPARQL Statement-1:

```
SELECT ?device
WHERE {
  ?device  is-a Camera
  ?device  monitors-room-inMZ-1
}
```

With the above in mind, there are potential issues that are addressed by this disclosure. Conventionally, during the resource discovery process, <Camera-111> resource will not be identified as a desired resource, although it should be included in the discovery result. The reason is that the fact “Device-1 is-located-in Room-109-of-Building-1” (which is the semantic annotation of <Camera-111>) cannot match the pattern in the SPARQL Statement-1 “?device monitors-room-in MZ-1”, although Camera-111 is really deployed in a room belonging to MZ-1. The issue comes from the fact that the conventional semantic annotation of the devices often includes low-level metadata such as physical locations, and does not include high-level metadata about MZ. However, a user may just be interested in rooms under a specific MZ (e.g., MZ-1) and not interested in the physical locations of those rooms. With reference to the above example, the user is just interested in images from cameras deployed in the rooms belonging to MZ-1 and the user does not necessarily interested in the physical room or building numbers. In fact, the user may not even know the room allocation information (e.g., which room is for which purpose, since this may be just internal information managed by the hospital facility team). With that said, reasoning or inference mechanisms may be used to address these issues. For example, with knowledge of the following reasoning rule:
Rule-1: IF A is-located-in B && B is-managed-under C, THEN A monitors-room-in C
   By using the Fact-1, Fact-2 and Rule-1, then we can infer a new fact:
Camera-111 monitors-room-in MZ-1

Such a new fact may be useful for answering the query shown in the SPARQL Statement-1 above.

Note that high-level query may not directly match low-level metadata, such a phenomenon is very common due to the usage of “abstraction” in many computer science areas in the sense that the query from upper-layer user is based on high-level concept (e.g., terminology or measurement) while low-layer physical resources are annotated with low-level metadata. As an example, when a user queries a file in the C: disk on a laptop, the operating system should locate the physical blocks of this file on the hard drive, which is fully transparent to the user.

Although there are some existing semantic reasoning tools available, they cannot be directly used in the context of SL-based platform due to new issues from a fact perspective and a reasoning rule perspective. From a fact perspective, data or facts are often fragmented or distributed in different places (e.g., RDF triples in the existing oneM2M <semanticDescriptor> resources). Therefore, an efficient way is disclosed herein to organize or integrate related “fact silos” in order to make inputs (e.g., fact sets) ready for a reasoning process. From a reasoning rule perspective, service layer (SL)-based platform is often supposed to be a horizontal platform that enables applications across different sections. Therefore, different customized or user-defined rules can be defined based on application requirements or requests, which may lead to different inferred facts (even if they are based on the same initial facts).

Below are a further description of the issues. A first issue, from a fact perspective, in many cases, the initial input facts may not be sufficient and additional facts may be further identified as inputs before a reasoning operation can be executed. This issue in fact gets deteriorated in the context of service layer since facts may be “distributed” in different places and hard to collect. A second issue, from a reasoning rule perspective, conventionally there are no methods for SL entities to define, publish (e.g., a rule or fact can be published in order to be shared by others) user-defined reasoning rules for supporting reasoning for various applications.

A third issue, conventionally, there are no methods for SL entities to trigger an “individual” reasoning process by specifying the facts and rules as inputs. However, reasoning may be required or requested since many applications may require semantic reasoning to identify implicit facts. For example, a semantic reasoning process may take the current outdoor temperature, humidity, or wind of the park and outdoor activity advisor related reasoning rule as two inputs. After executing a reasoning process, a “high-level inferred fact” can be yielded about whether it is a good time to do outdoor sports now. Such a high-level inferred fact can benefit users directly in the sense that users does not have to know the details of low-level input facts (e.g., temperature, humidity, or wind numbers). In another usage scenario, the inferred facts can also be used to augment original facts as well. For example, the semantic annotation of Camera-111 initially includes one triple (e.g., fact) saying that Camera-111 is-a A:digitalCamera, where A:digitalCamera is an class or concept defined by ontology A. Through a reasoning process, an inferred fact may be further added to the semantic annotation of Camera-111, such as Camera-111 is-a B:highResolutionCamera, where B:highResolutionCamera is a class/concept defined by another ontology B. With this augmentation, the semantic annotation of Camera-111 now has more rich information.

A fourth issue, conventionally, there is limited support for leveraging semantic reasoning as a “background support” to optimize other semantic operations (such as semantic query, semantic resource discovery, etc.). In this case, users may just know that they are initiating a specific semantic operation (such as a semantic query or a semantic resource discovery, etc.). However, during the processing of this operation, semantic reasoning may be triggered in the background, which is transparent to the users. For example, a user may initiate a semantic query for outdoor sports recommendations in the park now. The query may not be answered if the processing engine just has the raw facts such as current outdoor temperature, humidity, or wind data of the park, since the SPARQL query processing is based on pattern matching (e.g., the match usually has to be exact). In comparison, if those raw facts can be used to infer a high-level fact (e.g., whether it is a good time to do a sport now) through a reasoning, this inferred fact may directly answer user's query.

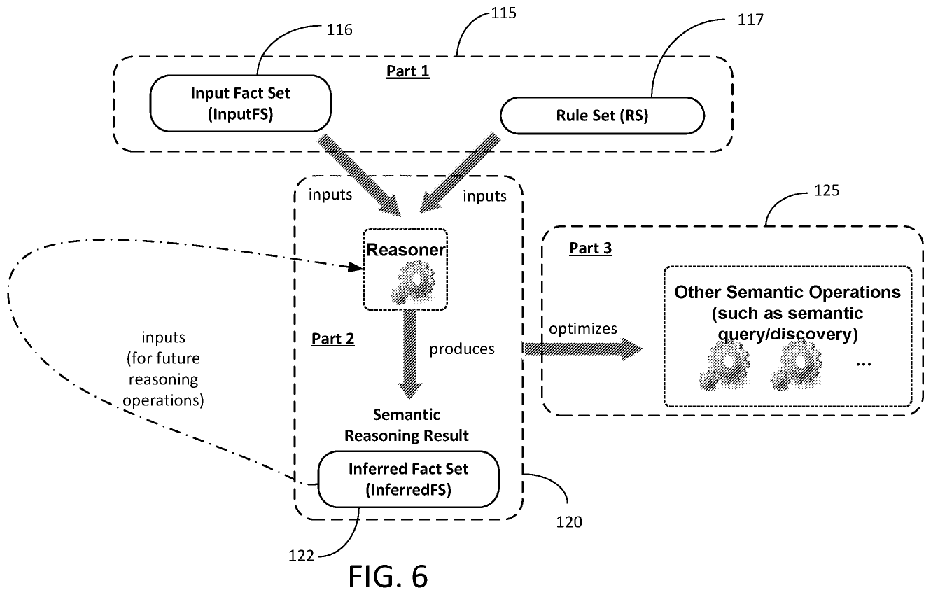

The existing service layer does not have the capability for enabling semantic reasoning, without which various semantic-based operations cannot be effectively operated. In order for semantic reasoning to be efficiently and effectively supported one or more of the semantic reasoning associated methods and systems disclosed herein should be implemented. In summary, with reference to FIG. 6, the methods and systems may involve the following three parts: 1) Block 115—enabling the management of semantic reasoning data (e.g., referring facts and rules); 2) Block 120—enabling individual semantic reasoning process; and 3) Block 125—optimizing other semantic operations with background reasoning support. Block 115 (part 1) focuses on how to enable the semantic reasoning data so that the fact set and rule set are available at the service layer. When the fact set (FS) and rule set (RS) are enabled and a semantic reasoner (SR) is enabled, then an individual semantic reasoning process may be initiated at Block 120 (part 2), in which an inferred result may be used again for input in future reasoning operations. Lastly, at block 125 (part 3), the disclosed semantic reasoning may be used to more efficiently and effectively execute semantic operations (e.g., semantic query, semantic resource discovery, semantic mashup, etc.). Each of the aforementioned methods and systems are disclosed in more detail herein.

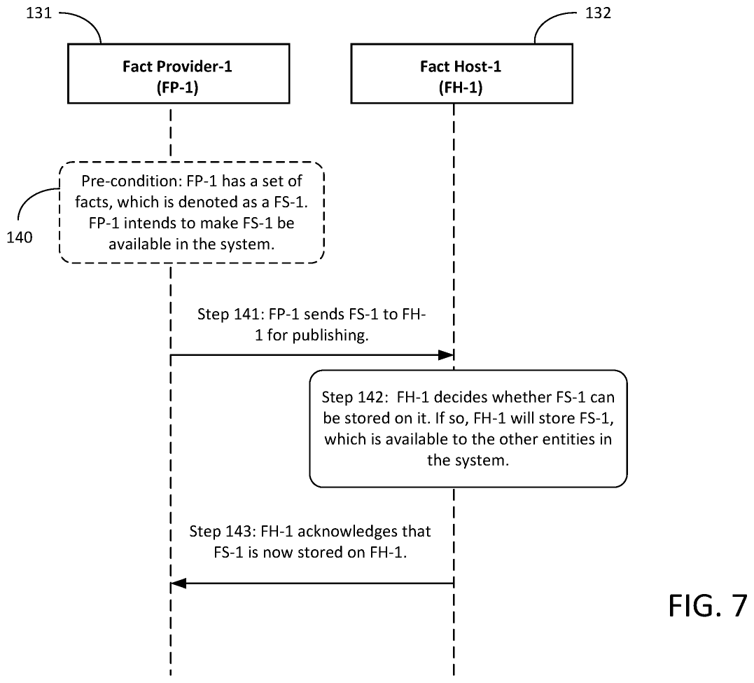

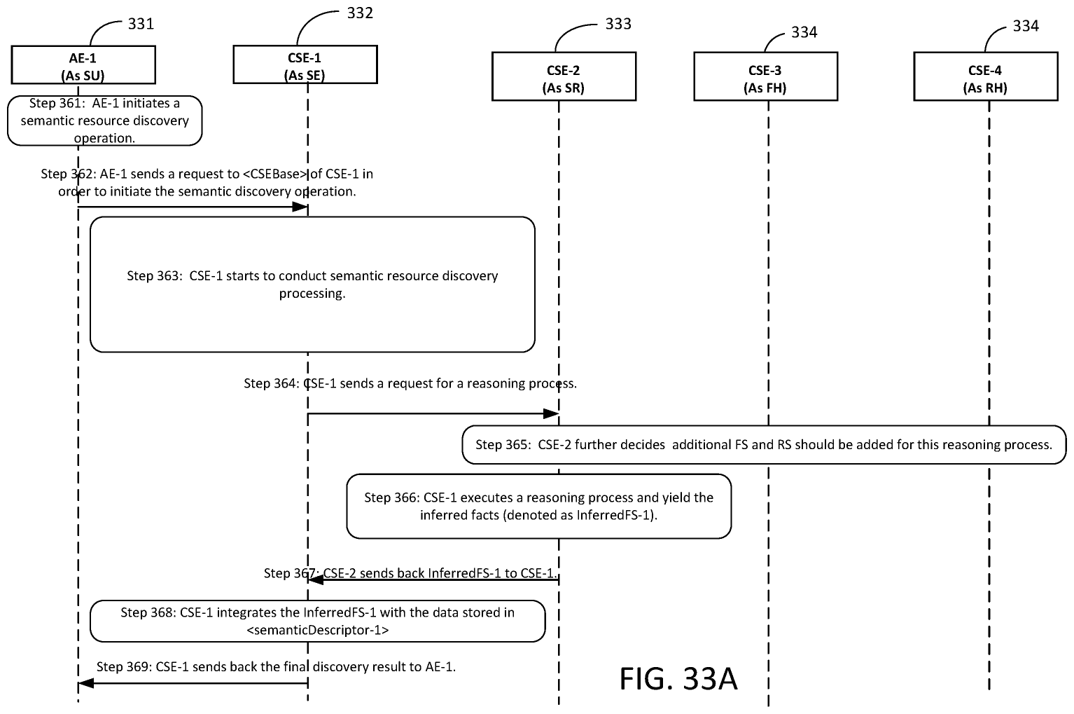

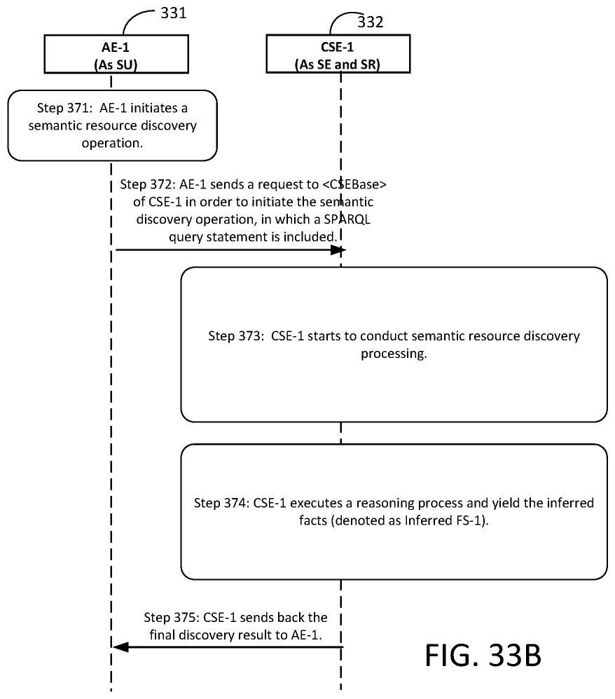

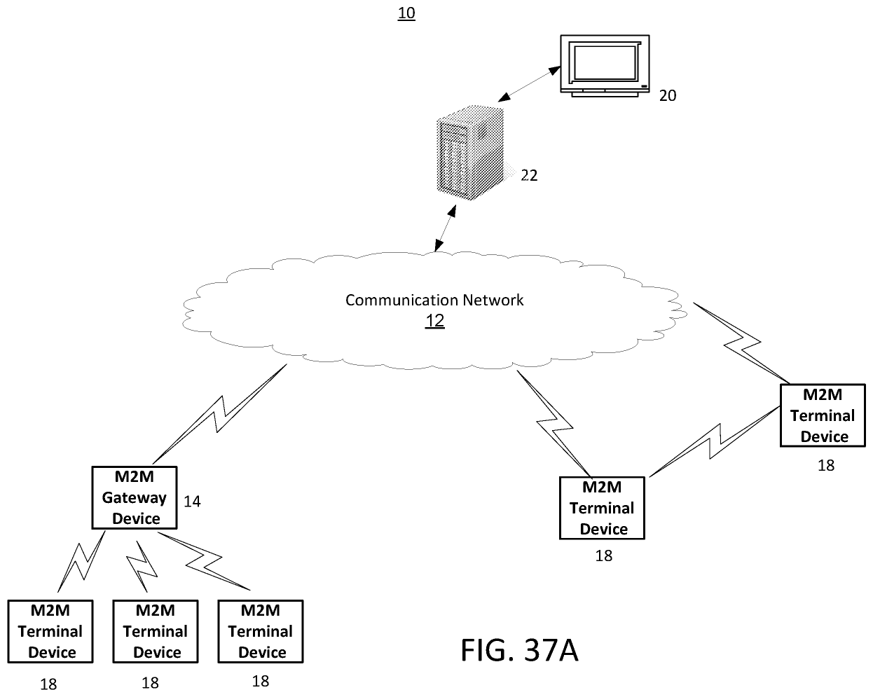

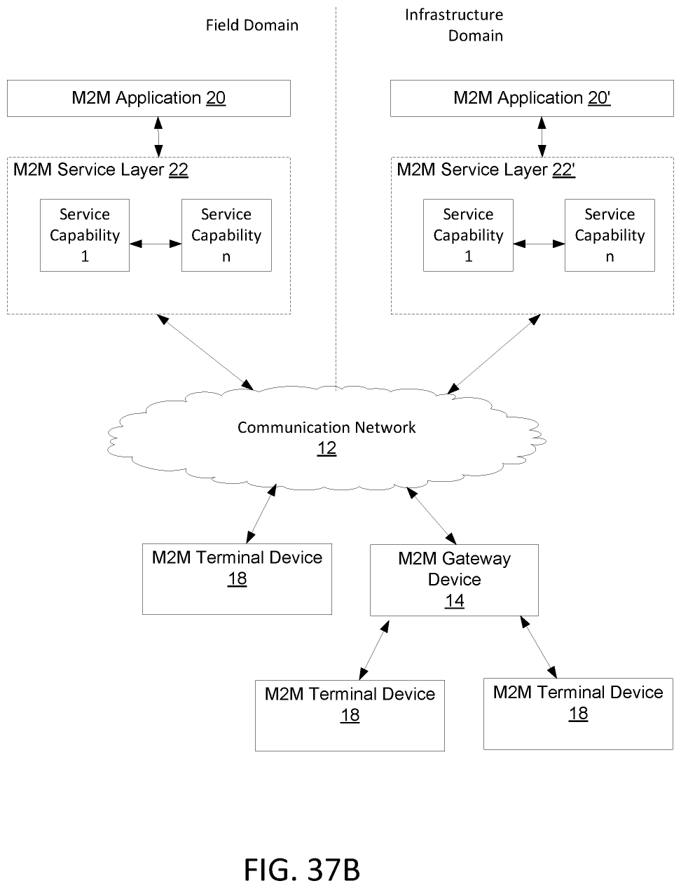

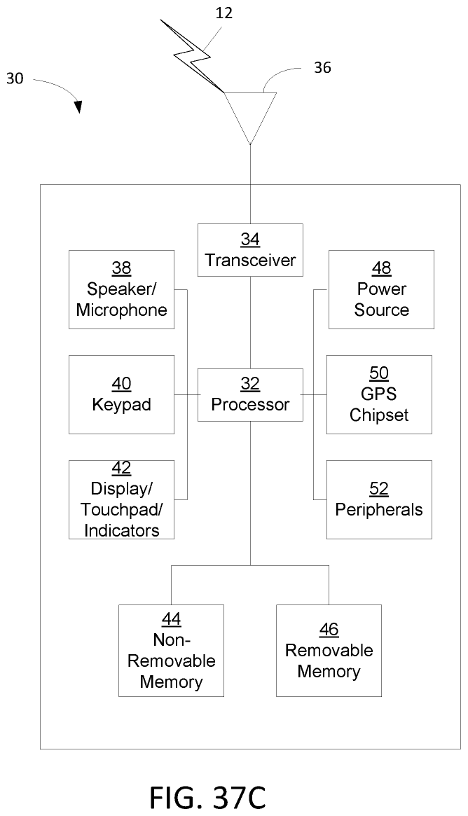

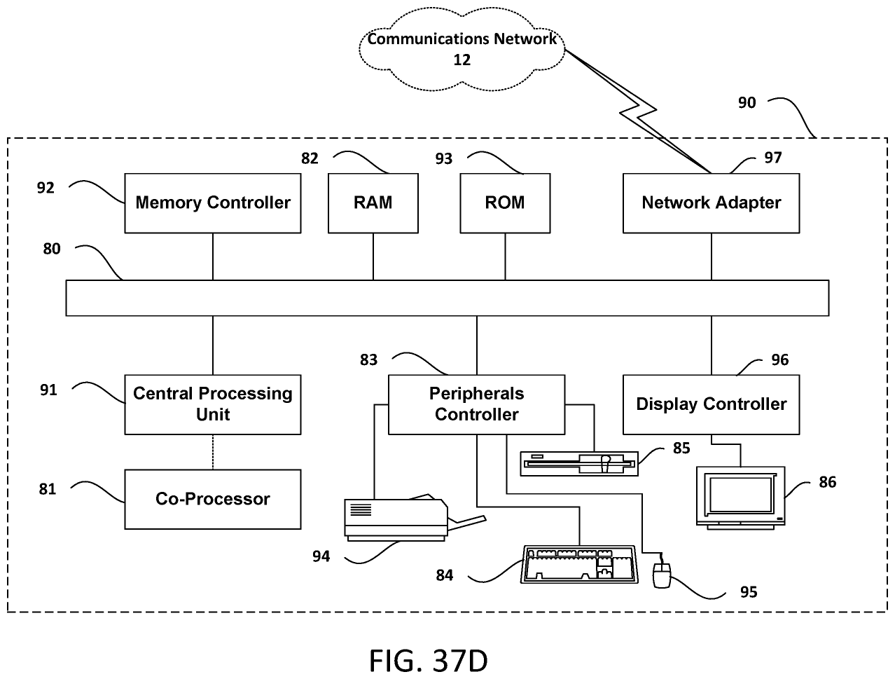

It is understood that the entities performing the steps illustrated herein, such as FIG. 7-FIG. 15, may be logical entities. The steps may be stored in a memory of, and executing on a processor of, a device, server, or computer system such as those illustrated in FIG. 37C or FIG. 37D. In an example, with further detail below with regard to the interaction of M2M devices, AE 331 of FIG. 33A may reside on M2M terminal device 18 of FIG. 37A, while CSE 332 and CSE 333 of FIG. 33A may reside on M2M gateway device 14 of FIG. 37A. Skipping steps, combining steps, or adding steps between exemplary methods disclosed herein (e.g., FIG. 7-FIG. 15) is contemplated.

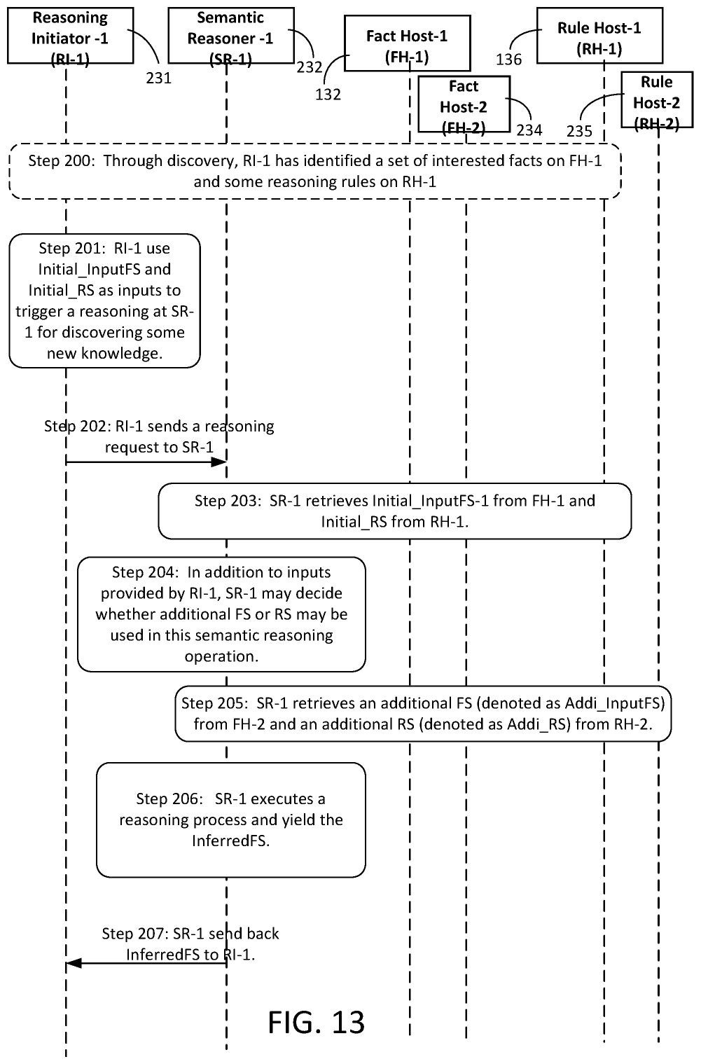

Disclosed below is how to publish, update and share facts and reasoning rules in the SL (Block 115—Part 1). The following data entities have been defined: fact set (FS) and rule set (RS). A Fact Set (FS) is a set of facts. When FS is involved with semantic reasoning, the FS can be further classified by InputFS or InferredFS. In particular, the InputFS (block 116) is the FS which is used as inputs to a specific reasoning operation, and InferredFS (block 122) is the semantic reasoning result (e.g., InferredFS includes the inferred facts). InferredFS (block 122) generated by a reasoning operation A can be used as an InputFS for later/future reasoning operations (as shown in FIG. 6). InputFS can be further classified by Initial_InputFS and Addi_InputFS (see e.g., FIG. 13). Initial_InputFS may be provided by a Reasoning Initiator (RI) when it sends a request to a Semantic Reasoner (SR) for triggering a semantic reasoning operation. Addi_InputFS is further provided or decided by the SR if additional facts should be used in the semantic reasoning operation. In the following descriptions, the general term FS may be used to cover the multiple types of fact sets. A Rule Set (RS—e.g., RS 117)) is a set of reasoning rules. RS may be further classified by Initial_RS and Addi_RS. For example, Initial_RS is provided by the RI when it sends a request to the SR for triggering a semantic reasoning operation. Addi_RS is further provided or decided by the SR if additional rules should be used in the semantic reasoning operation. Initial_InputFS refers to the FS that is provided by the Reasoning Initiator (RI). For example, when a RI sends a reasoning request to SR, RI may indicate what the facts will be as the reasoning input, such facts will be regarded as Initial_InputFS. Then, SR may find that the Initial_InputFS is not enough, it may include more facts as inputs, which will be regarded as Addi_InputFS.

From a FS perspective, in the service layer, data are normally exposed as resources and facts are fragmented or distributed in different places. Facts are not limited to semantic annotations of normal SL resources (e.g., RDF triples in different <semanticDescriptor> resources), facts can also refer to any information or knowledge that can be made available at service layer (e.g., published) and stored or accessed by others. For example, a special case of a FS may be an ontology that can be stored in a <ontology> resource defined in oneM2M.

From a RS perspective, a SL-based platform is often supposed to be a horizontal platform that enables applications across different domains. Therefore, different RSs may be made available at service layer (e.g., published) and stored or accessed by others for supporting different applications. For example, for the InputFS that describes the current outdoor temperature, humidity, or wind in a park, an outdoor activity advisor related reasoning rule may be used to infer a high-level fact of whether it is a good time to do outdoor sports right now (which can be directly digested). In comparison, the smart lawn watering related rule may be used to infer a fact of whether the current watering schedule is desirable. Overall, Block 115—Part 1 is associated with how to enable the semantic reasoning data in terms of how to make a FS or RS available at service layer and their related CRUD (create, read, update, and delete) operations.

This section introduces the CRUD operations for FS enablement such that a given FS (covering both InputFS and InferredFS cases) can be published, accessed, updated, or deleted.

In the following procedures, some “logical entities” are involved and each of them has a corresponding role. They are listed as follows:
Fact Provider (FP): This is an entity (e.g. an oneM2M AE or CSE) who creates a given FS and make it available at a SL.
Fact Host (FH): This is an entity (e.g. an oneM2M CSE) that can host a given FS.
Fact Modifier (FM): This is an entity (e.g. an oneM2M AE or CSE) who makes modification or updates on an existing FS.
Fact Consumer (FC): This is an entity (e.g. an oneM2M AE or CSE) who retrieves a given FS that is available at a SL.

Accordingly, different physical entities may take different logical roles as defined above. For example, an AE may be a FP and a CSE may be a FH. One physical entity, such as oneM2M CSE, may take multiple roles as defined above. For example, a CSE may be a FP as well as a FH. An AE can be a FP and later may also be a FM.

FIG. 7 illustrates an exemplary method for CREATE operation for FS Publication. As shown in FIG. 7, there may be FP 131 and FH 132 that are involved with publishing FS-1. Step 140 may be pre-condition for the publication method. At step 140, FP 131 has a set of facts, which is denoted as a FS-1. FP 131 intends (e.g., determines based on a trigger) to make FS-1 available in the system. For example, a possible trigger is that if FS-1 can be made available to external entities, this may trigger FP 131 to publish FS-1 to service layer. At step 141, FP 131 sends FS-1 to FH 132 for publishing. Note that a FS generally may have several forms. For example, an FS-1 may refer to an ontology, which describes a domain knowledge for a given use case (e.g., the smart city use case as disclosed herein, in which many domain concepts and their relationships are defined, such as hospital, city fire department, building, rooms, etc.). Another example, FS-1 may refer to facts related to specific instances. Still using the previous example of FIG. 5, a FS may describe the current management zones definitions of the hospital such as its building, room arrangement, allocation information (e.g., management zone MZ-1 includes rooms used for storing blood testing samples, such as Room-109 in Building-1, Room-117 in Building-3, etc.). For these type of facts, it could individually exist in the system (e.g., not necessarily to be as semantic annotations for other resources). In addition, a FS could also refer to the semantic annotations about a resource, entity, or other thing in the system. With continued reference to FIG. 5, an FS could be the semantic annotations of Camera-111, which is deployed in Room-109 of Building-1.

At step 142, with continued reference to FIG. 7, FH 132 decides whether FS-1 can be stored on it. For example, FH 132 may check whether FP 131 has appropriate access rights to do so. If FS-1 can be stored on it, FH 132 will store FS-1, which may be made available to other entities in the system. For example, a later semantic reasoning process may use FS-1 as input and in that case, FS-1 will be retrieved and input into a SR for processing. Regarding a given FS, certain information can also be stored or associated with this FS in order to indicate some useful information (this information maybe provided by FP 131 in step 141 or by others). For example, the information may include related ontologies or related rules.

With reference to related ontologies, facts stored in FS-1 may use concepts or terms defined by certain ontologies, therefore, it is useful to indicate which ontologies are involved in those facts (such that the meaning of the subject/predicate/object in those RDF triples can be accurately interpreted). For example, consider the following facts stored in FS-1:
Fact-1: Camera-111 is-located-in Room-109-of-Building-1
Fact-2: Room-109-of-Building-1 is-managed-under MZ-1

It can be observed that facts in FS-1 use some terms such as “is-located-in” or “is-managed-by”, which could be the vocabularies or properties defined by a specific ontology.

With reference to related rules, it is also possible that the facts stored in FS-1 may potentially be used for reasoning with certain reasoning rules, therefore, it is also useful to indicate which potential RSs maybe applied over this FS-1 for reasoning. Note that those rules are just suggestions in the sense that other rules may also be applied on this FS-1 as long as it makes sense. Consider the following reasoning rule stored in a RS-1:
Rule-1: IF A is-located-in B && B is-managed-under C, THEN A monitors-room-in C

The rule in RS-1 (Rule-1) maybe applied over the facts stored in FS-1 (Fact-1 and Fact-2). At step 143, FH 132 acknowledges that FS-1 is now stored on FH 132.

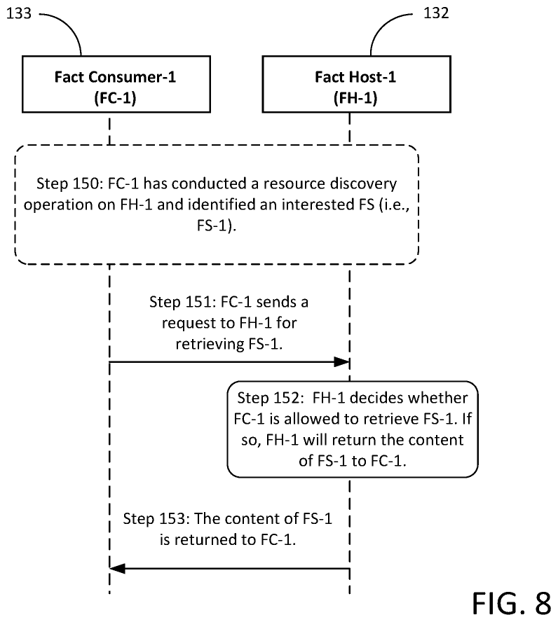

FIG. 8 illustrates an exemplary method for RETRIEVE operation for FS Retrieval. As shown in FIG. 8, there may be FC 133 that may retrieve a FS-1 stored on FH 132. At step 150, there may be a pre-condition for the retrieval method. At step 150, FC 133 has conducted a resource discovery operation on FH 132 and identified an interested FS (e.g., FS-1). Still using the previous example of FIG. 5, if FS-1 describes the current management zones definitions of the hospital such as its room allocation information, it may be used by a SR during a reasoning process. For example, FS-1 may be useful to identify the interested cameras, which are only annotated with physical location information (e.g., room and building numbers) but not with management zone related information. When a user is looking for the cameras deployed in the rooms belonging to MZ-1, such FS-1 will be useful to identify the related cameras through a reasoning process. At step 151, FC 133 sends a request to FH 132 for retrieving FS-1. At step 152, FH 132 decides whether FC 133 is allowed to retrieve FS-1. If so, FH 132 will return the content of FS-1 to FC 133. At step 153, the content of FS-1 is returned to FC 133.

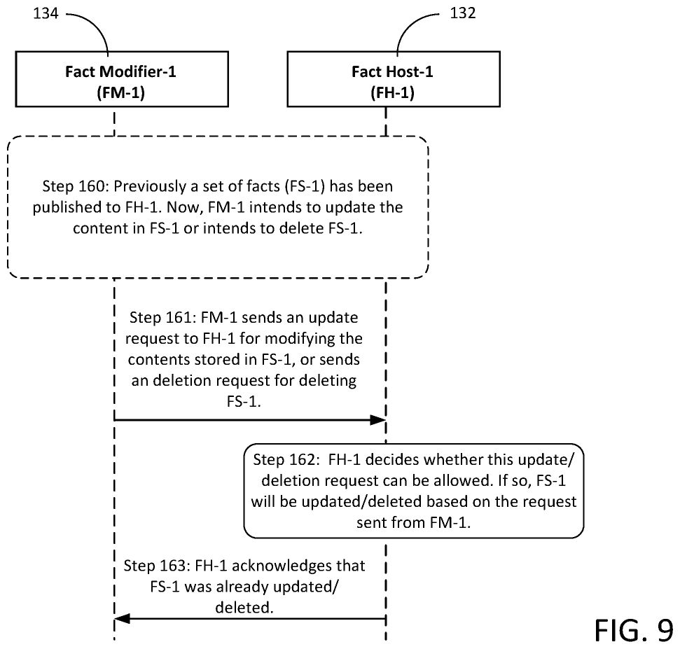

Regarding the UPDATE or DELETE operation, FM 134 may update or delete FS-1 stored on FH 132 using the following procedure, which is shown in FIG. 9. At step 160, previously a set of facts (FS-1) has been published to or locally generated by FH 132. Now, FM 134 intends (e.g., determines based on a trigger) to update the content in FS-1 or intends to delete FS-1. For example, FM has received a notification that FS-1 is out of date, then an update or deletion is triggered. Still using the previous example of FIG. 5, assuming FS-1 describes the management zones definitions of hospital such as its room allocation information, FS-1 may be required or request to be updated if the hospital has reorganized the room allocation (e.g., now Room 109 in Building-1 is not belonging to MZ-1 anymore since it is not being used for storing blood samples but for other purpose). At step 161, FM 134 sends an update request to FH 132 for modifying the contents stored in FS-1 or sends a deletion request for deleting FS-1. At step 162, FH 132 decides whether this update or deletion request maybe allowed (e.g., based on certain access rights). If so, FS-1 will be updated or deleted based on the request sent from FM 134. At step 163, FH 132 acknowledges that FS-1 was already updated or deleted. As an alternative approach, if the facts stored in a FS are in form of RDF triples, the FS maybe updated using SPARQL query statement. In order to do so, in step 161, the update request may include a SPARQL query statement which describe how the FS should be updated. In particular, in this approach, the FS maybe fully updated or partially updated, which depends on how the SPARQL query statement is written. An example of the alternative approach may include, when the FM is a fully semantic-capable user and knows SPARQL query language, the FM may directly write its update requirements or requests in the form of SPARQL query statement.

This section introduces the CRUD operations for RS enablement such that a given RS maybe published, accessed, updated and deleted. RS enablement generally refers to the customized or user-defined rules. In the following procedures, some “logical entities” are involved and each of them has a corresponding role. They are listed as follows:
Rule Provider (RP): This is an entity (e.g. an oneM2M AE or CSE) who creates a given RS and make it available at SL.
Rule Host (RH): This is an entity (e.g. an oneM2M CSE) that can host a given RS.
Rule Modifier (RM): This is an entity (e.g. an oneM2M AE or CSE) who makes modification (e.g., updates) on an existing RS.
Rule Consumer (RC): This is an entity (e.g. an oneM2M AE or CSE) who retrieves a given RS that is available at SL.

Accordingly, different physical entities may take different logical roles as defined above. For example, an AE maybe a RP and a CSE maybe a RH. One physical entity, such as oneM2M CSE, may take multiple roles as defined above. For example, a CSE may be a RP as well as a RH. An AE may be a RP and later may also be a RM.

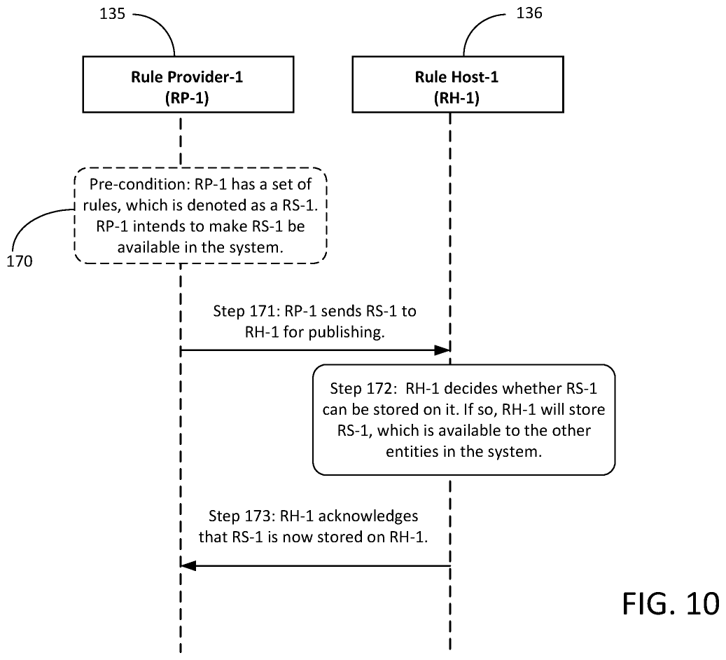

Regarding the CREATE operation, RP 135 may publish a RS-1 and store it on a RH 136 using the following procedure, which is shown in FIG. 10. As a pre-condition, at step 170, RP 135 has a set of rules, which is denoted as a RS-1. RP 135 intends to make RS-1 available in the system. A possible trigger is that if RS-1 can be made available to external entities, this may trigger RP 135 to publish FS-1 to the service layer. At step 171, RP 135 sends RS-1 to RH 136 for publishing. Still using the previous example of FIG. 5, RS-1 may include a rule that “IF A (e.g., Camera-111) is-located-in B (e.g., Room-109 of Building-1), and B is-managed-under C (e.g., MZ-1), THEN A monitors-room-in C”. Such a rule may be useful to infer a new fact, which may associate a camera with a specific MZ. At step 172, RH 136 decides whether RS-1 may be stored on it based on certain access right. If RS-1 may be stored on it, RH 136 may store RS-1, which is available to the other entities in the system. For example, a later semantic reasoning process may use RS-1 as input and in that case, RS-1 may be retrieved and input into a SR for processing. Certain information mayalso be stored or associated with this RS in order to indicate some useful information. This information maybe provided by RP 135 in step 171 or by others. For example, the information may include related ontologies or related facts. With regard to related ontologies, it is possible that the rules stored in a RS may use concepts or terms defined by certain ontologies, therefore, it is useful to indicate which ontologies are involved in those rules. For example, consider the following user-defined reasoning rule stored in RS-1:
Rule-1: IF A is-located-in B && B is-managed-under C, THEN A monitors-room-in C

Rule-1 uses some terms such as “is-located-in” or “is-managed-by”, which may be the vocabularies/properties defined by a specific ontology.

With regard to related fact, it is also possible that the rules stored in a RS may be applied over certain type of facts, therefore, it is also useful to indicate which potential FSs this RS maybe applied to for reasoning. Note that those facts are just suggestions in the sense that this RS may also be applied to other facts if terms used in FS and terms used in RS have overlaps. For example, consider the following two facts are stored in FS-1, which are described as RDF triples:
Fact-1: Camera-111 is-located-in Room-109-of-Building-1
Fact-2: Room-109-of-Building-1 is-managed-under MZ-1.

The rule in RS-1 (Rule-1) maybe applied over the facts stored in FS-1 (Fact-1 and Fact-2) since there is an overlap between the ontologies used in the facts and ontologies used in the rules, such as those terms like “is-located-in” or “is-managed-by”. At step 173, RH 136 acknowledges that RS-1 is now stored on RH 136 with a URI.

Shown in this section is how the reasoning rules may be created. First, based on various application scenarios or requirements, various application-driven reasoning rules may be defined, such as those rules defined in the intelligent facility management use case discussed previously:
Rule-1: IF A is-located-in B && B isEquippedWith BackupPower, THEN A isEquippedWith BackupPower

Second, another case where reasoning rules may be generated is when doing ontology alignment or mapping. Ontology alignment, or ontology matching, is the process of determining correspondences between concepts in ontologies. As an example, for a given ontology A and ontology B, ontology mapping may not be conducted and one of the identified mappings may be that the concept or class “record” in ontology A is equal to or as same as the concept/class “log record” in ontology B. A concept is normally corresponding to a class defined in an ontology. So usually, a concept and class refer to the same thing. Here a class called “record” is defined in a ontology A and a class called “log record” is defined in ontology B. Accordingly, this mapping may be described as a RDF triple (using the “sameAs” predicate defined in OWL) such as the following triple:
RDF Triple-A: ontologyA:Record owl:sameAs ontologyB:LogRecord

There are multiple ways regarding to how to further utilize this RDF Triple-A, such as provided below. In other words, RDF-A triple is already a mapping result between two ontologies. Now below there is discussion of exemplary ways that this mapping result may be further utilized In a first way, RDF Triple-A may be added to the semantic annotations of a record (e.g., Record-X) For example, for the given Record-X, initially its semantic annotation just includes the following RDF triple (which shows Record-X is an instance of the LogRecord concept/class in ontology B):
RDF Triple-B: Record-X is-a ontologyB:LogRecord

Accordingly, if a user wants to conduct a semantic discovery with the following SPARQL query statement:
SELECT ?rec WHERE {?rec is-a ontologyA:Record}

The user cannot get Record-X in the discovery result since the above SPARQL query statement cannot match the semantic annotation of Record-X (since Record-X is a type of ontologyB:LogRecord while the user is looking for a record, which is a type of ontologyA:Record). To address this issue, we may add RDF Triple-A into the semantic annotation of Record-X. Then, when processing the above SPARQL statement during the semantic discovery operation, reasoning maybe triggered by applying certain reasoning rules over the semantic annotations of Record-X, for example:
Rule-2: If uuu owl:sameAs vvv and Y is-a uuu, Then Y is-a vvv (here “uuu” “vvv” “Y” are all the wildcards to be replaced.)

As a result, the reasoning result is the following triple:
RDF Triple-C: Record-X is-a ontologyA:Record

Such RDF Triple-C then may match the original SPARQL statement (e.g., the pattern WHERE {?rec is-a ontologyA:Record}), and finally Record-X be identified during this semantic discovery operation.

A second way transform RDF Tiple-A into a reasoning rule for further usage. For example, the RDF Triple-A may be represented as the following reasoning rule:
Rule-3: If Y is-a ontologyB:LogRecord, Then Y is-a ontologyA:Record.

Then, such a reasoning rule may be stored in the service layer by using the RS enablement procedure as defined in this disclosure (e.g., using a CREATE operation to create a RS on a host. In oneM2M, it may mean that we may use a CREATE operation to create a <reasoningRule> resource to store Rule-3).

Still using the previous example (the Record-X and the SPARQL statement as discussed before). In this approach, we do not add RDF Triple-A into the semantic annotation of Record-X. Instead, when processing the above SPARQL statement during the semantic discovery operation, semantic reasoning may be triggered by using Rule-3. As a result, the reasoning result may be as same as RDF Triple-C. Finally, Record-X may also be identified during this semantic discovery operation.

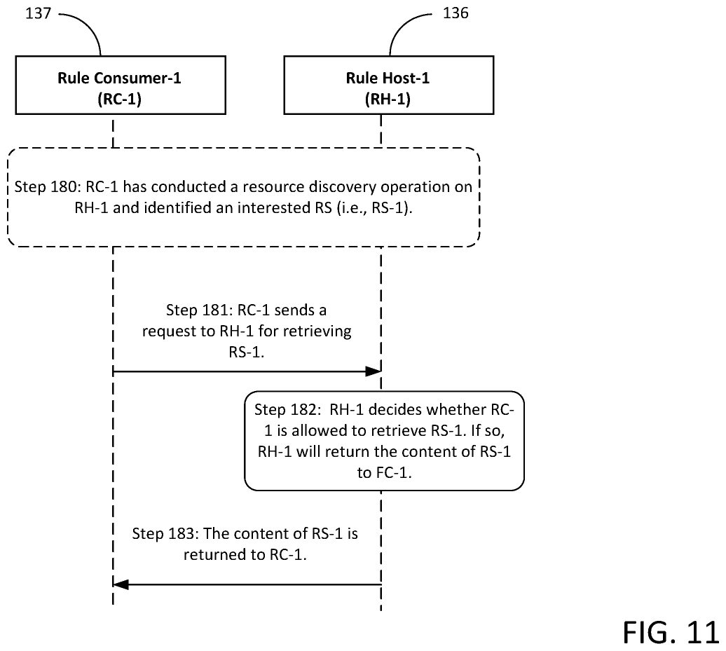

Regarding the RETRIEVE operation, RC 137 may retrieve RS-1 stored on an RH 136 using the following procedure, which is shown in FIG. 11. As a pre-condition, at step 180, RC 137 has conducted a resource discovery operation on RH 136 and identified an interested RS-1. For example, RC 137 is a SR and intend to do a reasoning operation using RS-1 (e.g., in this case, SR is taking a logical role of a RC). At step 181, RC 137 sends a request to RH 136 for retrieving RS-1. At step 182, RH 136 decides whether RC 137 is allowed to retrieve RS-1. If so, RH 136 will return the content of RS-1 to RC 137. At step 183, the content of RS-1 is returned to FC 133.

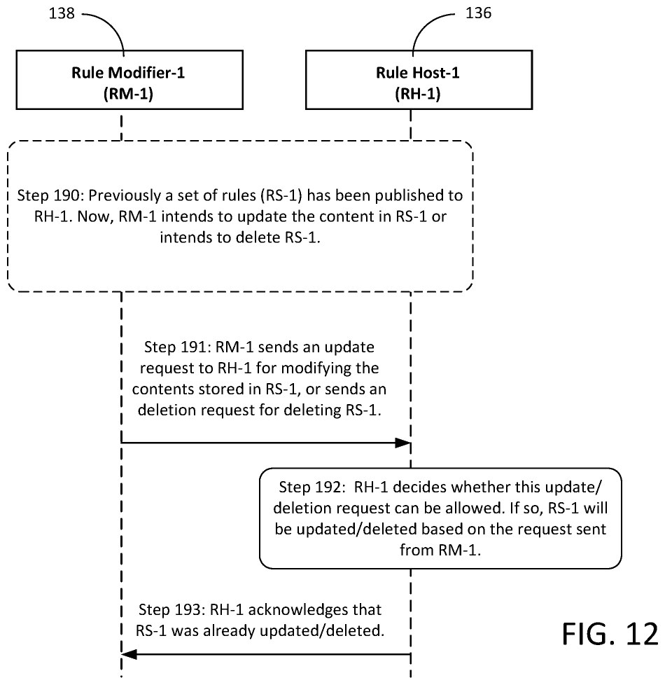

Regarding the UPDATE/DELETE operation, RM 138 may update or delete RS-1 stored on RH 136 using the following procedure, which is shown in FIG. 12. As a pre-condition, at step 190, previously a set of rules (RS-1) has been published to RH 136. Now, RM 138 intends (e.g., determines based on a trigger) to update the content in RS-1 or intends to delete RS-1. For example, a trigger may be that RM 138 has received a notification that RS-1 is out of date, then it needs to updated or deleted. Still using the previous example of FIG. 5, RS-1 originally just included one reasoning rule. However, a new reasoning rule may be added to infer more facts about device access rights. For example, a new rule may be” “IF A (e.g., Camera-111) is-managed-under B (e.g., MZ-1 for rooms storing blood testing samples), and B is-exposed-to C (e.g., city health department is aware of MZ-1), THEN C is-allowed-to-access A (e.g., Camera-111 may be accessed by the city health department). Using this new rule for a reasoning, the inferred fact may be used for answering the query such as which devices may be accessed by city health department. At step 191, RM 138 sends an update request to RH 136 for modifying the contents stored in RS-1 or sends a deletion request for deleting RS-1. At step 192, RH 136 decides whether this update/deletion request may be allowed based on certain access right. If so, RS-1 will be updated/deleted based on the request sent from RM 138. At step 193, RH 136 acknowledges that RS-1 was already updated/deleted.

This part introduces several methods and systems for enabling an individual semantic reasoning process. A first example method may be associated with a one-time reasoning operation. For this operation, a reasoning initiator (RI) has identified some interested InputFS and RS and would like to initiate a reasoning operation at a SR in order to identify some new facts (e.g., knowledge). A second example method may be associated with a continuous reasoning operation. In this system, a RI may be required or request to initiate a continuous reasoning operation over related InputFS and RS. The reason is that it is possible that InputFS and RS may get changed (e.g., updated) over time, and accordingly the previously inferred facts may not be valid anymore. Accordingly, a new reasoning operation should be executed over the latest InputFS and RS and yield more fresh inferred facts.

Using a previous example, a semantic reasoning process may take the current outdoor temperature/humidity/wind of a park (as InputFS) and outdoor activity advisor related reasoning rule (as RS) as two inputs. After executing a reasoning process, a high-level fact (as InferredFS) may be inferred about, for instance, whether it is a good time to do outdoor sports now. The word “individual” here means that a semantic reasoning process is not necessarily associated with other semantic operations (such as semantic resource discovery, semantic query, etc.). To enable a semantic reasoning process, it involves a number of issues, such as:
1. What is the InputFS to be used and where to collect it?
2. What is the RS to be used and where to collect it?
3. Who will be responsible for collecting InputFS and RS? For example, it may be an application entity who initiates the semantic process or the SR may handle this.
4. Once the InferredFS is yielded by RS, where to deliver or store it?

The following disclosed methods and systems address the aforementioned issues. Some previously-defined “logical entities” are still involved such as FH and RH. In addition, a SR is available in the system and a new logical entity called a Reasoning Initiator (RI) is the one who may send a request to the SR for triggering a reasoning operation.

In this scenario with regard to one-time reasoning, an RI has identified some interested InputFS and RS and would like to initiate a reasoning operation at a SR in order to discover some new knowledge/facts. Disclosed herein are systems, methods, or apparatuses that provide ways to trigger a one-time reasoning operation at the service layer. FIG. 13 illustrates an exemplary method for one-time reasoning operation and the detailed descriptions are as follows. At step 200, a precondition, RI 231 knows the existence of SR 232. RI 231 may be an AE or CSE. Through discovery, RI 231 has identified a set of interested facts on FH 132 (this fact set is denoted as Initial_InputFS) and some reasoning rules on RH 136 (this rule set is denoted as Initial_RS). It is also possible that RI 231 may first identify Initial_InputFS part and if more information about Initial_InputFS is also available (for example, if “related rules” information is also available (which indicates which potential RSs may be applied over Initial_InputFS for a reasoning), RI 231 may directly select some interested rules from those suggestions. Regarding identified “interested” facts and rules discussed throughout this disclosure, the reasoning initiator (RI) can use the existing semantic resource discovery to identify the oneM2M resources that store the facts or reasoning rules. In general, in a semantic discovery request, a semantics filter and this filter may carry a SPARQL statement. This SPARQL statement may indicate what type of facts or rules RI is interested in (i.e., a request message includes a request for more information about certain data). For example, a RI may say “Please find me all the facts about the street lights in the downtown, e.g., its production year, its brand, its location, etc.”—this is RI's interested fact. A RI may also say “please find me reasoning rules that represent the street light maintenance plan. E.g., a rule can be written as: IF a street light is brand X, or it is located in a specific road, THEN this light needs to be upgraded now”—this is RI's interested rule. Then, if the RI (e.g., the city street light maintenance application) wants to know which lights should be upgraded (this can be an example for when a RI “intends to . . . ”), then this RI can use the identified facts and rules to trigger a reasoning operation as shown in FIG. 13, and the reasoning results are a list of street lights that need to be upgraded. So, in short, what type of facts or rules that a RI is interested in may depend on application business needs.

As an example, RI 231 is interested in two cameras (e.g., Camera-111, Camera-112) and the Initial_InputFS has several facts about those two cameras, such as the following:
Fact-1: Camera-111 hasBrandName “XYZ”
Fact-2: Camera-112 is-located-in Building-1

RI 231 also identified the following rule (as Initial_RS) and intend to use it for reasoning in order to discover more implicit knowledge/facts about those interested cameras:
Rule-1: IF A hasBrandName “XYZ”, THEN A isEquippedWith BackupPower

With those Initial_InputFS and Initial_RS, it is possible to infer some new knowledge regarding whether those cameras have backup power such that they may support 7*24 monitoring purpose even if power outage happens. At step 201, RI 231 intends (e.g., determines based on a trigger) to use Initial_InputFS and Initial_RS as inputs to trigger a reasoning operation/job at SR 232 for discovering some new knowledge. A trigger for RI 231 to send out a resoning request could be that RI 231 receives a “non-empty” set of facts and rules during the previous discovery operation, then this may trigger RI to send out a reasoning request. In other words, if Initial_RS and Initial FS is not empty, then it may trigger RI 231 to send a reasoning request. At step 202, RI 231 sends a reasoning request to SR 232, along with the information about Initial_InputFS and Initial_RS (e.g. their URIs). For example, the information includes the URI of corresponding FH 132 for storing Initial_InputFS, the URI of corresponding RH 136 for storing Initial_RS. At step 203, based on the information sent from RI 231, SR 232 retrieves Initial_InputFS-1 from FH 132 and Initial_RS from RH 136.

At step 204, in addition to inputs provided by RI 231, SR 232 may also determine whether additional FS or RS may be used in this semantic reasoning operation. If SR 232 is aware of alternative FH and RH, it may query them to obtain additional FS or RS.

For example, it is possible that RI 231 just identified partial facts and rules (e.g., RI 231 did not conduct discovery on FH 234 and RS-2, but there are also useful FS and RS on FH 234 and RS-2 that are interested by RI 231), which may limit the capability for SR to infer new knowledge. For example, with just Initial_InputFS and Initial_RS, SR 232 may just yield one piece of new fact:
Inferred Fact-1: Camera-111 isEquippedWith BackupPower

In general, in this step 204, whether SR 232 will use additional facts or additional rules may have different implementation choices. For example, in a first approach, RI 231 may indicate in step 202 that whether SR 232 may add additional facts or rules. In a second approach, RI 231 may not indicate in step 202 that whether SR 232 may add additional facts or rules. Instead, the local policy of SR 232 may make such a decision.

With continued reference to step 204, in general, there may be the following potential ways for SR 232 to decide which additional FS and RS may be utilized. This may be achieved by setting up some local policies or configurations on SR 232. For example:
For a given FS (e.g., FS-1) included in Initial_InputFS, the SR 232 may further check whether there is useful information associated (e.g., stored) with FS-1. For example, information may include “related rules”, which is to indicate which potential RSs may be applied over a FS-1 for reasoning. If any part of those related rules were not included in the Initial_RS, RI 231 may further decide whether to add some of those related rules as additional rules.
For a given RS (e.g., RS-1) included in Initial_RS, the SR 232 may further check whether there is useful information associated/stored with RS-1. For example, one of the information could be the “related facts”, which is to indicate which potential FSs RS-1 may be applied to. If any part of those related facts were not included in the Initial_InputFS, RI 231 may further decide whether to add some of those facts as additional facts.
When SR 232 cannot get useful information from Initial_InputFS and Initial_RS as discussed above, SR 232 may also take actions based on its local configurations or policies. For example, SR 232 may be configured such that as long as it sees certain ontologies or the interested terms/concepts/predicates used in Initial_InputFS or Initial_RS, it could further to retrieve more facts or rules. In other words, a SR 232 may keep a local configuration table to record its interested key words and each key word may be associated with a number of related FSs and RSs. Accordingly, for any key word (a term, a concept, or a predicate) appeared in Initial_InputFS and Initial_RS, SR 232 may check its configuration table to find out the associated FSs and RSs of this key word. Those associated FSs and RSs may potentially be the additional FSs and RSs that may be utilized if they have not been included in the Initial_InputFS and Initial_RS. For example, when the SR 232 receives Fact-2 and it finds term “Building-1” has appeared in Fact-2 (e.g., “Building-1” is an interested term or key word in its configuration table), then SR 232 may choose to add additional facts about Building-1 (e.g., based on the information in its configuration table), such as Fact-3 shown below. Similarly, since the SR 232 finds interested predicate “is-located-in” is appeared in Fact-2 and interested predicate “isEquippedWith” is appeared in Fact-3, then it will add additional/more rules, such as Rule-2 shown below:
   Fact-3: Building-1 isEquippedWith BackupPower
   Rule-2: IF A is-located-in B && B isEquippedWith BackupPower, THEN A isEquippedWith BackupPower
SR 232 may also be configured such that given the type of RI 231, which additional FS and RS should be utilized. (e.g., depend on the type of RI; for example, if RI is a VIP user, more FS may be included in the reasoning process so that high-quality reasoning result may be produced.).

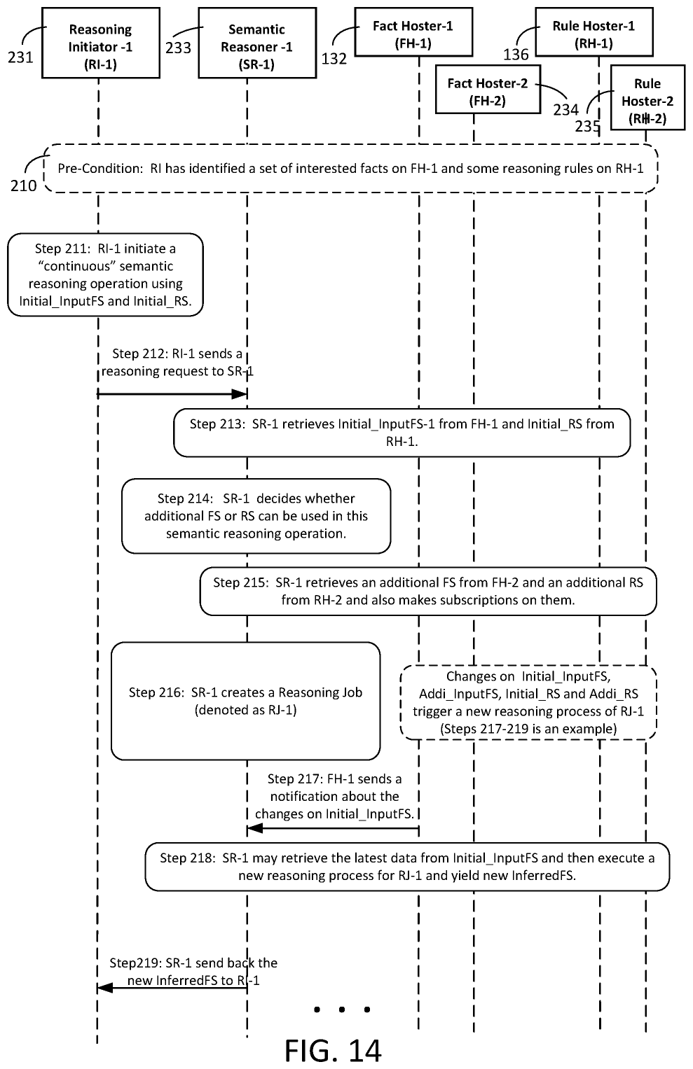

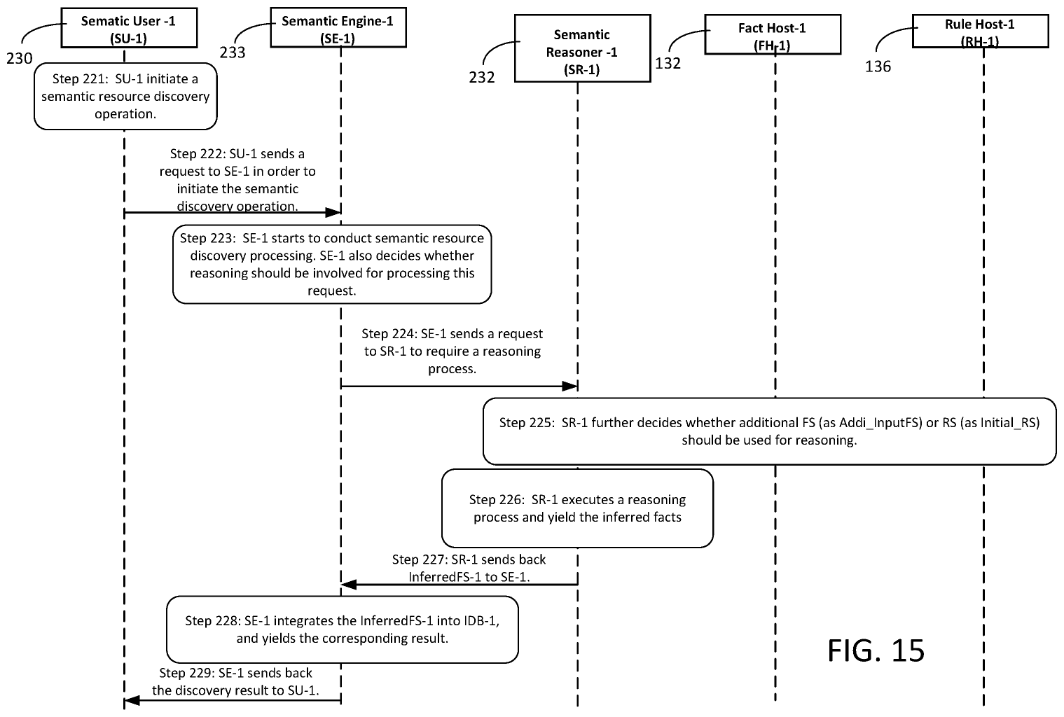

The approaches here at step 204 may also be used in the methods in the later sections, such as step 214 in FIG. 14 and step 225 in FIG. 15.

At step 205, SR 232 retrieves an additional FS (denoted as Addi_InputFS) from FH 234 and an additional RS (denoted as Addi_RS) from RH 235. For example, the Addi_InputFS has the Fact-3 as shown above about Building-1, and Addi_RS has Rule-2 as shown above. With additional FS and RS and with Fact-2, SR 232 may yield Inferred Fact-2:
Inferred Fact-2: Camera-112 isEquippedWith BackupPower

At step 206, with all the InputFS (e.g., Initial_InputFS and Addi_InputFS) and RS (e.g., Initial_RS and Addi_RS), SR 232 will execute a reasoning process and yield the InferredFS. As mentioned earlier, two inferred facts (Inferred Fact-1 and Inferred Fact-2) will be included in InferredFS. At step 207, SR 232 sends back InferredFS to RI 231.

As a refresher, a concept is equal to a Class in a ontology, such as a Teacher, Student, Course, those are all concepts in a university ontology. A predicate describes the “relationship” between class, e.g., a Teacher “teaches” a Course. A term is often a key words in the domain, that is understood by everybody, e.g., “full-time”. Consider the following RDF triples (in terms of subject-predicate-object):

RDF Triple 1: Jack is-a Teacher (here Teacher is a Class, and Jack is an instance of Class Teacher).

RDF Triple 2: Jack teaches Course-232 (here teaches in this RDF triple is a predicate).

RDF Triple 3: Jack has-the-work-status “Full-time” (here “full-time” is a term that known by everybody)

Several alternatives of the procedure shown in FIG. 13 are also defined as follows (the alternatives may be considered separate). Alternative-1 for step 201, RI 231 does not have to do discovery to identify Initial_InputFS and Initial_RS. Instead, RI 231 itself may generate Initial_InputFS and Initial_RS on its own and send them to SR 232 (in this case, Step 203 is not required).

Alternative-2 for step 201, RI 231 does not have to use user-defined reasoning rule set. Instead, it may also utilize the existing standard reasoning rules. For example, it is possible that SR 232 may support reasoning based on all or part of reasoning rules as defined by a specific W3C entailment regimes such as RDFS entailment, OWL entailment, etc. (e.g., Initial_RS in this case may refer to those standard reasoning rules). In order to do so, RI 231 may ask SR 232 which standard reasoning rules or entailment regimes it may support when RI 231 discovers SR 232 for the first time.

Alternative-3, an alternative to step 202, RI 231 may just send the location information about Initial_InputFS and Initial_RS. Then, SR 232 may retrieve Initial_InputFS and Initial_RS on behalf of RI 231.

Alternative-4 is a non-block based approach for triggering a semantic operation may also be supported considering the fact that a semantic reasoning operation may take some time. For example, before step 203, SR 232 may first send back a quick acknowledgment about the acceptance for the request sent from RI 231. And after SR 232 works out the reasoning result (e.g., InferredFS), it will then send back InferredFS to RI 231 as shown in step 207. Note that in block-based approach, when RI sends a request to a SR, before SR works out a reasoning result, SR will not send back any response to RI. In comparison, in the non-Block approach, when SR receivers a reasoning request, SR may send back a quick ack to RI. Then in a later time, when SR work out the reasoning result, it may further send reasoning result to RI.

Alternative-5, another alternative to step 207, is that the InferredFS does not have to be returned to RI 231. Instead, it may be stored on certain FHs based on requirements or planned use. For example:
1. SR 232 may integrate InferredFS with Initial_InputFS such that Initial_InputFS will be “augmented” than before. This is useful in the case where Initial_InputFS is the sematic annotation of a device. With InferredFS, sematic annotation may have more rich information. For example, in the beginning, Initial_InputFS may just describe a fact that “Camera-111 is-a OntologyA: VideoCamera”. After conducting a reasoning, an inferred fact is generated (Camera-111 is-a OntologyB:DigitalCamera), which may also be added as the semantic annotation of Camera-111. In this way, Camera-111 have a better chance to be successfully identified in the later discovery operations (even if without reasoning support), which either use the concept “VideoCamera” defined in Ontology A or the concept “DigitalCamera” defined in Ontology B.
2. SR 232 may create a new resource to store InferredFS on FH 132 or locally on SR 232, and SR 232 may just return the resource URI or location of InferredFS on FH 132. This is useful in the case where Initial_InputFS describes some low-level sematic information of a device while InferredFS describes some high-level sematic information. For example, Initial_InputFS may just describe a fact that “Camera-113 is-located-in Room 147” and InferredFS may describe a fact that “Camera-113 monitors Patient-Mary”. Such high-level knowledge should not be integrated with the low-level semantic annotations of Camera-113.

For alternative-6, it is worth noting that in the disclosed methods, we consider the case where a specific rule set or fact set (e.g., Initial_InputFS, Addi_InputFS, Initial_RS, Addi_RS) is retrieved from one FH 132 or one RH 136, which is just for easier presentation. In general, Initial_InputFS (and similarly for Addi_InputFS) may be constituted by multiple FSs hosted on multiple FHs. Initial_RS (and similarly for Addi_RS) may be constituted by multiple RSs hosted on multiple RHs. Note that, all of the above alternatives may also apply to other similar methods as disclosed herein (e.g., method of FIG. 14).

Continuous Reasoning Operation: In this scenario, RI 231 may initiate a continuous reasoning operation over related FS and RS. The reason is that sometimes InputFS and RS may get changed/updated over time, and accordingly the previous inferred facts may not be valid anymore. Accordingly, a new reasoning operation may be executed over the latest InputFS and RS and yield fresher inferred facts. FIG. 14 illustrates the exemplary methods for continuous reasoning operation and the detailed descriptions are as follows. At step 210, pre-condition, RI 231 knows the existence of SR 232. Through discovery, RI 231 has identified a set of interested facts on FH 132 (this fact set is denoted as Initial_InputFS) and some reasoning rules on RH 136 (this rule set is denoted as Initial_RS). At step 211, RI 231 intends (e.g., determines based on a trigger) to initiate a “continuous” semantic reasoning operation using Initial_InputFS and Initial_RS. In an example, a trigger for RI 231 to send out a reasoning request could be that RI 231 receives a “non-empty” set of facts and rules during the previous discovery operation. In the meantime, the identified facts or rules may be changed over time, then this may trigger RI 231 to send a request for continuous reasoning operation. At step 212, RI 231 sends a reasoning request to SR 232, along with the information about Initial_InputFS and Initial_RS. Note that, the request message may include the new parameter reasoning type (rs_ty). Reasoning Type (rs_ty) indicates what type of reasoning operation the RI 231 requires. For example, rs_ty=0 means one-time reasoning operation (as discussed in the previous section) and rs_ty=1 means continuous reasoning operation. Alternatively, when rs_ty is not present in the request message, it will be treated as one-time reasoning request.

At step 213, based on the information sent from RI 231, SR 232 retrieves Initial_InputFS from FH 132 and Initial_RS from RH 136. SR 232 also makes subscriptions on them for notification on any changes. At step 214, in addition to inputs provided by RI 231, SR 232 may also decide whether additional FS or RS may be used in this semantic reasoning operation. At step 215, SR 232 retrieves an additional FS (denoted as Addi_InputFS) from FH 234 and an additional RS (denoted as Addi_RS) from RH 235 and also makes subscriptions on them.

At step 216, SR 232 creates a reasoning job (denoted as RJ-1), which includes all the InputFS (e.g., Initial_InputFS and Addi_InputFS) and RS (e.g., Initial_RS and Addi_RS). Then, RJ-1 will be executed and yield InferredFS. After that, as long as any of Initial_InputFS, Addi_InputFS, Initial_RS and Addi_RS is changed, it will trigger RJ-1 to be executed again. Alternatively, SR 232 may also choose to periodically check those resources and to see if there is an update. Another alternative, RI 231 may also proactively and parodically send requests to get latest reasoning result of RJ-1, and in this case, every time SR 232 receives a request from RI 231, SR 232 may also choose to check those resources and to see if there is an update (if so, a new reasoning will be triggered).

At step 217, FH 132 sends a notification about the changes on Initial_InputFS. At step 218, SR 232 will retrieve the latest data for Initial_InputFS and then execute a new reasoning process for RJ-1 and yield new InferredFS. Note that step 217-step 218 may operate continuously after the initial semantic reasoning process to account for changes to related FS and RS (e.g., Initial_InputFS shown in this example). Whenever SR 232 receives a notification on a change to Initial_InputFS, it will retrieve the latest data for Initial_InputFS and perform a new reasoning process to generate a new InferredFS. At step 219, SR 232 sends back the new InferredFS to RI 231, along with the job ID of RJ-1. This overall semantic reasoning process related to RJ-1 may continue as long as RJ-1 is a valid semantic reasoning job running in SR 232. In addition, if RJ-1 expires or SR 232 or RI 231 chooses to terminate RJ-1, SR 232 will stop processing reasoning related to RJ-1 and SR 232 may also unsubscribe from the related FS and RS. The alternative is shown in FIG. 13 may also be applied to the method shown in FIG. 14.

This part introduces methods and systems regarding how other semantic operations (such as semantic query, semantic resource discovery, semantic mashup, etc.) may benefit from semantic reasoning. In addition to a Semantic Reasoner, a Semantic Engine (SE) is also available in the system, which is the processing engine for those semantic operations. The general process is that: a Semantic User (SU) may initiate a semantic operation by sending a request to the SE, which may include a SPARQL query statement. In particular, the SU is not aware of the SR that may provide help behind the SE. For the SE, it may first decide the Involved Data Basis (IDB) for the corresponding SPARQL query statement. In general, IDB refers to a set of facts (e.g., RDF triples) that the SPARQL query statement should be executed on. However, the IDB at hand may not be perfect for providing a desired response for the request. Accordingly, the SE may further contact the SR for semantic reasoning support in order to facilitate the processing of the semantic operation at the SE. In particular, an augmenting IDB is disclosed. For an augmenting IDB the reasoning capability is utilized and therefore the original IDB will be augmented (by integrating some new inferred facts into the initial facts due to the help of reasoning) but the original query statement will not be modified. Accordingly, the SE will apply the original query statement over the “augmented IDB” in order to generate a processing result (for example, SE is processing a semantic query, the processing result will be the semantic query result. If SE is processing a semantic resource discovery, the processing result will be the semantic discovery result)

In Part 3 (block 125), semantic reasoning acts more like a “background support” to increase the effectiveness of other semantic operations and in this case, reasoning may be transparent to the front-end users. In other words, users in Part 3 (block 125) may just know that they are initiating a specific semantic operation (such as a semantic query or a semantic resource discovery, semantic mashup, etc.). However, during the processing of this operation by SE 233, SE 233 may further resort to SR 232 for support (in this work, the term SE is used as the engine for processing semantic operations other than semantic reasoning. In other words, reasoning processing will be specifically handled by the SR). In consideration of a previous example, a user may initiate a semantic query to the SE to query the recommendations for doing outdoor sports now. The query cannot be answered if the SE just has the raw facts such as current outdoor temperature/humidity/wind data of the park (remembering that the SPARQL query processing is mainly based on pattern matching). In fact, those raw facts (as InputFS) may be further sent to the SR for a reasoning using related reasoning rules and a high-level inferred fact (as InferredFS) may be deduced, with which SE may well answer the user's query.

This section introduces how the existing semantic operations (such as semantic query or semantic resource discovery) may benefit from semantic reasoning. In the following disclosed procedures, some of previously-defined “logical entities” are still involved such as FH and RH. In addition to a SR, a SE is also available in the system, which is the processing engine for those semantic operations. A logical entity called a Semantic User (SU), which is an entity that send a request to SE to initiate a semantic operation.

In general, SU 230 may initiate a semantic operation by sending a request to SE 233, which may include a SPARQL query statement. In particular, the SU is not aware of semantic reasoning functionality providing help behind the SE. For SE 233, it may first collect the Involved Data Basis (IDB) for the corresponding SPARQL query statement, e.g., based on the query scope information as indicated by the SU. More example for IDB is given as follows: In case of semantic query, given a received SPARQL query statement, the related semantic data to be collected is normally defined by the query scope. Using oneM2M as an example, the decedent <semanticDescriptor> resources under a certain resource will constitute the IDB and the query will be executed over this IDB. In case of semantic discovery, when evaluating whether a given resource should be included in the discovery result by checking its semantic annotations (e.g., its <semanticDescriptor> child resource), this <semanticDescriptor> child resource will be the IDB). However, the IDB at hand may not be perfect for providing a desired response for the request (e.g., the facts in IDB are described using a different ontology than the ontology used in the SPARQL query statement from SU 230). Accordingly, semantic reasoning could provide certain help in this case to facilitate the processing of the semantic operation processing at SE 233.

When SE 230 decides to ask for help from SR 232, SE 230 or SR 232 itself may decide whether additional facts and rules may be leveraged. If so, those additional facts and rules (along with IDB) may be used by the SR for a reasoning in order to identify inferred facts that may help for processing the original requests from the SU. The semantic resource discovery is used as an example semantic operation in the following procedure design which is just for easy presentation, however, the disclosed methods may also be applied to other semantic operations (such as semantic query, semantic mashup, etc.).

Again, for augmented IDB, the key idea is that by utilizing the reasoning capability, the IDB will be augmented (by integrating some new inferred facts with the initial facts due to the help of reasoning). Accordingly, the original query statement will be applied on the “augmented IDB” to generate a discovery result. The detailed descriptions of FIG. 15 are as follows: At step 221, SU 230 intends to initiate a semantic operation, which is e.g., a semantic resource discovery operation. For example, SU 230 is looking for cameras monitoring the rooms belonging to MZ-1. The SPARQL query statement in this discovery request may be written as follows:

```
SELECT ?device
WHERE {
  ?device  is-a Camera
  ?device  monitors-room-in MZ-1
}
```

At step 222, SU 230 sends a request to SE 233 in order to initiate a semantic discovery operation, along with a SPARQL query statement and information about which IDB should be involved (if required or otherwise planned). Using an oneM2M example, in case of semantic discovery, SU 230 may send a discovery request to a CSE (which implements a SE) and indicates where the discovery should start, e.g., a specific resource <resource-1> on the resource tree of this CSE. Accordingly, all child resources of <resource-1> will be evaluated respectively to see whether they should be included in the discovery result. In particular, for a given child resource (e.g., <resource-2>) to be evaluated, the SPARQL query will be applied to the semantic data stored in the <semanticDescriptor> child resource of <resource-2> to see whether there is match (If so, <resource-2> will be included in the discovery result). Accordingly, in this case, when evaluating <resource-2>, the semantic data stored in the <semanticDescriptor> child resource of <resource-2> is the IDB.

Similarly, in case of semantic query, SU 230 may send a sematic query request to a CSE (which implements a SE) and indicate how to collect related semantic data (e.g., the query scope), e.g., the semantic-related resources under a specific oneM2M resource <resource-1> should be collected. Accordingly, the decedent semantic-related resources of <resource-1> (e.g., those <semanticDescriptor> resources) may be collected together and the SPARQL query will be applied to the aggregated semantic data from those semantic-related resources in order to produce a semantic query result. Accordingly, in this case, the data stored in all the decedent semantic-related resources of <resource-1> is the IDB.

At step 222, based on the request sent from SU 230, SE 233 starts to conduct semantic resource discovery processing. Using the example associated with FIG. 5, <Camera-111> is one of the candidate resource, and SU 230 may evaluate whether <Camera-111> should be included in the discovery result by examining the semantic data in its <semanticDescriptor> child resource. In other words, the data stored in the <semanticDescriptor> child resource of <Camera-111> is the IDB (denoted as IDB-1) now. For example, for the semantic discovery case, every time when starting to evaluate one specific resource, a new IDB is decided and it may be used just for evaluating this specific resource. For example, IDB-1 may just include the following facts:
Fact-1: Camera-111 is-a Camera
Fact-2: Camera-111 is-located-in Room-109-of-Building-1

SE 233 also decides whether reasoning should be involved for processing this request.

In general, there may be the following potential ways for SE 233 to decide reasoning should be involved (this may be achieved by setting up some local policies or configurations on SE 233), which includes but not limited to:
If no result can be produced by SE 233 based on the original IDB-1, SE 233 may decide to leverage reasoning to augment IDB-1.
If SU 230 is a preferred user, which requires or requests a high-quality discovery, SE 233 may decide to leverage reasoning to augment IDB-1 (e.g., depend on the type of SU).
SE 233 may also be configured such that as long as it sees certain ontologies or the interested terms/concepts/properties used in IDB-1, SE 233 may decide to leverage reasoning to augment IDB-1. For example, when the SE 233 checks Fact-2 and it finds terms related to building number and room numbers (e.g., “Building-1” and “Room-109”) appeared in Fact-2, then it may decide to leverage reasoning to augment IDB-1.

If SE 233 decides to leverage reasoning to augment IDB-1, it may further contact SR 232. At step 224, SE 233 sends a request to SR 232 for a reasoning process, along with the information related to IDB-1, which will be as the Initial_InputFS for the reasoning process at SR 232. Note that, it is possible that in reality SE 233 and SR 232 are integrated together and implemented by a same entity, e.g., a same CSE in oneM2M context. SR 232 further decides whether additional FS (as Addi_InputFS) or RS (as Initial_RS) should be used for reasoning. Step 224, as shown in FIG. 13 regarding to how to decide which additional FS and RS should be utilized, may be re-used here. One extension is that SR 232 may not only check the key words or interested terms appeared in IDB-1, but also those appeared in the SPARQL statement shown step 221. After decision, SR 232 will retrieve those FS and RS. For example, SR 232 retrieves Addi_InputFS from FH 132 and Initial_RS from RH 136 respectively. In this example, SR 232 finds there is a key word “is-located-in” appeared in Fact-2 and key word “monitors-room-in” was appeared in the SPARQL query statement sent from SU 230 in Step 221, then SR 232 may decide that some useful information about MZ definition and room allocation may be utilized for a reasoning. Therefore, Addi_InputFS may include the following fact:
Fact-3: Room-109-of-Building-1 is-managed-under “MZ-1”

SE 233 also decides Initial_RS may include the following rule, since it also includes the two key words “is-located-in” and “is-managed-under”:
Rule-1: IF A is-located-in B && B is-managed-under C, THEN A monitors-room-in C

At step 226, based on IDB-1 and the collected Addi_InputFS and Initial_RS, SR 232 executes a reasoning process and yields the inferred facts (denoted as InferredFS-1). For example, SR 232 finds that:
Fact-2 can match the partial pattern in the IF part of Rule-1: A is-located-in B
Fact-3 can match the partial pattern in the IF part of Rule-1: B is-managed-under C

Accordingly, a new fact may be inferred, e.g., Camera-111 monitors-room-in MZ-1, which is denoted as InferredFS-1. At step 227, SR 232 sends back InferredFS-1 to SE 233. At step 228, SE 233 integrates the InferredFS-1 into IDB-1 (as a new IDB-2), and applies the original SPARQL statement over IDB-2 and yields the corresponding result. In the example, it means there will be a match when applying the SPARQL statement over IDB-2 (since now the new inferred fact InferredFS-1 is in IDB-2, it will match the pattern “?device monitors-room-in MZ-1” in the SPARQL statement) and therefore the URI of <Camera-111> will be included in the discover result). After that, SE 233 completes the evaluation for <Camera-111> and may continue to check the next resource to be evaluated. At step 229, After all the discovery processing is done by SE 233, it sends back the processing result (in terms of the discovery result in this case) to SU 230. For example, the URI of <Camera-111> may be included in the discovery result (which is the processing result) and sent back to SU 230.

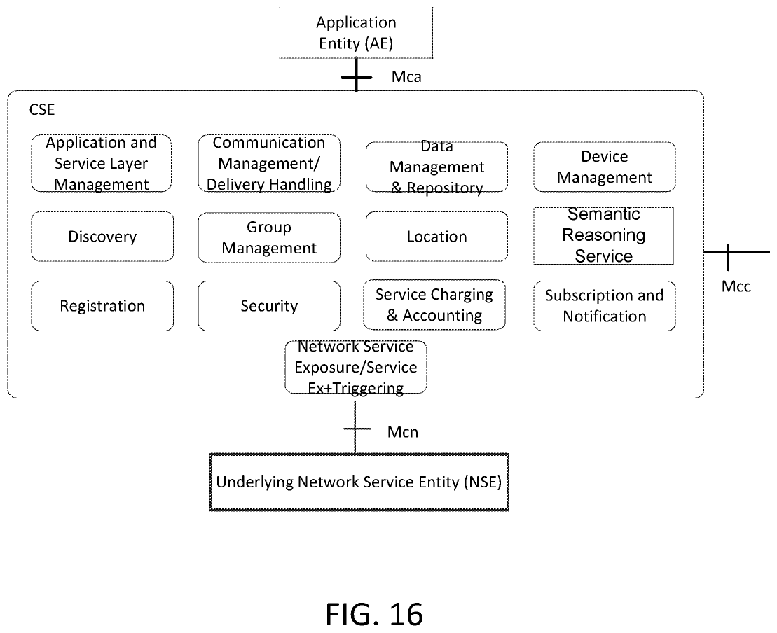

Semantic Reasoning CSF: The semantic reasoning CSF could be regarded as a new CSF in oneM2M service layer, as shown in FIG. 16 (Alternatively, it may also be part of the existing Semantics CSF defined in oneM2M TS-0001). It should be understood that, different types of M2M nodes may implement semantic reasoning service, such as M2M Gateways, M2M Servers, etc. In particular, depending on the various/different hardware/software capacities for those nodes, the capacities of semantic reasoning services implemented by those nodes may also be variant.

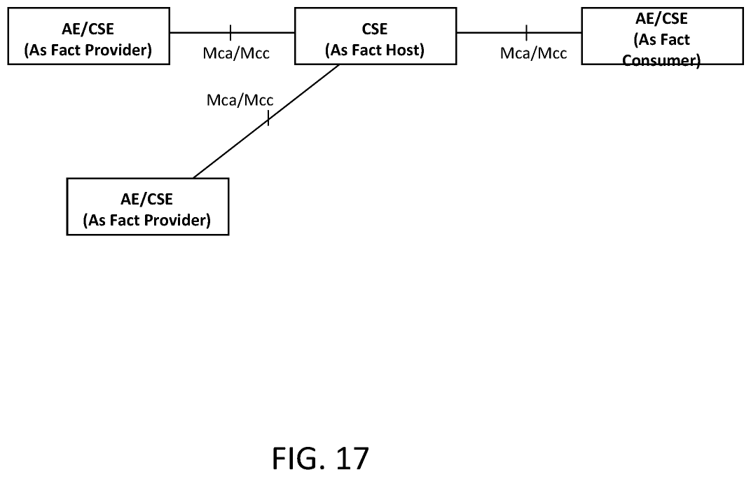

FIG. 17 shows the oneM2M examples for the entities defined for FS enablement. For example, a Fact Host may be a CSE in the oneM2M system and AE/CSE may be a Fact Provider or a Fact Consumer or a Fact Modifier.

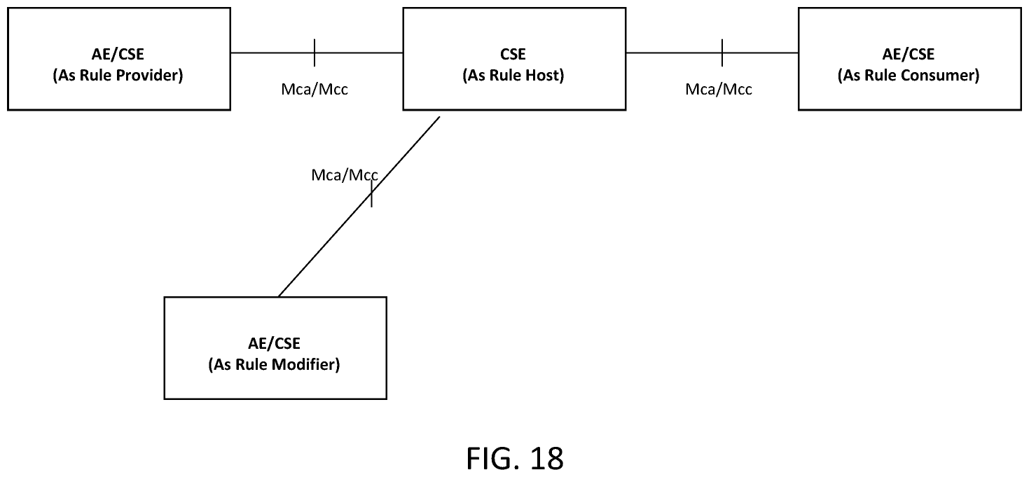

FIG. 18 shows the oneM2M examples for the entities defined for RS enablement. For example, a Rule Host may be a CSE in the oneM2M system and AE/CSE may be a Rule Provider or Rule Consumer or Rule Modifier.

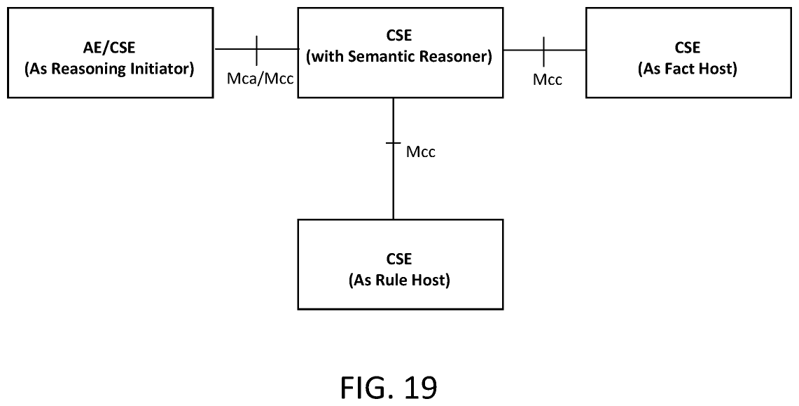

FIG. 19 shows the oneM2M examples for the entities involved in an individual semantic reasoning operation. For example, a CSE may provide semantic reasoning service if it is equipped with a semantic reasoner. In addition, AE/CSE may be a reasoning initiator. As discussed earlier, the involved entities defined in this disclosure are most logical roles. Therefore, one physical entity may take multiple logical roles. For example, when a CSE has the semantic reasoning capability (e.g., as a SR as shown in FIG. 19) and is required to or requests to retrieve certain FS and RS as inputs for a reasoning operation, this CSE will also have the roles of FC and RC as shown in FIG. 17 and FIG. 18.

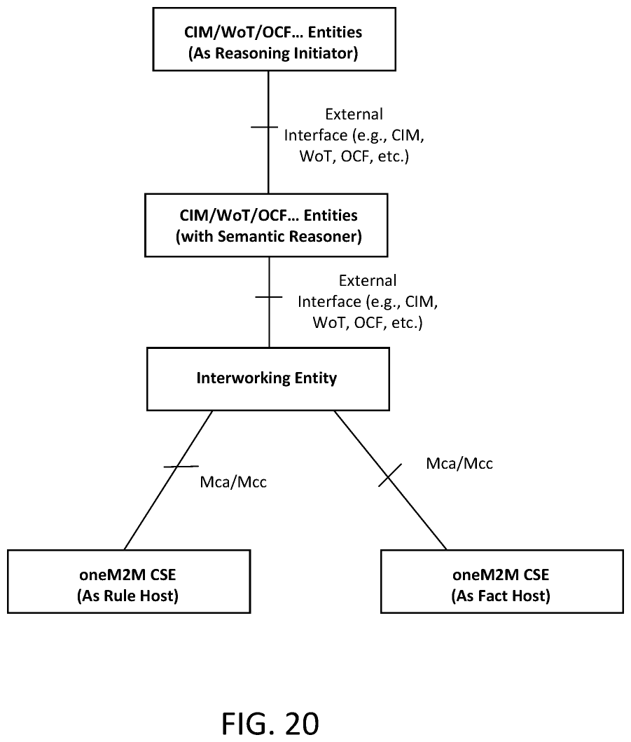

FIG. 20 shows another type of examples for the entities involved in an individual semantic reasoning operation. In this architecture, oneM2M system mainly provide facts and rules. For example, an oneM2M CSE may be regarded as a fact host or a rule host. There may be another layer (such as ETSI Context Information Management (CIM), W3C Web of Things (WoT) or Open Connectivity Foundation (OCF)) on top of oneM2M system, such that users' semantic reasoning requests may be from the upper layer. Accordingly, an external CIM/W3C WoT/OCF entity may be equipped with a semantic reasoner and reasoning initiators are mainly those entities from CIM/W3C WoT/OCF systems. In other words, those RIs will send reasoning requests to the semantic reasoner, which will further contact Interworking Entity and Interworking Entity will collect related FS and RS from oneM2M entities through oneM2M interface (Note that, FS may also be provided by other non-oneM2M entities as long as oneM2M may interact with it. For example, FS may also be provided by a Triple Store.). In the oneM2M system, there could be two types of entity may handle interworking, e.g., IPE-based interworking and CSE-based interworking. Accordingly, the Interworking Entity could refer to either a CSE or an IPE (which is a specialized AE) for supporting those two types of interworking.

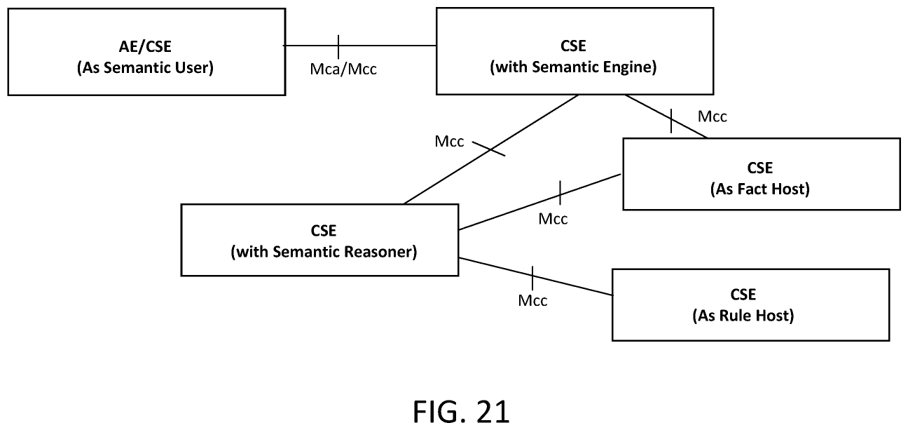

FIG. 21 shows the oneM2M examples for the entities involved in optimizing semantic operations with reasoning support. For example, a CSE may provide semantic reasoning capability if it is equipped with a semantic reasoner and a CSE may process other semantic operations (such as semantic resource discovery, semantic query, etc.) if it is equipped with a semantic engine. In addition, AE/CSE may be a semantic user to trigger a semantic operation. Note that, throughout all the examples in this section, a given logical entity is taken by a single AE or CSE, which is just for easy presentation. In fact, in a general case, a AE or a CSE may take the roles of multiple logistical entities. For example, a CSE may be a FH as well as a RH. Another example, CSE may host both a semantic reasoner and a semantic engine. Another example, a CSE may be a reasoning initiator and this CSE itself may also be equipped with a semantic reasoner.

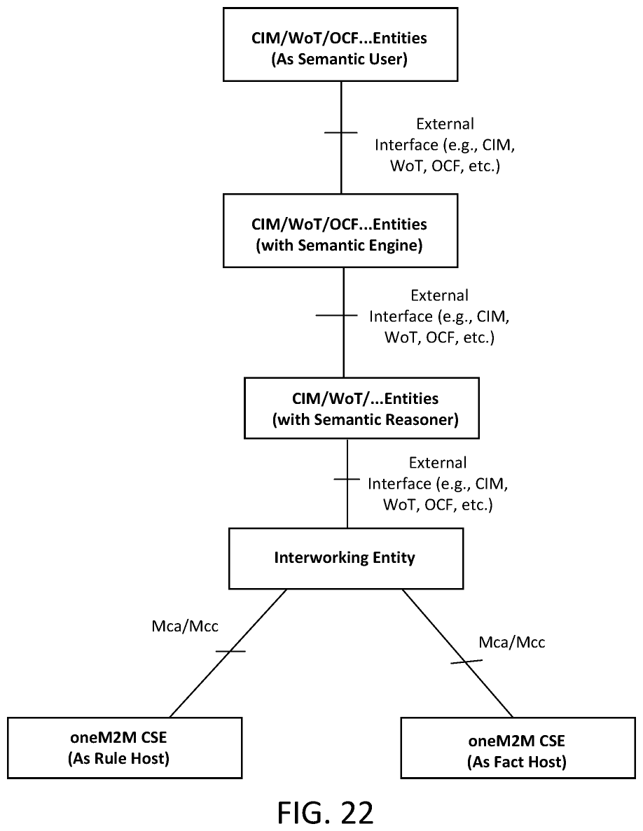

FIG. 22 shows another type of examples for the entities involved in optimizing semantic operations with reasoning support. In this architecture, oneM2M system mainly provide facts and rules. For example, an oneM2M CSE may be as a fact host or a rule host. There may be another layer (such as CIM, WoT or OCF) on top of oneM2M system, such that users' semantic reasoning requests may be from the upper layer. Accordingly, an external CIM/WoT/OCF entity may be equipped with a semantic engine and semantic users are mainly those entities from CIM/WoT/OCF systems. Similarly, an external CIM/WoT/OCF entity may be equipped with a semantic reasoner. In general, semantic users will send their requests to semantic engine for triggering certain semantic operations. The semantic engine may further contact semantic reasoner for reasoning support, and the reasoner will further go through the Interworking Entity to collect related FS and RS from oneM2M entities through oneM2M interface. Note that, FS may also be provided by other non-oneM2M entities as long as oneM2M may interact with it. For example, FS may also be provided by a Triple Store.

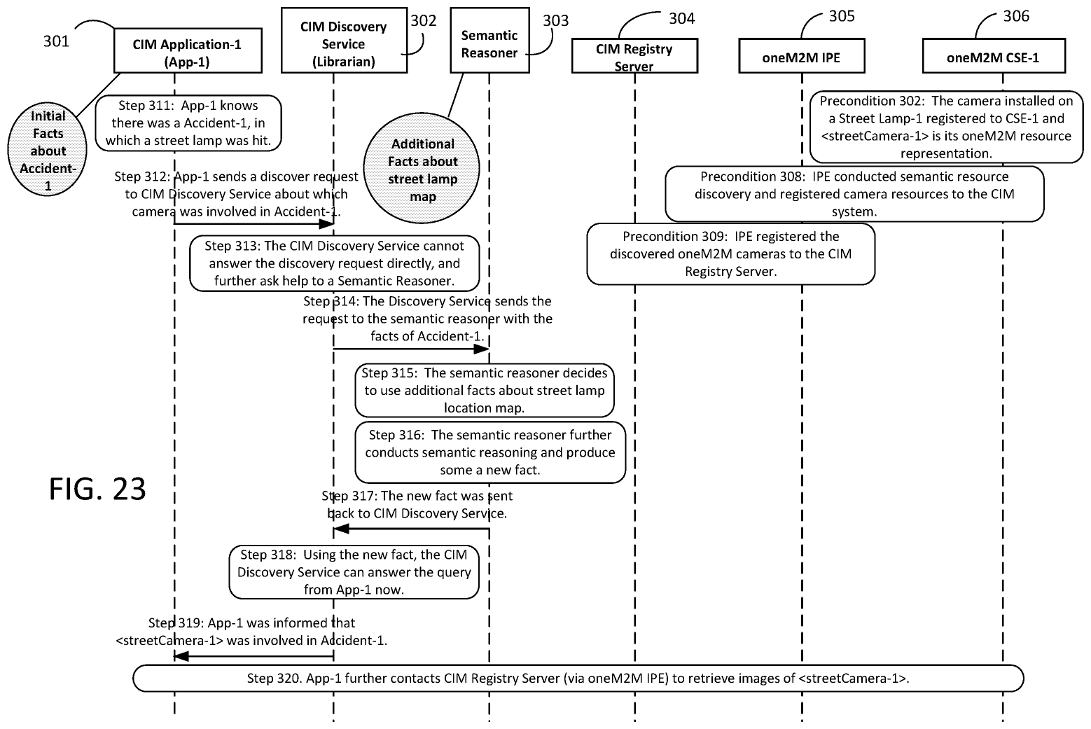

Below is a more concreate example of FIG. 22 for semantic query with reasoning support between ETSI CIM and oneM2M system; FIG. 23 illustrates the procedure and the detailed descriptions are as follows:

Precondition 0 (Step 307): The camera installed on a Street Lamp-1 registered to CSE-1 and <streetCamera-1> is its oneM2M resource representation and some semantic metadata is also associated with this resource. For example, one of the semantic metadata could be:
Fact-1: <streetCamera-1> is-installed-on streetLamp-1

Precondition 1 (Step 308): IPE conducted semantic resource discovery and registered camera resources to the CIM system, including the street camera-1 for example.

Precondition 2 (Step 309): IPE registered the discovered oneM2M cameras to the CIM Registry Server. Similarly, one of context information for <streetCamera-1> is that it was installed on Street Lamp-1 (e.g., Fact-1)

Step 311: an CIM application App-1 (which is city road monitoring department) knows there was an Accident-1 and has some facts or knowledge about Accident-1, e.g., the location of this accident:
Fact-2: Accident-1 has-incident-location “40.079136, −75.288823”

App-1 intends to collect images from the camera that was installed on the street lamp (which was hit in Accident-1) in order to see whether the camera was broken. Accordingly, the query statement can be written as (note that, here the statement is written using SPARQL language, which is just for easy presentation. In other words, query statement can be written in any form that is supported by CIM):

```
SELECT ?camera
WHERE {
  ?device  is-a Camera
  ?device  is-involved-in  Accident-1
}
```

Step 312: App-1 sends a discover request to CIM Discovery Service about which camera was involved in Accident-1, along with Fact-2 about Accident-1 (such as its location).

Step 313: The CIM Discovery Service cannot answer the discovery request directly, and further ask help to a Semantic Reasoner.

Step 314: The Discovery Service sends the request to the semantic reasoner with Fact-2, and also the semantic information of the cameras (including Fact-1 about <streetCamera-1>). In other words, Fact-1 and Fact-2 may be regarded as the “Initial_InputFS”.

Step 315: The semantic reasoner decides to use additional facts about street lamp location map. For example, since Fact-2 just includes the geographical location about the accident, the semantic reasoner may require or request more information about street lamps in order to decide which street lamp is involved. For example, Fact-3 is an additional fact about streetLamp-1.
Fact-3: streetLamp-1 has-incident-location “40.079236, −75.288623”

Step 316: The semantic reasoner further conducts semantic reasoning and produce some a new fact (<streetCamera-1> was involved in Accident-1). For example, Rule-1 as shown below can be used to deduce a new fact (Inferred Fact-1) that streetlamp-1 was involved in Accident-1.
Rule-1: IF A has-location Coordination-1 and B has-location Coordination-2 and distance(Coordination-1, Coordination-2)<20 meters, THEN A is-involved-in B
Inferred Fact-1: streetlamp-1 is-involved-in Accident-1

Further, with Inferred Fact-1 and Fact-1, another reasoning may be executed by using the following rule (Rule-2) and another inferred fact may be deduced (e.g., Inferred Fact-2):
Rule-1: IF A is-involved-in B and C is-installed-on A THEN C is-involved-in B
Inferred Fact-2: <streetCamera-1> is-involved-in Accident-1

Step 317: The new fact was sent back to CIM Discovery Service. Step 318: Using the new fact, the CIM Discovery Service may answer the query from App-1 now since the Inferred Fact-2 shows that <streetCamera-1> is the camera that was involved in Accident-1. Step 319: App-1 was informed that <streetCamera-1> was involved in Accident-1. Step 320. App-1 further contacts CIM Registry Server to retrieve images of <streetCamera-1> and Registry Server will further ask oneM2M IPE to retrieve images from <streetCamera-1> resource in the oneM2M system.

<facts> Resource Definition: A given FS could refer to different types of knowledge. First, a FS may refer to an ontology, which describes a domain knowledge for a given use case (e.g., the smart city use case associated with FIG. 5, in which many domain concepts/class and their relationships are defined, such as hospital, city fire department, building, rooms, etc.). Accordingly, such type of FS may be embodied as a oneM2M <ontology> resource. Second, a FS could also refer to a semantic annotation about a resource/entity/thing in the system. Still using the previous example associated with FIG. 5, a FS could be the semantic annotations for Camera-111, which is deployed in Room-109 of Building-1. Accordingly, such type of FS may be embodied as an oneM2M <semanticDescriptor> resource.

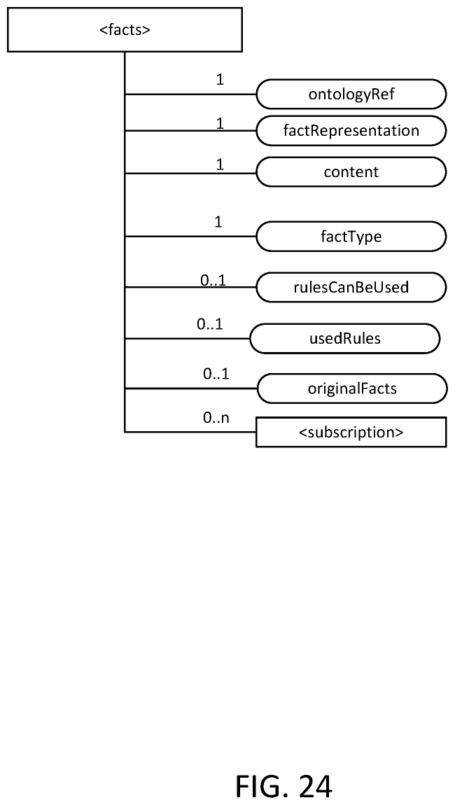

A FS could also refer to facts related to specific instances. Still using the previous example associated with FIG. 5, a FS may describe the current management zones definitions of hospital such as its building/room arrangement/allocation information (e.g., management zone MZ-1 includes rooms used for storing blood testing samples, e.g., Room-109 in Building-1, Room-117 in Building-3, etc.). Note that, for this type of facts, it could individually exist in the system, e.g., not necessarily to be as semantic annotations for other resources/entities/things. Accordingly, a new type of oneM2M resource (called <facts>) is defined to store such type of FS. Note that, it could be named with a different name, as long as it has the same purpose. The resource structure of <facts> is shown in FIG. 24. A FS could also refer to <contentInstance> resource if this resource may be used to store semantic type of data. In addition, to be more general, A FS may refer to any future new resource types defined by oneM2M as long as they may store semantic type of data.

The <facts> resource above may include one or more of the child resources specified in Table 2.

TABLE 2
Child resources of <facts> resource

| Child | | | <factsAnnc> |
|---|---|---|---|
| Resources of | Child Resource | | Child Resource |
| <facts> | Type | Description | Types |
| [variable] | <subscription> | See clause 9.6.8 in | <subscription> |
| | | oneM2M-TS-0001 | |
| | | oneM2M Functional | |
| | | Architecture- | |
| | | V3.8.0 [1] | |
| | | where the type of this | |
| | | resource is described. | |

The <facts> resource above may include one or more of the attributes specified in Table 3.

TABLE 3
Attributes of <facts> resource

| | | <factsAnnc> |
|---|---|---|
| Attribute Name | Description | Attributes |
| resourceName | See clause 9.6.1.3 in [1]. | NA |
| parentID | See clause 9.6.1.3 in [1]. | NA |
| expiration Time | See clause 9.6.1.3 in [1]. | NA |
| accessControlPolicyIDs | See clause 9.6.1.3 in [1]. | NA |
| labels | See clause 9.6.1.3 in [1]. | MA |
| creationTime | See clause 9.6.1.3 in [1]. | MA |
| lastModifiedTime | See clause 9.6.1.3 in [1]. | MA |
| announceTo | See clause 9.6.1.3 in [1]. | NA |
| announcedAttribute | See clause 9.6.1.3 in [1]. | NA |
| dynamicAuthorization | See clause 9.6.1.3 in [1]. | OA |
| ConsultationIDs | | |
| creator | See clause 9.6.1.3 in [1]. | NA |
| ontologyRef | A reference (URIs) of the | OA |
| | ontologies used to | |
| | represent the information | |
| | that is stored in the content | |
| | attribute. | |
| factRepresentation | Indicates the type used for | OA |
| | the serialization of the | |
| | content attribute, e.g. RDF | |
| | serialized in XML. | |
| content | Stores a set of facts. The | OA |
| | facts shall be described as | |
| | RDF triples according to | |
| | ontologies referred by the | |
| | ontologyRef attribute. | |
| factType | This is to indicate whether | OA |
| | the facts stored in this | |
| | resource is a set of original | |
| | facts, or a set of inferred | |
| | facts due to a semantic | |
| | reasoning operation. Note | |
| | that, even if this resource | |
| | stores the inferred facts, | |
| | those inferred facts may | |
| | still be as the inputs for | |
| | future reasoning | |
| | operations. | |
| rulesCanBeUsed | This attribute is to | OA |
| | indicate/suggest which | |
| | candidate reasoning rules | |
| | may be used/applied over | |
| | the facts stored in this | |
| | resource for a reasoning. | |
| | This attribute includes the | |
| | URIs of those candidate | |
| | <reasoningRules> | |
| | resources, but they are just | |
| | suggestions. This attribute | |
| | corresponds to the “related | |
| | rules” about a given FS | |
| | discussed herein. | |
| usedRules | This attribute is present | OA |
| | when the facts stored in | |
| | this resource is a set of | |
| | inferred facts. This | |
| | attribute includes the URIs | |
| | of <reasoningRules> | |
| | resources, which store the | |
| | reasoning rules that were | |
| | used for inferring the facts | |
| | stored in this resource. | |
| originalFacts | This attribute is present | OA |
| | when the facts stored in | |
| | this resource is a set of | |
| | inferred facts. This | |
| | attribute includes the URIs | |
| | of facts-related resources | |
| | (such as | |
| | <semanticDescriptor>, | |
| | <ontology>, <facts>, etc.), | |
| | which store the facts that | |
| | were used as inputs for | |
| | deducing the facts stored | |
| | in this resource. | |

Note that, the CRUD operations on the <facts> resource as introduced below will be the oneM2M examples of the related procedures introduced herein with regard to enabling the semantic reasoning data. Note that since the <semanticDescriptor> resource may also be used to store facts (e.g., using the “descriptor” attribute), the attributes such as factType, rulesCanBeUsed, usedRules, originalFacts may also be as the new attributes for the existing <semanticDescriptor> resource for supporting the semantic reasoning purpose. For example, assuming <SD-1> and <SD-2> are type of <semanticDescriptor> resources and are the semantic annotations of <CSE-1>. <SD-1> could be the original semantic annotation of <CSE-1>. In comparison, <SD-2> is an additional semantic annotation of <CSE-1>. For example, the “factType” of <SD-2> may indicate that the triples/facts stored in the “descriptor” attribute of <SD-2> resource is the reasoning result (e.g., inferred facts) based on a semantic reasoning operation. In other words, the semantic annotation stored in <SD-2> was generated through semantic reasoning. Similarly, the rulesCanBeUsed, usedRules, originalFacts attributes of <SD-2> may further indicate the detailed information about how the facts stored <SD-2> was generated (based on which inputFS and reasoning rules), and how the facts stored in <SD-2> may be used for other reasoning operations.

Create <facts>: The procedure used for creating a <facts> resource.

TABLE 4
<facts> CREATE
<facts> CREATE

| | |
|---|---|
| Associated | Mca, Mcc and Mcc′. |
| Reference Point | |
| Information in | All parameters defined in [1] |
| Request message | table 8.1.2-2 apply with the specific |
| | details for: |
| | Content: The resource content |
| | shall provide the information as defined |
| | in <facts> resource. |
| Processing at | According to [1] clause 10.1.2 in [1] |
| Originator before | |
| sending Request | |
| Processing at | According to [1] clause 10.1.2 in [1] |
| Receiver | |
| Information in | According to [1] clause 10.1.2 in [1] |
| Response message | |
| Processing at | According to [1] clause 10.1.2 in [1] |
| Originator after | |
| receiving Response | |
| Exceptions | According to [1] clause 10.1.2 in [1] |

Retrieve <facts>: The procedure used for retrieving the attributes of a <facts> resource.

TABLE 5
<facts> RETRIEVE
<facts> RETRIEVE

| | |
|---|---|
| Associated | Mca, Mcc and Mcc′. |
| Reference Point | |
| Information in | All parameters defined in table 8.1.2-2 in |
| Request message | [1] apply with the specific |
| | details for: |
| | Content: attributes of the <facts> resource. |
| Processing at | According to [1] clause 10.1.3 in [1]. |
| Originator before | |
| sending Request | |
| Processing at | According to [1] clause 10.1.3 in [1]. |
| Receiver | |
| Information in | According to [1] clause 8.1.3 in [1]. |
| Response message | |
| Processing at | According to [1] clause 10.1.3 in [1]. |
| Originator after | |
| receiving Response | |
| Exceptions | According to [1] clause 10.1.3 in [1]. |

Update <facts>: The procedure used for updating attributes of a <facts > resource.

TABLE 6
<facts> UPDATE
<facts> UPDATE

| | |
|---|---|
| Associated | Mca, Mcc and Mcc′ |
| Reference Point | |
| Information in | All parameters defined in table 8.1.2-2 in [1] |
| Request message | apply with the specific |
| | details for: |
| | Content: attributes of the <facts> resource. |
| Processing at | According to clause 10.1.4 in [1]. |
| Originator before | |
| sending Request | |
| Processing at | According to clause 10.1.4 in [1]. |
| Receiver | |
| Information in | According to clause 10.1.4 in [1]. |
| Response message | |
| Processing at | According to clause 10.1.4 in [1]. |
| Originator after | |
| receiving Response | |
| Exceptions | According to clause 10.1.4 in [1]. |

Delete <facts>: The procedure used for deleting a <facts> resource.

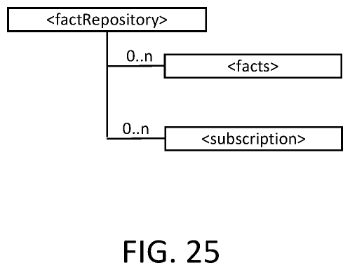

TABLE 7
<facts> DELETE
<facts> DELETE

| | |
|---|---|
| Associated | Mca, Mcc and Mcc' |
| Reference Point | |
| Information in | All parameters defined in table 8.1.2-2 in [1]. |
| Request message | |
| Processing at | According to clause 10.1.5 in [1]. |
| Originator before | |
| sending Request | |
| Processing at | According to clause 10.1.5 in [1]. |
| Receiver | |
| Information in | According to clause 10.1.5 in [1]. |
| Response message | |
| Processing at | According to clause 10.1.5 in [1]. |
| Originator after | |
| receiving Response | |
| Exceptions | According to clause 10.1.5 in [1]. |

<factRepository> Resource Definition: In general, a <facts> resource may be stored anywhere, e.g., as a child resource of <AE> or <CSEBase> resource. Alternatively, a new <factRepository> may be defined as a new oneM2M resource type, which may be a hub to store multiple <facts> such that it is easier to find the required or requested facts. An <factRepository> resource may be a child resource of the <CSEBase> or a <AE> resource. The resource structure of <factRepository> is shown in FIG. 25.

The <factRepository> resource shall contain the child resources as specified in Table 8.

TABLE 8
Child resources of <factRepository> resource

| Child | | | <factRepository |
|---|---|---|---|
| Resources of | Child Resource | | Annc> Child |
| <factRepository> | Type | Description | Resource Types |
| [variable] | <facts> | <facts> resource | <factsAnnc> |
| | | for describing | |
| | | a fact set. | |
| [variable] | <subscription> | See clause | <subscription> |
| | | 9.6.8 in [1] | |

The <factRepository> resource above may include one or more of the attributes specified in Table 9.

TABLE 9
Attributes of <factRepository> resource

| | | <fact Repo- |
|---|---|---|
| | | sitoryAnnc> |
| Attribute Name | Description | Attributes |
| resourceName | See clause 9.6.1.3 in | NA |
| | [1]. | |
| parentID | See clause 9.6.1.3 in | NA |
| | [1]. | |
| expirationTime | See clause 9.6.1.3 in | NA |
| | [1]. | |
| accessControlPolicyIDs | See clause 9.6.1.3 in | NA |
| | [1]. | |
| labels | See clause 9.6.1.3 in | MA |
| | [1]. | |
| creationTime | See clause 9.6.1.3 in | MA |
| | [1]. | |
| lastModifiedTime | See clause 9.6.1.3 in | MA |
| | [1]. | |
| announceTo | See clause 9.6.1.3 in | NA |
| | [1]. | |
| announcedAttribute | See clause 9.6.1.3 in | NA |
| | [1]. | |
| dynamicAuthorization | See clause 9.6.1.3 in | OA |
| ConsultationIDs | [1]. | |
| creator | See clause 9.6.1.3 in | NA |
| | [1]. | |

Create <factRepository>: The procedure used for creating a <factRepository> resource.

TABLE 10
<factRepository> CREATE
<factRepository> CREATE

| | |
|---|---|
| Associated | Mca, Mcc and Mcc' |
| Reference Point | |
| Information in | All parameters defined in table 8.1.2-2 in oneM2M |
| Request message | TS-0001 [1] apply with the specific details for: |
| | Content: The resource content shall provide the |
| | information as defined in the resource definition |
| | of <factRepository> resource. |
| Processing at | According to clause 10.1.2 in oneM2M TS-0001 [1]. |
| Originator before | |
| sending Request | |
| Processing at | According to clause 10.1.2 in oneM2M TS-0001 [1]. |
| Receiver | |
| Information in | According to clause 10.1.2 in oneM2M TS-0001 [1]. |
| Response message | |
| Processing at | According to clause 10.1.2 in oneM2M TS-0001 [1]. |
| Originator after | |
| receiving Response | |
| Exceptions | According to clause 10.1.2 in oneM2M TS-0001 [1]. |

Retrieve <factRepository>: The procedure used for retrieving <factRepository> resource.

TABLE 11
<factRepository> RETRIEVE
<factRepository> RETRIEVE

| | |
|---|---|
| Associated | Mca, Mcc and Mcc'. |
| Reference Point | |
| Information in | All parameters defined in table 8.1.2-2 in oneM2M |
| Request message | TS-0001 apply with the specific details for: |
| | Content: attributes of the <factRepository> resource. |
| Processing at | According to clause 10.1.3 in oneM2M TS-0001 [1]. |
| Originator before | |
| sending Request | |
| Processing at | According to clause 10.1.3 in oneM2M TS-0001 . |
| Receiver | |
| Information in | All parameters defined in table 8.1.3-1 in |
| Response message | oneM2M TS-0001 [1] apply. |
| Processing at | According to clause 10.1.3 in oneM2M TS-0001 [1]. |
| Originator after | |
| receiving Response | |
| Exceptions | According to clause 10.1.3 in oneM2M TS-0001 [1]. |

Update <factRepository>: The procedure used for updating an existing <factRepository> resource.

TABLE 12
<factRepository> UPDATE
<factRepository> UPDATE

| | |
|---|---|
| Associated | Mca, Mcc and Mcc' |
| Reference Point | |
| Information in | All parameters defined in table 8.1.2-2 in oneM2M |
| Request message | TS-0001 [1] apply with the specific details for: |
| | Content: attributes of the <factRepository> resource. |
| Processing at | According to clause 10.1.4 in oneM2M TS-0001 [1]. |
| Originator before | |
| sending Request | |
| Processing at | According to clause 10.1.4 in oneM2M TS-0001 [1]. |
| Receiver | |
| Information in | According to clause 10.1.4 in oneM2M TS-0001 [1]. |
| Response message | |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

Delete <factRepository>: The procedure used for deleting an existing <factRepository> resource.

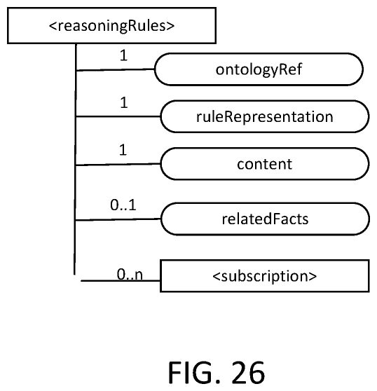

TABLE 13
<factRepository> DELETE
<factRepository> DELETE

| | |
|---|---|
| Associated | Mca, Mcc and Mcc' |
| Reference Point | |
| Information in | All parameters defined in table 8.1.2-2 apply in |
| Request message | oneM2M TS-0001 [1]. |
| Processing at | According to clause 10.1.5 in oneM2M TS-0001 [1]. |
| Originator before | |
| sending Request | |
| Processing at | According to clause 10.1.5 in oneM2M TS-0001 [1]. |
| Receiver | |
| Information in | According to clause 10.1.5 in oneM2M TS-0001 [1]. |
| Response message | |
| Processing at | According to clause 10.1.5 in oneM2M TS-0001 [1]. |
| Originator after | |
| receiving Response | |
| Exceptions | According to clause 10.1.5 in oneM2M TS-0001 [1]. |

<reasoningRules> Resource Definition: A new type of oneM2M resource (called <reasoningRules>) is defined to store a RS, which is used to store (user-defined) reasoning rules. Note that, it could be named with a different name, as long as it has the same purpose. The resource structure of <reasoningRules> is shown in FIG. 26.

The <reasoningRules> resource above may include one or more of the child resources specified in Table 14.

TABLE 14
Child resources of <factRepository> resource

| Child | | | <reasoningRules |
|---|---|---|---|
| Resources of | Child Resource | | Annc> Child |
| <reasoningRules> | Type | Description | Resource Types |
| [variable] | <subscription> | See clause 9.6.8 | <subscription> |
| | | in [1] where the | |
| | | type of this resource | |
| | | is described | |

The <reasoningRules> resource above may include one or more of the attributes specified in Table 15.

TABLE 15
Attributes of <reasoningRules> resource

| | | <reasoning |
|---|---|---|
| | | RulesAnnc> |
| Attribute Name | Description | Attributes |
| resourceName | See clause 9.6.1.3 in [1]. | NA |
| parentID | See clause 9.6.1.3 in [1]. | NA |
| expirationTime | See clause 9.6.1.3 in [1]. | NA |
| accessControlPolicyIDs | See clause 9.6.1.3 in [1]. | NA |
| labels | See clause 9.6.1.3 in [1]. | MA |
| creationTime | See clause 9.6.1.3 in [1]. | MA |
| lastModifiedTime | See clause 9.6.1.3 in [1]. | MA |
| announceTo | See clause 9.6.1.3 in [1]. | NA |
| announcedAttribute | See clause 9.6.1.3 in [1]. | NA |
| dynamicAuthorization | See clause 9.6.1.3 in [1]. | OA |
| ConsultationIDs | | |
| creator | See clause 9.6.1.3 in [1]. | NA |
| ontologyRef | A reference (URIs) of the | OA |
| | ontologies used to represent the | |
| | reasoning rules that are stored in | |
| | the content attribute. | |
| ruleRepresentation | Indicates the format of the rules, | OA |
| | e.g. RIF (An example of how to | |
| | use RIF to represent a reasoning | |
| | rule is shown below). | |
| content | Stores a set of rules. | OA |
| relatedFacts | This is to indicate/suggest which | OA |
| | potential facts may be used | |
| | together with the rules in this | |
| | <reasoningRule> resource for a | |
| | reasoning. This attribute may | |
| | either 1) store a list of fact- | |
| | related resources such as | |
| | <semanticDescriptor>, | |
| | <ontology>, <facts> resources | |
| | etc.; or 2) just include a list of | |
| | ontologies, which means as long | |
| | as the ontologyRef attribute of a | |
| | given facts-related resource | |
| | includes any part of the | |
| | ontologies indicated by this | |
| | attribute, the rules in this | |
| | <reasoningRules> resource may | |
| | be used together with that | |
| | resource for a reasoning, or 3) | |
| | just include a list of key words, | |
| | which means as long as the a | |
| | given facts-related resource | |
| | includes any key word indicated | |
| | by this attribute, the rules in this | |
| | <reasoningRules> resource may | |
| | be used together with that | |
| | resource for a reasoning. | |

Below is the example how to use RIF for representing a reasoning rule. Consider the following reasoning rule used in this disclosure:
Rule-1: IF A is-located-in B && B is-managed-under C, THEN A monitors-room-in C

Rule-1 may be written as the following RIF rule (the words in Bold are the key words defined by RIF syntax, and more details for RIF specification may be found in RIF Primer, https://www.w3.org/2005/rules/wiki/Primer [12]):

```
Document(
  Prefix(rdf <http://www.w3.org/1999/02/22-rdf-syntax-ns#>)
  Prefix(rdfs <http://www.w3.org/2000/01/rdf-schema#>)
  Prefix(exA <http://example.com/#>)
  Prefix(exB <http://example.com/#>)
  Group(
    Forall ?Camera ?Room ?MZ (
      If  And(
          ?Camera # exA:Camera
          ?Room # exA:Room
          ?MZ # exB:ManagementZone
          exA:is-located-in (?Camera ?Room)
          exB:is-managed-under (?Room ?MZ)
        )
      Then exC: monitors-room-in (?Camera ?MZ)
    )
  )
)
```

The explanations for the above rules may be provided by the following five explanations. Explanation 1: The above rule basically follows the Abstract Syntax in term of If . . . Then form. Explanation 2: Two operators, Group and Document, may be used to write rules in RIF. Group is used to delimit, or group together, a set of rules within a RIF document. A document may contain many groups or just one group. Similarly, a group may consist of a single rule, although they are generally intended to group multiple rules together. It is necessary to have an explicit Document operator because a RIF document may import other documents and may thus itself be a multi-document object. For practical purposes, it is sufficient to know that the Document operator is generally used at the beginning of a document, followed by a prefix declaration and one or more groups of rules.

Explanation 3: Predicate constants like “is-located-in” cannot be just used ‘as is’ but may be disambiguated. This disambiguation addresses the issue that the constants used in this rule come from more than one source and may have different semantic meanings. In RIF, disambiguation is effected using IRIs, and the general form of a prefix declaration by writing the prefix declaration Prefix(ns< ThisIRI>). Then the constant name may be disambiguated in rules using the string ns:name. For example, the predicate “is-located-in” is the predicate defined by the example ontology A (with prefix “exA”) while the predicate “is-managed-under” is the predicate defined by another example ontology B (with prefix “exB”) and the predicate “monitors-room-in” is the predicate defined by another example ontology C (with prefix “exC”).

Explanation 4: Similarly, for the variable starting with “?” (e.g., ?Camera), it is also necessary to define which type of instances may be as the input for that variable by using a special sign “#” (which is equal to the predicate “is-type-of” as defined in RDF schema). For example, “?Camera # exA:Camera” means that just the instances of the Class Camera defined in ontology A may be used as the input for ?Camera variable. Explanation 5: The above rule may include a conjunction, and in RIF, a conjunction is rewritten in prefix notation, e.g. the binary A and B is written as And(A B).

Note that, the CRUD operations on the <reasoningRules> resource as introduced below are oneM2M examples of the related procedures introduced herein with regard to RS enablement.

Create <reasoningRules>: The procedure used for creating a <reasoningRules> resource.

TABLE 16
<reasoningRules> CREATE
<reasoningRules> CREATE

| | |
|---|---|
| Associated | Mca, Mcc and Mcc' |
| Reference Point | |
| Information in | All parameters defined in [1] table 8.1.2-2 apply |
| Request message | with the specific details for: |
| | Content: The resource content shall provide |
| | the information as defined in the resource |
| | definition of <reasoningRules> resource. |
| Processing at | According to [1] clause 10.1.2 in [1] |
| Originator before | |
| sending Request | |
| Processing at | According to [1] clause 10.1.2 in [1] |
| Receiver | |
| Information in | According to [1] clause 10.1.2 in [1] |
| Response message | |
| Processing at | According to [1] clause 10.1.2 in [1] |
| Originator after | |
| receiving Response | |
| Exceptions | According to [1] clause 10.1.2 in [1] |

Retrieve <reasoningRules>: The procedure used for retrieving the attributes of a <reasoningRules> resource.

TABLE 17
<reasoningRules> RETRIEVE
<reasoningRules> RETRIEVE

| | |
|---|---|
| Associated | Mca, Mcc and Mcc'. |
| Reference Point | |
| Information in | All parameters defined in table 8.1.2-2 in [1] |
| Request message | apply with the specific details for: |
| | Content: attributes of the reasoningRules resource. |
| Processing at | According to [1] clause 10.1.3 in [1]. |
| Originator before | |
| sending Request | |
| Processing at | According to [1] clause 10.1.3 in [1]. |
| Receiver | |
| Information in | All parameters defined in table 8.1.3-1 in [1]. |
| Response message | |
| Processing at | According to [1] clause 10.1.3 in [1]. |
| Originator after | |
| receiving Response | |
| Exceptions | According to [1] clause 10.1.3 in [1]. |

Update <reasoningRules>: The procedure used for updating attributes of a <reasoningRules> resource.

TABLE 18
<reasoningRules> UPDATE
<reasoningRules> UPDATE

| | |
|---|---|
| Associated | Mca, Mcc and Mcc' |
| Reference Point | |
| Information in | All parameters defined in table 8.1.2-2 in [1] |
| Request message | apply with the specific details for: |
| | Content: attributes of the <reasoningRules> resource. |
| Processing at | According to clause 10.1.4 in [1]. |
| Originator before | |
| sending Request | |
| Processing at | According to clause 10.1.4 in [1]. |
| Receiver | |
| Information in | According to clause 10.1.4 in [1]. |
| Response message | |
| Processing at | According to clause 10.1.4 in [1]. |
| Originator after | |
| receiving Response | |
| Exceptions | According to clause 10.1.4 in [1]. |

Delete <reasoningRules>: The procedure used for deleting a <reasoningRules> resource.

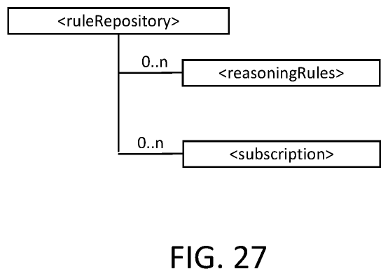

TABLE 19
<reasoningRules> DELETE
<reasoningRules> DELETE

| | |
|---|---|
| Associated | Mca, Mcc and Mcc' |
| Reference Point | |
| Information in | All parameters defined in table 8.1.2-2 in [1]. |
| Request message | |
| Processing at | According to clause 10.1.5 in [1]. |
| Originator before | |
| sending Request | |
| Processing at | According to clause 10.1.5 in [1]. |
| Receiver | |
| Information in | According to clause 10.1.5 in [1]. |
| Response message | |
| Processing at | According to clause 10.1.5 in [1]. |
| Originator after | |
| receiving Response | |
| Exceptions | According to clause 10.1.5 in [1]. |

<ruleRepository> Resource Definition: In general, a <reasoningRules> resource may be stored in anywhere, e.g., as a child resource of <AE> or <CSEBase> resource. Alternatively, a new <ruleRepository> may be defined as a new oneM2M resource type, which may be as a hub to store multiple <reasoningRules> such that it is easier to find the required or requested rules. An <ruleRepository> resource may be a child resource of the <CSEBase> or a <AE> resource. The resource structure of <ruleRepository> is shown in FIG. 27.

The <ruleRepository> resource may include one or more of the child resources as specified in Table 8.

TABLE 20
Child resources of <ruleRepository> resource

| Child | | | <ruleRepositoiy |
|---|---|---|---|
| Resources of | Child Resource | | Annc> Child |
| <ruleRepository> | Type | Description | Resource Types |
| [variable] | <reasoningRules> | <reasoningRules> | <reasoningRules |
| | | resource for | Annc> |
| | | describing a set of | |
| | | reasoning rules. | |
| [variable] | <subscription> | See clause 9.6.8 | <subscription> |
| | | in [1] | |

The <ruleRepository> resource above may include one or more of the attributes specified in Table 9.

TABLE 21
Attributes of <ruleRepository> resource

| | | <ruleRepositor |
|---|---|---|
| | | yAnnc> |
| Attribute Name | Description | Attributes |
| resourceName | See clause 9.6.1.3 in [1]. | NA |
| parentID | See clause 9.6.1.3 in [1]. | NA |
| expirationTime | See clause 9.6.1.3 in [1]. | NA |
| accessControlPolicyIDs | See clause 9.6.1.3 in [1]. | NA |
| labels | See clause 9.6.1.3 in [1]. | MA |
| creationTime | See clause 9.6.1.3 in [1]. | MA |
| lastModifiedTime | See clause 9.6.1.3 in [1]. | MA |
| announceTo | See clause 9.6.1.3 in [1]. | NA |
| announcedAttribute | See clause 9.6.1.3 in [1]. | NA |
| dynamicAuthorization | See clause 9.6.1.3 in [1]. | OA |
| ConsultationIDs | | |
| creator | See clause 9.6.1.3 in [1]. | NA |

Create <ruleRepository>: The procedure used for creating a <ruleRepository> resource.

TABLE 22
<ruleRepository> CREATE
<ruleRepository> CREATE

| | |
|---|---|
| Associated | Mca, Mcc and Mcc′ |
| Reference Point | |
| Information in | All parameters defined in table 8.1.2-2 in oneM2M TS-0001 [1] apply |
| Request message | with the specific details for: |
| | Content: The resource content shall provide the information as defined |
| | in the resource definition of <ruleRepository> resource. |
| Processing at | According to clause 10.1.2 in oneM2M TS-0001 [1]. |
| Originator before | |
| sending Request | |
| Processing at | According to clause 10.1.2 in oneM2M TS-0001 [1]. |
| Receiver | |
| Information in | According to clause 10.1.2 in oneM2M TS-0001 [1]. |
| Response message | |
| <ruleRepository> | CREATE |
| Processing at | According to clause 10.1.2 in oneM2M TS-0001 [1]. |
| Originator after | |
| receiving Response | |
| Exceptions | According to clause 10.1.2 in oneM2M TS-0001 [1]. |

Retrieve <ruleRepository>: The procedure used for retrieving <ruleRepository> resource.

TABLE 23
<ruleRepository> RETRIEVE
<ruleRepository> RETRIEVE

| | |
|---|---|
| Associated | Mca, Mcc and Mc′. |
| Reference Point | |
| Information in | All parameters defined in table 8.1.2-2 in oneM2M TS-0001 [1] |
| Request message | apply with the specific details for: |
| | Content: attributes of the <ruleRepository> resource. |
| Processing at | According to clause 10.1.3 in oneM2M TS-0001 [1]. |
| Originator before | |
| sending Request | |
| Processing at | According to clause 10.1.3 in oneM2M TS-0001 [1]. |
| Receiver | |
| Information in | All parameters defined in table 8.1.3-1 in oneM2M TS-0001 [1] |
| Response message | apply. |
| Processing at | According to clause 10.1.3 in oneM2M TS-0001 [1] . |
| Originator after | |
| receiving Response | |
| Exceptions | According to clause 10.1.3 in oneM2M TS-0001 [1] . |

Update <ruleRepository>: The procedure used for updating an existing <ruleRepository> resource.

TABLE 24
<ruleRepository> UPDATE
<ruleRepository> UPDATE

| | |
|---|---|
| Associated | Mca, Mcc and Mcc′ |
| Reference Point | |
| Information in | All parameters defined in table 8.1.2-2 in oneM2M TS-0001 [1] |
| Request message | apply with the specific details for: |
| | Content: attributes of the <ruleRepository> resource. |
| Processing at | According to clause 10.1.4 in oneM2M TS-0001 [1]. |
| Originator before | |
| sending Request | |
| Processing at | According to clause 10.1.4 in oneM2M TS-0001 [1]. |
| Receiver | |
| Information in | According to clause 10.1.4 in oneM2M TS-0001 [1]. |
| Response message | |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

Delete <ruleRepository>: The procedure used for deleting an existing <ruleRepository> resource.

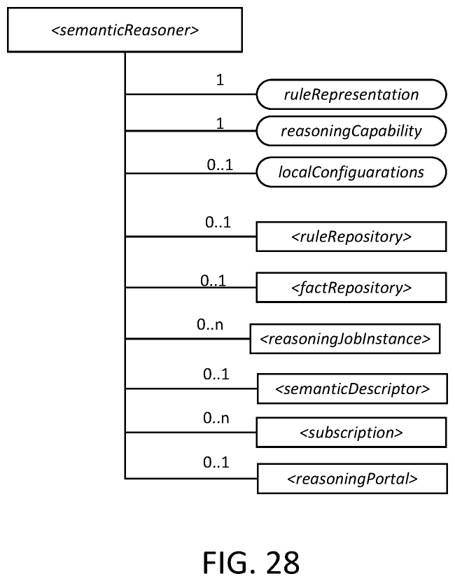

TABLE 25
<ruleRepository> DELETE
<ruleRepository> DELETE

| | |
|---|---|
| Associated | Mca, Mcc and Mcc′ |
| Reference Point | |
| Information in | All parameters defined in table 8.1.2-2 apply in oneM2M |
| Request message | TS-0001 [1]. |
| Processing at | According to clause 10.1.5 in oneM2M TS-0001 [1]. |
| Originator before | |
| sending Request | |
| Processing at | According to clause 10.1.5 in oneM2M TS-0001 [1]. |
| Receiver | |
| Information in | According to clause 10.1.5 in oneM2M TS-0001 [1]. |
| Response message | |
| Processing at | According to clause 10.1.5 in oneM2M TS-0001 [1]. |
| Originator after | |
| receiving Response | |
| Exceptions | According to clause 10.1.5 in oneM2M TS-0001 [1]. |

<semanticReasoner> Resource Definition: A new resource called <semanticReasoner> is disclosed, which is to expose a semantic reasoning service. The resource structure of <semanticReasoner> is shown in FIG. 28.

If a CSE has the semantic reasoning capability, it may create a <semanticReasoner> resource on it (e.g., under <CSEBase>) for supporting semantic reasoning processing.

The <semanticReasoner> resource above may include one or more of the child resources specified in Table 26.

TABLE 26
Child resources of <semanticReasoner> resource

| Child | Child | | <semanticReasonerAnnc> |
|---|---|---|---|
| Resources of | Resource | | Child Resource |
| <semanticReasoner> | Type | Description | Types |
| [variable] | <ruleRepository> | A semantic reasoner | <ruleRepositoryAnnc> |
| | | may be associated with a | |
| | | rule repository. | |
| [variable] | <factRepository> | A semantic reasoner | <factRepositoryAnnc> |
| | | may be associated with a | |
| | | fact repository. | |
| [variable] | <reasoningJobInstance> | A | <reasoningJobInstanceAnnc> |
| | | <reasoningJobInstance> | |
| | | may be created as a child | |
| | | resource to represent a | |
| | | reasoning job executed | |
| | | by the semantic reasoner | |
| | | represented by this | |
| | | <semanticReasoner> | |
| | | resource. | |
| [variable] | <semanticDescriptor | Describes general | <variable> |
| | | semantic information | |
| | | about this | |
| | | <semanticReasoner> | |
| | | resource, which may | |
| | | leverage appropriate | |
| | | ontologies to describe | |
| | | the functionality of the | |
| | | reasoner. | |
| [variable] | <subscription> | See clause 9.6.8 in | <subscription> |
| | | where the type of this | |
| | | resource is described. | |
| <reasoningPortal> | <reasoningPortal> | This is a standard | <reasoningPortal> |
| | | oneM2M virtual | |
| | | resource. When a RI | |
| | | sends a UPDATE | |
| | | operation to this virtual | |
| | | resource, it triggers a | |
| | | semantic reasoning | |
| | | operation. | |

The <semanticReasoner> resource above may include one or more of the attributes specified in Table 27.

TABLE 27
Attributes of <semanticReasoner> resource

| | | <semanticReasonerAnnc> |
|---|---|---|
| Attribute Name | Description | Attributes |
| resourceName | See clause 9.6.1.3 in [1]. | NA |
| parentID | See clause 9.6.1.3 in [1]. | NA |
| expirationTime | See clause 9.6.1.3 in [1]. | NA |
| accessControlPolicyIDs | See clause 9.6.1.3 in [1]. | NA |
| labels | See clause 9.6.1.3 in [1]. | MA |
| creationTime | See clause 9.6.1.3 in [1]. | MA |
| lastModifiedTime | See clause 9.6.1.3 in [1]. | MA |
| announceTo | See clause 9.6.1.3 in [1]. | NA |
| announcedAttribute | See clause 9.6.1.3 in [1]. | NA |
| dynamicAuthorizationConsultationIDs | See clause 9.6.1.3 in [1]. | OA |
| creator | See clause 9.6.1.3 in [1]. | NA |
| ruleRepresentation | Indicates the accepted | OA |
| | format of the rules, e.g. | |
| | RIF. | |
| reasoningCapability | Indicates the reasoning | OA |
| | capabilities of the reasoner, | |
| | e.g., RDFS reasoning, OWL | |
| | reasoning, generic | |
| | reasoning with user-defined | |
| | rules. Each of capability | |
| | may be denoted by a | |
| | specific URI. In order to | |
| | conducting reasoning using | |
| | user-defined rules, the | |
| | semantic reasoner may | |
| | support generic reasoning | |
| | capability. | |
| localConfigurations | When a SR receives a | OA |
| | reasoning request, it may | |
| | decide whether additional | |
| | FS or RS may be used, | |
| | based on the information | |
| | indicated in this attribute. In | |
| | other words, this attribute | |
| | indicates the local | |
| | configurations or policies. | |
| | For example, SR may be | |
| | configured such that as long | |
| | as it sees certain ontologies | |
| | or the interested key words | |
| | such as | |
| | terms/concepts/predicates | |
| | used in Initial_InputFS or | |
| | Initial_RS, it could further | |
| | to retrieve more facts or | |
| | rules indicated in this | |
| | attribute. | |

Alternatively, another way to expose the semantic reasoning is using the existing <CSEBase> or <remoteCSE> resource. Accordingly, the attributes shown in Table 27 may be the new attributes for the <CSEBase> or <remoteCSE> resource. There may be a few ways for <CSEBase> to obtain (e.g., receive) a semantic reasoning request: 1) a <reasoningPortal> resource may be the new child virtual resource of the <CSEBase> or <remoteCSE> resource for receiving requests related to trigger a semantic reasoning operation as defined in this work; or 2) Instead of defining a new resource, the requests from RI may directly be sent towards <CSEBase>, in which a trigger may be defined in the request message (e.g., a new parameter called “reasoningIndicator” may be defined to be included in the request message).

Create <semanticReasoner>: The procedure used for creating a <semanticReasoner> resource.

TABLE 28
<semanticReasoner> CREATE
<semanticReasoner> CREATE

| | |
|---|---|
| Associated | Mca, Mcc and Mcc′ |
| Reference Point | |
| Information in | All parameters defined in table 8.1.2-2 in oneM2M TS-0001 [1] apply |
| Request message | with the specific details for: |
| | Content: The resource content shall provide the information as defined |
| | in the resource definition of <semanticReasoner> resource. |
| Processing at | According to clause 10.1.2 in oneM2M TS-0001 [1]. |
| Originator before | |
| sending Request | |
| Processing at | According to clause 10.1.2 in oneM2M TS-0001 [1]. |
| Receiver | |
| Information in | According to clause 10.1.2 in oneM2M TS-0001 [1]. |
| Response message | |
| Processing at | According to clause 10.1.2 in oneM2M TS-0001 [1]. |
| Originator after | |
| receiving Response | |
| Exceptions | According to clause 10.1.2 in oneM2M TS-0001 [1]. |

Retrieve <semanticReasoner>: The procedure used for retrieving <semanticReasoner> resource.

TABLE 29
<semanticReasoner> RETRIEVE
<semanticReasoner> RETRIEVE

| | |
|---|---|
| Associated | Mca, Mcc and Mcc′. |
| Reference Point | |
| Information in | All parameters defined in table 8.1.2-2 in oneM2M TS-0001 [1] |
| Request message | apply with the specific details for: |
| | Content: attributes of the <semanticReasoner> resource. |
| Processing at | According to clause 10.1.3 in oneM2M TS-0001 [1]. |
| Originator before | |
| sending Request | |
| Processing at | According to clause 10.1.3 in oneM2M TS-0001 [1]. |
| Receiver | |
| Information in | All parameters defined in table 8.1.3-1 in oneM2M TS-0001 [1] |
| Response message | apply. |
| Processing at | According to clause 10.1.3 in oneM2M TS-0001 [1]. |
| Originator after | |
| receiving Response | |
| Exceptions | According to clause 10.1.3 in oneM2M TS-0001 [1]. |

Update <semanticReasoner>: The procedure used for updating an existing <semanticReasoner> resource.

TABLE 30
<semanticReasoner> UPDATE
<semanticReasoner> UPDATE

| | |
|---|---|
| Associated | Mca, Mcc and Mcc′ |
| Reference Point | |
| Information in | All parameters defined in table 8.1.2-2 in oneM2M TS-0001[1] |
| Request message | apply with the specific details for: |
| | Content: attributes of the <semanticReasoner> resource. |
| Processing at | According to clause 10.1.4 in oneM2M TS-0001[1]. |
| Originator before | |
| sending Request | |
| Processing at | According to clause 10.1.4 in oneM2M TS-0001 [1]. |
| Receiver | |
| Information in | According to clause 10.1.4 in oneM2M TS-0001 [1]. |
| Response message | |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

Delete <semanticReasoner>: The procedure used for deleting an existing <semanticReasoner> resource.

TABLE 31
<semanticReasoner> DELETE
<semanticReasoner> DELETE

| | |
|---|---|
| Associated | Mca, Mcc and Mcc′ |
| Reference Point | |
| Information in | All parameters defined in table 8.1.2-2 apply in oneM2M |
| Request message | TS-0001 [1]. |
| Processing at | According to clause 10.1.5 in oneM2M TS-0001 [1]. |
| Originator before | |
| sending Request | |
| Processing at | According to clause 10.1.5 in oneM2M TS-0001 [1]. |
| Receiver | |
| Information in | According to clause 10.1.5 in oneM2M TS-0001 [1]. |
| Response message | |
| Processing at | According to clause 10.1.5 in oneM2M TS-0001 [1]. |
| Originator after | |
| receiving Response | |
| Exceptions | According to clause 10.1.5 in oneM2M TS-0001 [1]. |

<reasoningPortal> Resource Definition: <reasoningPortal> is a virtual resource because it does not have a representation. It is the child resource of a <semanticReasoner> resource. When a UPDATE operation is sent to the <reasoningPortal> resource, it triggers a semantic reasoning operation.

In general, an originator may send a request to this <reasoningPortal> resource for the following purposes, which are disclosed below. In a first example, the request may be to trigger a one-time reasoning operation. In this example, the following information may be carried in the request: a) facts to be sued in this reasoning operation, b) reasoning rules to be used in the reasoning operation, c) reasoning type which indicates that this is for a one-time reasoning operation, or d) any other information as listed in the previous sections. In a second example, the request may be to trigger a continuous reasoning operation. In this second example, the following information may be carried in the request: a) facts to be used in the reasoning operation, b) reasoning rules to be used in the reasoning operation, c) reasoning type which indicates that this is for a continuous reasoning operation, or d) any other information for creating a <reasoningJobInstance> resource. For example, continuousExecutionMode is one of the attributes in the a <reasoningJobInstance> resource. Therefore, the request may also carry related information which may be used to set this attribute. In a third example, a request may be to trigger a new reasoning operation for an existing reasoning job. In this third example, the following information may be carried in the request: jobID: the URI of an existing <reasoningJobInstance> resource.

In addition, for the information to be carried in the request, e.g., facts and reasoning rules to be used, there are multiple ways to carry them in the request: 1) Facts and reasoning rules may be carried in the content parameters of the request; or 2) Facts and reasoning rules may be carried in new parameters of the request. Example new parameters are a Facts parameter and a Rules parameters. For the facts parameter, it may carry the facts to be used in a reasoning operation. For the rules parameter, it may carry the reasoning rules to be used in a reasoning operation.

For the “Facts” parameter, it may include the information about the facts using the following ways:
Case 1: Facts parameter may directly include the facts data, such as RDF triples.
Case 2: Facts parameter may also include one or more URIs that store the facts to be used.

For the “Rules” parameter, it may include the information about the facts using the following ways:
Case 1: Rules parameter can include one or more URIs that store the rules to be used.
Case 2: Rules parameter can directly carry a list of reasoning rules to be used.
Case 3: Rules parameter can be a string value, which indicates a specific standard SPARQL entailment regime. (Note that, SPARQL entailment is one type of semantic reasoning using standard reasoning rules as defined by different entailment regimes). For example, if Rules=“RDFS”, it means that the reasoning rules defined by RDFS entailment regime will be used.

For the implementation choices, one may just implement one of above cases, or may implement those cases at the same time. For the latter case, two new parameters may be defined called typeofFactsRepresentation and typeofUseReasoning, which may be parameters included in the request and may have exemplary values which may be indicators as shown below:
typeofFactsRepresentation=1, Facts parameter stores a URIs.
typeofFactsRepresentation=2, Facts parameter stores a list of facts, e.g., RDF triples to be used.
typeofRulesRepresentation=1, Rules parameter stores a list of URI(s).
typeofRulesRepresentation=2, Rules parameter stores a list of reasoning rules.
typeofRulesRepresentation=3, Rules parameter stores a string value indicating a standard entailment regime.

The <reasoningPortal> resource are created when the parent <semanticReasoner> resource is created by the hosting CSE. The Create operation is not applicable via Mca, Mcc or Mcc′.

The Retrieve operation may not be not applicable for <reasoningPortal>.

Update <reasoningPortal>: The Update operation is used for triggering a semantic reasoning operation. For a continuous reasoning operation, it may utilize <reasoningPortal> in the following ways. In a first way, use the <reasoningPortal> UPDATE operation. For this first way, a reasoning type parameter may be carried in the request to indicate that this request is requiring to create a continuous reasoning operation. In a second way, use the <reasoningPortal> Create operation.

TABLE 32A
<reasoningPortal> UPDATE
<reasoningPortal> UPDATE

| | |
|---|---|
| Associated | Mca, Mcc and Mcc′. |
| Reference Point | |
| Information in | All parameters defined in table 8.1.2-3 in oneM2M TS-0001 [1]. |
| Request message | Besides, the information of the facts and reasoning rules to be used |
| | may be carried in the request. There are multiple ways to carry this |
| | information: 1) Content parameter of the request message may carry |
| | this information; Or 2) the new “Facts” parameter may be used to |
| | carry the facts to be used and the new “Rules” parameter may be |
| | used to carry the reasoning rules to be used. In general, the |
| | facts related resources may refer to <facts> resources, <ontology> |
| | resources, or <semanticDescriptor> resource while reasoning rules |
| | related resources may refer to <reasoningRules> resources.. |
| Processing at | According to clause 10.1.4 in oneM2M TS-0001 [1]. |
| Originator before | |
| sending Request | |
| Processing at | The Receiver shall follow the basic procedure according to clause |
| Receiver | 10.1.4 in oneM2M TS-0001 [1], with the following specific details |
| | (Below are the example processing assuming that facts or rules are |
| | carried in the Content parameter and the originator is requiring a |
| | one-time reasoning operation): |
| | For a given URI included in the Content parameter (which may |
| | include multiple URIs): |
| | If this URI refers to a specific standard reasoning capability |
| | (e.g., RDFS reasoner, OWL reasoner, etc) of the receiver |
| | (which is indicated in the reasoningCapability attribute of the |
| | parent <semanticReasoner> resource), the related reasoning |
| | rules will be input into Initial RS. |
| | If this URI refers to a FS-related or a RS-related resource, this |
| | resource will be retrieved first. If the involved RS is type of |
| | user-defined rules, the receiver shall support the generic |
| | reasoner capability (which is indicated by the |
| | reasoningCapability attribute of the parent |
| | <semanticReasoner> resource. |
| | For a given resource included in the Content parameter or a given |
| | resource that was retrieved through the above step based on the |
| | URI included in the Content parameter: |
| | Case 1: If this resource is a <facts> resource, the following |
| | data will be input into Initial InputFS: |
| | The triples in the content attribute |
| | The referenced ontology as referred by the ontologyRef |
| | attribute (same as Case 3) |
| | Case 2: If this resource is a <semanticDescriptor> resource, the |
| | following data will be retrieved and input into Initial_InputFS: |
| | The triples in the descriptor attribute |
| | The referenced ontology as referred by the ontologyRef |
| | attribute |
| | Other <semanticDescriptor> resources linked by this |
| | <semanticDescriptor> |
| | The referenced ontologies as referred by the ontologyRef |
| | attribute of those linked <semanticDescriptor> resources |
| | (same as Case 3). |
| | Case 3: If this resource is a <ontology> resource, the following |
| | data will be retrieved and input into Initial_InputFS: |
| | The content in the ontologyContent attribute |
| | Case 4: For a given <reasoningRules> resource (which stores |
| | e.g., user-defined rules), the following data will be retrieved |
| | and input into Initial RS: |
| | The content in the content attribute |
| | In addition to Initial_InputFS and Initial_RS, the receiver may |
| | decide whether/which additional FS or RS may be used in this |
| | semantic reasoning operation. If so, those additional FS-related and |
| | RS-related resources will also be retrieved. For example, the |
| | receiver may be configured such that as long as it sees certain |
| | ontologies or the interested terms/concepts/predicates used in |
| | Initial_InputFS or Initial_RS, it could further to retrieve more facts |
| | or rules. In other words, a SR 232 may keep a local configuration |
| | table to record its interested key words and each key word may be |
| | associated with a number of related FSs and RSs. Accordingly, for |
| | any key word (a term, a concept, or a predicate) appeared in |
| | Initial_InputFS or Initial_RS, SR 232 may check its configuration |
| | table to find out the associated FSs and RSs of this key word. |
| | Those associated FSs and RSs may potentially be the additional |
| | FSs and RSs that may be utilized if they have not been included in |
| | the Initial_InputFS and Initial_RS. |
| | For a given retrieved FS-related resource, its data will be input |
| | into Addi InputFS, and the processing is as same as Case 1, |
| | Case 2 and Case 3. |
| | For a given retrieved RS-related resource, its data will be input |
| | into Addi_RS, and the processing is as same as Case 4. |
| | With all the facts (e.g., Initial_InputFS and Addi_InputFS) and |
| | rules (e.g., Initial_RS and Addi_RS), the receiver performs the |
| | semantic reasoning processing and produce the reasoning result. |
| Information in | According to clause 10.1.4 in oneM2M TS-0001 [1] with the specific |
| Response message | details for: |
| | Content: the semantic reasoning result produced by the receiver. |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

The below is an alternative version for the processing of <reasongingPortal> UPDATE operation shown in Table 32A. For example, in this version, the facts and reasoning rules are carried in the Facts and Rules parameters in the request. In the meantime, it does not consider to add additional facts and rules for simplification.

TABLE 32B
Simplified version of <reasoningPortal> UPDATE
<reasoningPortal> UPDATE

| | |
|---|---|
| Associated | Mca, Mcc and Mcc′. |
| Reference Point | |
| Information in | All parameters defined in table 8.1.2-3 in oneM2M TS-0001 [1]. |
| Request message | Besides, the information of the facts and reasoning rules to be used |
| | may be carried in the request. The new “Facts” parameter carries the |
| | facts to be used and the new “Rules” parameter carries the reasoning |
| | rules to be used. |
| Processing at | According to clause 10.1.4 in oneM2M TS-0001 [1]. |
| Originator before | |
| sending Request | |
| Processing at | The Receiver shall follow the basic procedure according to clause |
| Receiver | 10.1.4 in oneM2M TS-0001 [1], with the following specific details |
| | (Below are the example processing assuming that facts or rules are |
| | carried in Facts and Rules parameter: |
| | Case 1. When Facts and Rules are present and the Reasoning |
| | type indicates that this is for a one-time reasoning operation. |
| | The receiver first collects all the related facts to be used: |
| | If the Facts parameter directly carry a list of facts, e.g., |
| | RDF triples, then the receiver may use those facts |
| | directly as inputs. |
| | If the Facts parameter carry a list of URIs that refer to |
| | the resources storing the facts to be used. Then, the |
| | receiver may retrieve those facts (The details for how to |
| | extract the facts from those resources are as same as the |
| | details described in Table 32A). |
| | The receiver may also collect the related reasoning rules to be |
| | used: |
| | If the Rules parameter directly carry a list of rules, then |
| | the receiver may use those rules directly as inputs. |
| | If the Rules parameter carry a list of URIs that refer to |
| | the resources storing the rules to be used. Then, the |
| | receiver may retrieve those rules (The details for how to |
| | extract the rules from those resources are as same as the |
| | details described in Table 32A). |
| | If the Rules parameter is a string value that indicate a |
| | standard entailments regime, then the receiver may use |
| | the reasoning rules defined by the standard entailment |
| | regime for this reasoning operation. |
| | With all the facts and rules, the receiver may perform the |
| | semantic reasoning processing and produce the reasoning result. |
| | Case 2. When Facts and Rules are present and the Reasoning |
| | type indicates that this is for a continuous reasoning operation. |
| | The receiver first collects all the related facts to be used: |
| | If the Facts parameter directly carry a list of facts, e.g., |
| | RDF triples, then the receiver may use those facts |
| | directly as inputs. |
| | If the Facts parameter carry a list of URIs that refer to |
| | the resources storing the facts to be used. Then, the |
| | receiver first may retrieve those facts (The details for |
| | how to extract the facts from those resources are as same |
| | as the details described in Table 32A). |
| | The receiver also collects all the related reasoning rules to be |
| | used: |
| | If the Rules parameter directly carry a list of rules, then |
| | the receiver will use those rules directly as inputs. |
| | If the Rules parameter carry a list of URIs that refer to |
| | the resources storing the rules to be used. Then, the |
| | receiver may first retrieve those rules (The details for |
| | how to extract the rules from those resources are as same |
| | as the details described in Table 32A). |
| | If the Rules parameter is a string value that indicate a |
| | standard entailments regime, then the receiver will use |
| | the reasoning rules defined by the standard entailment |
| | regime for this reasoning operation. |
| | The receiver then creates a new <ReasoningJobInstance> |
| | resource for this request, which stores the related information |
| | (e.g., the information stored in the Facts and Rule parameters |
| | may be used to set initialInputFS and initialRS attributes of |
| | the newly-created <ReasoningJobInstance> resource). |
| | With all the facts and rules, the receiver performs the semantic |
| | reasoning processing and produce the reasoning result and will |
| | create a <reasoningResule> child resource under the parent |
| | <ReasoningJobInstance> resource in order to store the |
| | reasoning result. |
| | Case 3. When Facts and Rules are not present but a jobID is |
| | present in the request. |
| | The receiver first checks whether this jobID is a valid id, |
| | which means that it refers to a valid reasoning job represented |
| | by a <ReasoningJobInstance> resource. |
| | The receiver further checks the continuousExecutionMode |
| | attribute of this <ReasoningJobInstance> resource to see if it is |
| | set to “When RI triggers the job execution” (In this case, the |
| | reasoning job described by this resource will be executed |
| | when an originator sends an UPDATE operation to the |
| | <reasoningPortal> virtual resource with a jobID. |
| | If so, the receiver will re-collect the facts and rules that are |
| | referred by the initialInputFS and initialRS attributes of the |
| | <ReasoningJobInstance> resource. |
| | With all the collected facts and rules, the receiver performs the |
| | semantic reasoning processing and produce the reasoning |
| | results. |
| Information in | According to clause 10.1.4 in oneM2M TS-0001 [1] with the specific |
| Response message | details for: |
| | For the Case 1: |
| | Content: the semantic reasoning result produced by the receiver. |
| | For the Case 2: |
| | Content: the URI of the newly-created <reasoningJobInstance> |
| | resource or the semantic reasoning result produced by the receiver. |
| | For the Case 3: |
| | Content: the semantic reasoning result produced by the receiver or the |
| | URI of the newly-created <reasoningResult> resource that store the |
| | latest results. |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

Delete <reasoningPortal>: The <reasoningPortal> resource shall be deleted when the parent <semanticReasoner> resource is deleted by the hosting CSE. The Delete operation is not applicable via Mca, Mcc or Mcc′.

<reasoningJobInstance> Resource Definition: A new type of oneM2M resource (called <reasoningJobInstance>) is defined to describe a specific reasoning job instance (it could be a one-time reasoning operation, or a continuous reasoning operation). Note that, it could be named with a different name, as long as it has the same purpose.

Note that the following may be alternative ways to conduct a continuous reasoning job. In a first way, the Originator may send a request towards a <semanticReasoner> of a CSE, (or towards the <CSEBase> resource) in order to create a <reasoningJobInstance> resource if this CSE may support semantic reasoning capability. In a second way, the Originator may send a CREATE request towards a <reasoningPortal> of a <semanticReasoner> resource, in order to create a <reasoningJobInstance> resource (or it may send a UPDATE request to <reasoningPortal>, but the reasoning type parameter included in the request may indicate that this is for creating a continuous reasoning operation).

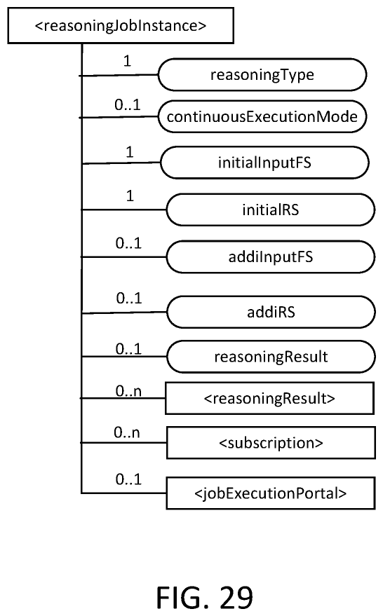

The resource structure of <reasoningJobInstance> is shown in FIG. 29. The <reasoningJobInstance> resource may include one or more of the child resources specified in Table 33.

TABLE 33
Child resources of <reasoningJobInstance> resource

| Child | Child | | <reasoningJobInstanceAnnc> |
|---|---|---|---|
| Resources of | Resource | | Child |
| <reasoningJobInstance > | Type | Description | ResourceTypes |
| [variable] | <subscription> | See clause 9.6.8 in [1] | <subscription> |
| | | where the type of this | |
| | | resource is described. | |
| [variable] | <reasoningResult> | This resource is to store | <reasoningResultAnnc> |
| | | the reasoning result. | |
| | | Note that, if the | |
| | | attribute | |
| | | reasoningResult is used | |
| | | to store the reasoning | |
| | | result, this resource may | |
| | | not be used. For the | |
| | | case of continuous | |
| | | reasoning job, every | |
| | | time a new reasoning | |
| | | result is generated, a | |
| | | new <reasoning Result> | |
| | | resource will be created | |
| | | to store the newly- | |
| | | generated result. | |
| <jobExecutionPortal> | <jobExecutionPortal> | This is a standard | <jobExecutionPortal> |
| | | oneM2M virtual | |
| | | resource and this child | |
| | | resource is present just | |
| | | if the parent | |
| | | <reasoningJobInstance> | |
| | | resource represents a | |
| | | continuous reasoning | |
| | | job and the value of | |
| | | attribute | |
| | | continuousExecutionMode | |
| | | is set to “When RI | |
| | | triggers the job | |
| | | execution”. When a RI | |
| | | sends a UPDATE | |
| | | operation to this virtual | |
| | | resource, it triggers an | |
| | | execution of the | |
| | | corresponding | |
| | | reasoning job. Another | |
| | | alternative approach is | |
| | | for a RI to send a | |
| | | request to the | |
| | | <reasoningPortal> | |
| | | resource by indicating a | |
| | | job ID. | |

The <reasoningJobInstance> resource above may include one or more of the attributes specified in Table 34.

TABLE 34
Attributes of <reasoningJobInstance> resource

| | | <reasoningJob |
|---|---|---|
| | | InstanceAnnc> |
| Attribute Name | Description | Attributes |
| resourceName | See clause 9.6.1.3 in [1]. | NA |
| parentID | See clause 9.6.1.3 in [1]. | NA |
| expirationTime | See clause 9.6.1.3 in [1]. | NA |
| accessControlPolicyIDs | See clause 9.6.1.3 in [1]. | NA |
| labels | See clause 9.6.1.3 in [1]. | MA |
| creationTime | See clause 9.6.1.3 in [1]. | MA |
| lastModifiedTime | See clause 9.6.1.3 in [1]. | MA |
| announceTo | See clause 9.6.1.3 in [1]. | NA |
| announcedAttribute | See clause 9.6.1.3 in [1]. | NA |
| dynamicAuthorization | See clause 9.6.1.3 in [1]. | OA |
| ConsultationIDs | | |
| creator | See clause 9.6.1.3 in [1]. | NA |
| reasoningType | Indicates the type of this | OA |
| | reasoning job, it could be | |
| | “one-time reasoning | |
| | operation” or “continuous | |
| | reasoning operation”. | |
| continuous | This attribute is present just | OA |
| ExecutionMode | if the job type is “continuous | |
| | reasoning job”. | |
| | The potential values of this | |
| | attribute may include but not | |
| | limited to: | |
| | “When RI triggers the | |
| | job execution”. In this | |
| | case, the reasoning job | |
| | described by this | |
| | resource will be executed | |
| | when a RI sends a | |
| | UPDATE operation to the | |
| | <jobExecutionPortal> | |
| | virtual child resource. An | |
| | alternative is that RI | |
| | sends a UPDATE | |
| | operation to the | |
| | <reasoningPortal> virtual | |
| | resource of a semantic | |
| | reasoner if exists with a | |
| | job ID. | |
| | “Periodically”. In this | |
| | case, the SR will | |
| | periodically execute the | |
| | reasoning job represented | |
| | by this resource. | |
| | “When related FS/RS | |
| | changes”. In this case, | |
| | the SR will monitor any | |
| | changes on the | |
| | Initial_InputFS, | |
| | Addi_InputFS, | |
| | Initial_RS and Addi_RS | |
| | of the corresponding | |
| | reasoning job represented | |
| | by this resource. If any | |
| | change happens, it will | |
| | trigger an execution of | |
| | the job. | |
| initialInputFS | The URIs (or contents) of | OA |
| | facts-related resources that | |
| | constitute the Initial_InputFS | |
| | of this job. Alternatively, | |
| | this attribute may also | |
| | directly store a list of facts, | |
| | such as RDF triples. | |
| initialRS | The URIs (or contents) of | OA |
| | rules-related resources that | |
| | constitute the Initial_RS of | |
| | this job. Alternatively, this | |
| | attributes may also directly | |
| | store a list of rules. | |
| addiInputFS | The URIs (or contents) of | OA |
| | facts-related resources that | |
| | constitute the Addi_InputFS | |
| | of this job. Alternatively, this | |
| | attribute may also directly | |
| | store a list of facts, such as | |
| | RDF triples. | |
| addiRS | The URIs (or contents) of | OA |
| | rules-related resources that | |
| | constitute the Addi_RS of | |
| | this job. Alternatively, this | |
| | attribute may also directly | |
| | store a list of rules. | |
| reasoningResult | This resource is to store the | OA |
| | reasoning result. Note that, | |
| | if the child resource | |
| | <reasoningResult> is used to | |
| | store the reasoning result, | |
| | this attribute may not be | |
| | used. For the case of | |
| | continuous reasoning job, | |
| | every time a new reasoning | |
| | result is generated, this | |
| | attribute will be updated to | |
| | reflect the latest | |
| | reasoning result. | |
| jobID | This represents the ID of this | OA |
| | reasoning job instance, | |
| | which could be URI for | |
| | example. | |

The procedure used for creating a <reasoningJobInstance> resource.

TABLE 35
<reasoningJobInstance> CREATE
<reasoningJobInstance> CREATE

| | |
|---|---|
| Associated | Mca, Mcc and Mcc′ |
| Reference Point | |
| Information in | All parameters defined in |
| Request message | details for: |
| | Content: The resource content shall |
| | provide the information as defined |
| | in <reasoningJobInstance> resource. |
| Processing at | According to [1] clause 10.1.2 in [1] |
| Originator before | |
| sending Request | |
| Processing at | According to [1] clause 10.1.2 in [1] |
| Receiver | |
| Information in | According to [1] clause 10.1.2 in [1] |
| Response message | |
| Processing at | According to [1] clause 10.1.2 in [1] |
| Originator after | The following information may also be |
| receiving Response | included: The URI of the created |
| | <reasoningJobInstance>, which is the job ID. |
| Exceptions | According to [1] clause 10.1.2 in [1] |

Retrieve <reasoningJobInstance>: The procedure used for retrieving the attributes of a <reasoningJobInstance> resource.

TABLE 36
<reasoningJobInstance> RETRIEVE
<reasoningJobInstance> RETRIEVE

| | |
|---|---|
| Associated | Mca, Mcc and Mcc′ |
| Reference Point | |
| Information in | All parameters defined in [1] table 8.1.2-2 |
| Request message | apply with the specific details for: |
| | Content: attributes of the |
| | <reasoningJobInstance> resource. |
| Processing at | According to [1] clause 10.1.3 in [1]. |
| Originator before | |
| sending Request | |
| Processing at | According to [1] clause 10.1.3 in [1]. |
| Receiver | |
| Information in | All parameters defined in table 8.1.3-1 in [1]. |
| Response message | |
| Processing at | According to [1] clause 10.1.3 in [1]. |
| Originator after | |
| receiving Response | |
| Exceptions | According to [1] clause 10.1.3 in [1]. |

Update <reasoningJobInstance>: The procedure used for updating attributes of a <reasoningJobInstance> resource.

TABLE 37
<reasoningJobInstance> UPDATE
<reasoningJobInstance> UPDATE

| | |
|---|---|
| Associated | Mca, Mcc and Mcc′ |
| Reference Point | |
| Information in | All parameters defined in table 8.1.2-2 in [1] |
| Request message | apply with the specific details for: |
| | Content: attributes of the |
| | <reasoningJobInstance> resource. |
| Processing at | According to clause 10.1.4 in [1]. |
| Originator before | |
| sending Request | |
| Processing at | According to clause 10.1.4 in [1]. |
| Receiver | |
| Information in | According to clause 10.1.4 in [1]. |
| Response message | |
| Processing at | According to clause 10.1.4 in [1]. |
| Originator after | |
| receiving Response | |
| Exceptions | According to clause 10.1.4 in [1]. |

Delete <reasoningJobInstance>: The procedure used for deleting a <reasoningJobInstance> resource.

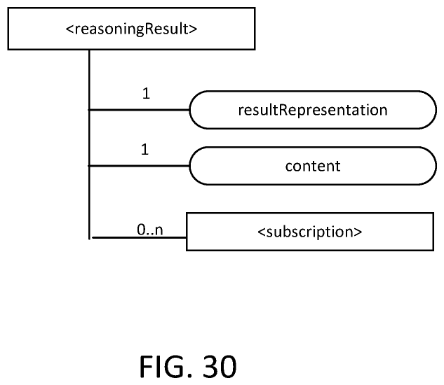

TABLE 38
<reasoningJobInstance> DELETE
<reasoningJobInstance> DELETE

| | |
|---|---|
| Associated | Mca, Mcc and Mcc′ |
| Reference Point | |
| Information in | All parameters defined in table 8.1.2-2 in [1]. |
| Request message | |
| Processing at | According to clause 10.1.5 in [1]. |
| Originator before | |
| sending Request | |
| Processing at | According to clause 10.1.5 in [1]. |
| Receiver | |
| Information in | According to clause 10.1.5 in [1]. |
| Response message | |
| Processing at | According to clause 10.1.5 in [1]. |
| Originator after | |
| receiving Response | |
| Exceptions | According to clause 10.1.5 in [1]. |

<reasoningResult> Resource Definition: A new type of oneM2M resource (called <reasoningResult>) is defined to store a reasoning result. Note that, it could be named with a different name, as long as it has the same purpose. The resource structure of <reasoningResult> is shown in FIG. 30.

The <reasoningResult> resource above may include one or more of the child resources specified in Table 39.

TABLE 39
Child resources of <reasoningResult> resource

| | | | <reasoningResult |
|---|---|---|---|
| Child Resources of | Child Resource | | Anne> Child |
| <reasoningResult> | Type | Description | Resource Types |
| [variable] | <subscription> | See clause 9.6.8 in [1] | <subscription> |
| | | where the type of this | |
| | | resource is described. | |

The <reasoningResult> resource above may include one or more of the attributes specified in Table 40.

TABLE 40
Attributes of <reasoningResult> resource

| | | <reasoning |
|---|---|---|
| | | RulesAnnc> |
| Attribute Name | Description | Attributes |
| resourceName | See clause 9.6.1.3 in [1]. | NA |
| parentID | See clause 9.6.1.3 in [1]. | NA |
| expirationTime | See clause 9.6.1.3 in [1]. | NA |
| accessControlPolicyIDs | See clause 9.6.1.3 in [1]. | NA |
| labels | See clause 9.6.1.3 in [1]. | MA |
| creationTime | See clause 9.6.1.3 in [1]. | MA |
| lastModifiedTime | See clause 9.6.1.3 in [1]. | MA |
| announceTo | See clause 9.6.1.3 in [1]. | NA |
| announcedAttribute | See clause 9.6.1.3 in [1]. | NA |
| dynamicAuthorization | See clause 9.6.1.3 in [1]. | OA |
| ConsultationIDs | | |
| creator | See clause 9.6.1.3 in [1]. | NA |
| ontologyRef | A reference (URIs) of the | OA |
| | ontologies used to represent | |
| | the reasoning rules that are | |
| | stored in the content attribute. | |
| resultRepresentation | Indicates the representation of | OA |
| | the reasoning result, e.g. RDF | |
| | serialized in XML. | |
| content | Stores the reasoning result of | OA |
| | the reasoning job represented | |
| | by the parent | |
| | <reasoningJobInstance> | |
| | resource. | |

The Create operation is not applicable for <reasoningResult>. A <reasoningResult> resource is automatically generated by a Hosting CSE which has the semantic reasoner capability when it executes a semantic reasoning process for a reasoning job represented by the <reasoningJobInstance> parent resource.

Retrieve <reasoningResult>: The procedure used for retrieving the attributes of a <reasoningResult> resource.

TABLE 41
<reasoningResult> RETRIEVE
<reasoningResult> RETRIEVE

| | |
|---|---|
| Associated | Mca, Mcc and Mcc′ |
| Reference Point | |
| Information in | All parameters defined in table 8.1.2-2 in [1] |
| Request message | apply with the specific details for: |
| | Content: attributes of the |
| | <reasoningResult> resource. |
| Processing at | According to clause 10.1.3 in [1]. |
| Originator before | |
| sending Request | |
| Processing at | According to clause 10.1.3 in [1]. |
| Receiver | |
| Information in | All parameters defined in table 8.1.3-1 in [1]. |
| Response message | |
| Processing at | According to clause 10.1.3 in [1]. |
| Originator after | |
| receiving Response | |
| Exceptions | According to clause 10.1.3 in [1]. |

The Retrieve operation is not applicable for <reasoningResult>.

Delete <reasoningResult>: The procedure used for deleting a <reasoningResult> resource.

TABLE 42
<reasoningResult> DELETE
<reasoningResult> DELETE

| | |
|---|---|
| Associated | Mca, Mcc and Mcc′ |
| Reference Point | |
| Information in | All parameters defined in table 8.1.2-2 in [1]. |
| Request message | |
| Processing at | According to clause 10.1.5 in [1]. |
| Originator before | |
| sending Request | |
| Processing at | According to clause 10.1.5 in [1]. |
| Receiver | |
| Information in | According to clause 10.1.5 in [1]. |
| Response message | |
| Processing at | According to clause 10.1.5 in [1]. |
| Originator after | |
| receiving Response | |
| Exceptions | According to clause 10.1.5 in [1]. |

<jobExecutionPortal> Resource Definition: <jobExecutionPortal> is a virtual resource because it does not have a representation and it has the similarly functionality like the previously-defined <reasoningPortal> resource. It is the child resource of a <reasoningJobInstance> resource. When the value of attribute continuousExecutionMode is set to “When RI triggers the job execution” and a UPDATE operation is sent to the <jobExecutionPortal> resource, it triggers a semantic reasoning execution corresponding to the parent <reasoningJobInstance> resource.

Create <jobExecutionPortal>: The <reasoningPortal> resource shall be created when the parent <reasoningJobInstance> resource is created.

Retrieve <jobExecutionPortal>: The Retrieve operation is not applicable for <reasoningPortal>.

Update <jobExecutionPortal>: The Update operation is used for triggering a semantic reasoning execution. This is an alternative compared to sending an update request to the <reasoningPortal> resource with a jobID.

TABLE 43A
<jobExecutionPortal> UPDATE
<jobExecutionPortal> UPDATE

| | |
|---|---|
| Associated | Mca, Mcc and Mcc′. |
| Reference Point | |
| Information in | All parameters defined in table 8.1.2-3 in oneM2M TS-0001 [1]. |
| Request message | |
| Processing at | According to clause 10.1.4 in oneM2M TS-0001 [1]. |
| Originator before | |
| sending Request | |
| Processing at | The Receiver follows the basic procedure according to clause 10.1.4 in |
| Receiver | oneM2M TS-0001 [1], with the following specific details: |
| | For a given URI included in the initialInputFS attribute of the |
| | parent <reasoningJobInstance> resource (which may include |
| | multiple URIs): |
| | Case 1: If this resource is a <facts> resource, the following |
| | data will be input into Initial_InputFS: |
| | The triples in the content attribute |
| | The referenced ontology as referred by the ontologyRef |
| | attribute (see Case 3) |
| | Case 2: If this resource is a <semanticDescriptor> resource, the |
| | following data will be retrieved and input into Initial_InputFS: |
| | The triples in the descriptor attribute |
| | The referenced ontology as referred by the ontologyRef attribute |
| | Other <semanticDescriptor> resources linked by this |
| | <semanticDescriptor> |
| | The referenced ontologies as referred by the ontologyRef |
| | attribute of those linked <semanticDescriptor> resources |
| | (See Case 3). |
| | Case 3: If this resource is a <ontology> resource, the following |
| | data will be retrieved and input into Initial InputFS: |
| | The content in the ontologyContent attribute |
| | For a given URI included in the addiInputFS attribute of the parent |
| | <reasoningJobInstance> resource (which may include multiple |
| | URIs), the processing will be similar as did for the initialInputFS |
| | attribute, but the facts-related data will be input into Addi_InputFS. |
| | For a given URI included in the initiaW attribute of the parent |
| | <reasoningJobInstance> resource (which may include multiple |
| | URIs), it refers to a <reasoningRules> resource. The content in the |
| | content attribute of this resource will be retrieved and input into |
| | Initial_RS: |
| | For a given URI included in the addiRS attribute of the parent |
| | <reasoningJobInstance> resource (which may include multiple |
| | URIs), the processing will be similar as did for the initialRS |
| | attribute, but the rules-related data will be input into Addi_RS. |
| | With all the facts (e.g., Initial_InputFS and Addi_InputFS) and |
| | rules (e.g., Initial_RS and Addi_RS), the receiver performs the |
| | semantic reasoning processing and produce a reasoning result. In |
| | addition, the reasoning result may also be stored in the |
| | reasoningResult attribute of the parent <reasoningJobInstance> |
| | resource (if exists) or a new <reasoningResult> resource may be |
| | created under the parent <reasoningJobInstance> resource to store |
| | the newly-generated reasoning result. |
| Information in | According to clause 10.1.4 in oneM2M TS-0001 |
| Response message | with the specific details for: |
| | Content: the semantic reasoning result produced by the receiver. |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

The below is a simplified or alternative version for the processing of <jobExecutionPortal> UPDATE operation shown in Table 43A. For example, it does not consider providing additional facts and rules for simplification.

TABLE 43B
Simplified Version of <jobExecutionPortal> UPDATE
<jobExecutionPortal> UPDATE

| | |
|---|---|
| Associated | Mca, Mcc and Mcc′. |
| Reference Point | |
| Information in | All parameters defined in table 8.1.2-3 in oneM2M TS-0001 [1]. |
| Request message | |
| Processing at | According to clause 10.1.4 in oneM2M TS-0001 [1]. |
| Originator before | |
| sending Request | |
| Processing at | The receiver checks the continuousExecutionAlode attribute of |
| Receiver | parent <ReasoningJobInstance> resource to see if it is set to |
| | “When RI triggers the job execution” (In this case, the reasoning |
| | job described by this resource will be executed when an |
| | originator sends an UPDATE operation to the |
| | <jobExecutionPortal> virtual child resource. |
| | If so, the receiver will re-collect the facts and rules that are |
| | referred by the initialInputFS and initialRS attributes of the |
| | <ReasoningJobInstance> resource. |
| | With all the collected facts and rules, the receiver performs the |
| | semantic reasoning processing and produce the reasoning |
| | results. |
| Information in | According to clause 10.1.4 in oneM2M TS-0001 |
| Response message | with the specific details for: |
| | Content: the semantic reasoning result produced by the receiver. |
| Processing at | According to clause 10.1.4 in oneM2M TS-0001 [1]. |
| Originator after | |
| receiving Response | |
| Exceptions | According to clause 10.1.4 in oneM2M TS-0001 [1]. |

Delete <jobExecutionPortal>: The <jobExecutionPortal> resource shall be deleted when the parent <reasoningJobInstance> resource is deleted by the hosting CSE. The Delete operation is not applicable via Mca, Mcc or Mcc′.

oneM2M Examples for Semantic Reasoning Related Procedures Introduced in association with enabling individual semantic reasoning process and increasing the effectiveness of other. This section introduces several oneM2M examples for the methods disclosed herein.

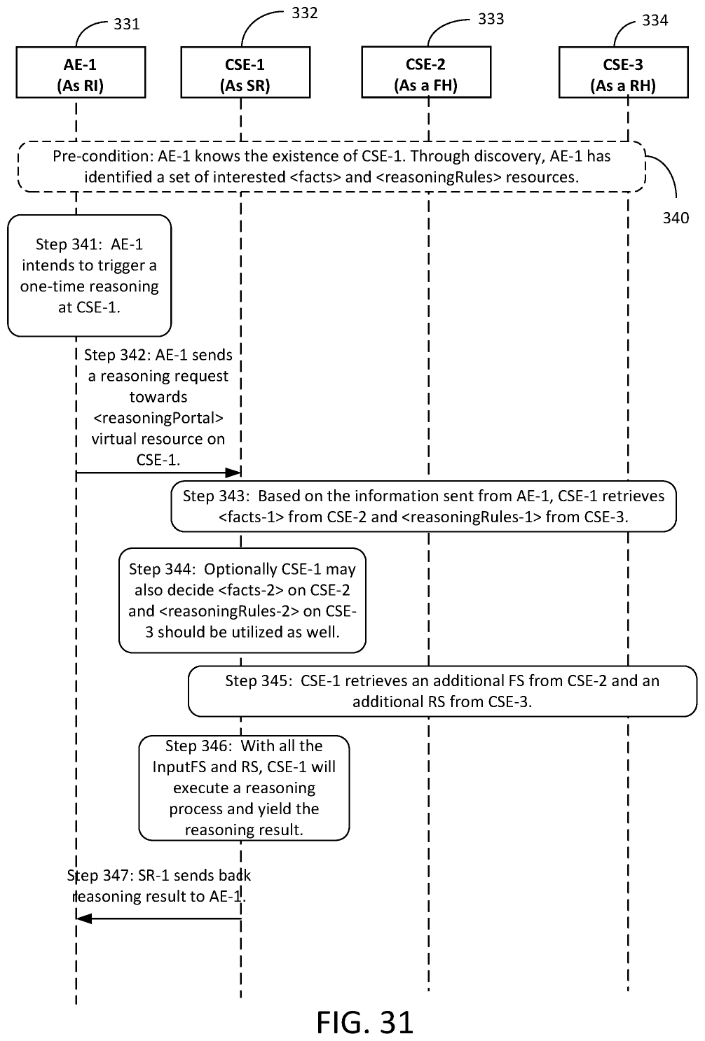

OneM2M Example of One-time Reasoning Operation Disclosed in FIG. 13. In this scenario, AE-1 (As an RI) has identified some interested InputFS (<facts-1>) and RS (<reasoningRules-1>) and would like to initiate a one-time reasoning operation at a CSE-1 (as SR) in order to discover some new knowledge/facts. FIG. 31 illustrates the oneM2M procedure for one-time reasoning operation and the detailed descriptions are as follows.

Pre-condition (Step 340): AE-1 knows the existence of CSE-1 (which acts as a SR) and a <semanticReasoner> resource was created on CSE-1. Through discovery, AE-1 has identified a set of interested <facts-1> resource on CSE-2 (<facts-1> will be Initial_InputFS) and some <reasoningRules-1> on CSE-3 (<reasoningRules-1> will be the Initial_RS).

Step 341: AE-1 intends to use <facts-1> and <reasoningRules-1> as inputs to trigger a reasoning at CSE-1 for discovering some new knowledge.

Step 342: AE-1 sends a reasoning request towards <reasoningPortal> virtual resource on CSE-1, along with the information about Initial_InputFS and Initial_RS. For example, the facts and rules to be used may be described by the newly-disclosed Facts and Rules parameters in the request.

Step 343: Based on the information sent from AE-1, CSE-1 retrieves <facts-1> from CSE-2 and <reasoningRules-1> from CSE-3.

Step 344: In addition to inputs provided by AE-1, optionally CSE-1 may also decide <facts-2> on CSE-2 and <reasoningRules-2> on CSE-3 should be utilized as well.

Step 345: CSE-1 retrieves an additional FS (e.g. <facts-2>) from CSE-2 and an additional RS (e.g., <reasoningRules-2>) from CSE-3.

Step 346: With all the InputFS (e.g., <facts-1> and <facts-2>) and RS (e.g., <reasoningRules-1> and <reasoningRules-2>), CSE-1 will execute a reasoning process and yield the reasoning result.

Step 347: SR 232 sends back reasoning result to AE-1. In addition, as introduced herein, SR 232 may also create a <reasoningResult> resource to store reasoning result.

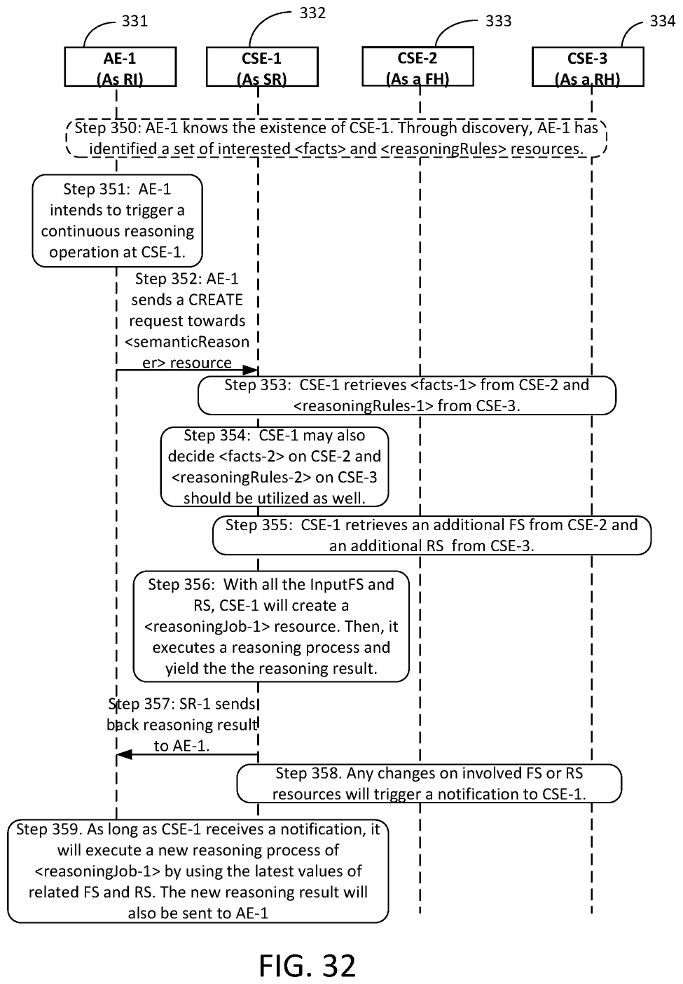

OneM2M Example of Continuous Reasoning Operation Disclosed in FIG. 14. In this scenario, AE-1 (As an RI) has identified some interested InputFS (<facts-1>) and RS (<reasoningRules-1>) and would like to initiate a continuous reasoning operation at a CSE-1 (As a SR) in order to discover some new knowledge (the terms facts and knowledge may be used synonomously herein). FIG. 32 illustrates the oneM2M example procedure for continuous reasoning operation and the detailed descriptions are as follows.

Pre-condition (Step 350): AE-1 knows the existence of CSE-1 (which acts as a SR) and a <semanticReasoner> resource was created on CSE-1. Through discovery, AE-1 has identified a set of interested <facts-1> resource on CSE-2 (<facts-1> will be Initial_InputFS) and some <reasoningRules-1> on CSE-3 (<reasoningRules-1> will be the Initial_RS).

Step 351: AE-1 intends to use <facts-1> and <reasoningRules-1> as inputs to trigger a continuous reasoning operation at CSE-1.

Step 352: AE-1 sends a CREATE request towards <reasoningPortal> child resource of the <semanticReasoner> resource to create a <reasoningJobInstance> resource, along with the information about Initial_InputFS and Initial_RS, as well as some other information for the <reasoningJobInstance> to be created. Alternatively, another possible implementation is that AE-1 may send a CREATE request towards to <CSEBase> or <semanticReasoner> resource.

Step 353: Based on the information sent from AE-1, CSE-1 retrieves <facts-1> from CSE-2 and <reasoningRules-1> from CSE-3. CSE-1 also make subscriptions on those two resources.

Step 354: In addition to inputs provided by AE-1, optionally CSE-1 may also decide <facts-2> on CSE-2 and <reasoningRules-2> on CSE-3 should be utilized as well.

Step 355: CSE-1 retrieves an additional FS (e.g. <facts-2>) from CSE-2 and an additional RS (e.g., <reasoningRules-2>) from CSE-3. CSE-1 also make subscriptions on those two resources.

Step 356: With all the InputFS (e.g., <facts-1> and <facts-2>) and RS (e.g., <reasoningRules-1> and <reasoningRules-2>), CSE-1 will create a <reasoningJobInstance-1> resource under the <semanticReasoner> resource (or other preferred locations). For example, the reasoningType attribute will be set to “continuous reasoning operation” and the continuousExecutionMode attribute will be set to “When related FS/RS changes”. Then, it executes a reasoning process and yield the reasoning result. The result may be stored in the reasoningResult attribute of <reasoningJobInstance-1> or stored in a new <reasoningResult> type of child resource.

Step 357: SR 232 sends back reasoning result to AE-1.

Step 358. Any changes on <facts-1>, <fact-2>, <reasoningRules-1> and <reasoningRules-2> will trigger a notification to CSE-1, due to the previously-established subscription in Step 3.

Step 359. As long as CSE-1 receives a notification, it will execute a new reasoning process of <reasoningJobInstance-1> by using the latest values of related FS and RS. The new reasoning result will also be sent to AE-1.

OneM2M Example of The Procedure Disclosed in FIG. 15. In this scenario, AE-1 (As an SU) intends to conduct semantic resource discovery in CSE-1 (as SE). During the resource discovery processing, CSE-1 may further utilize reasoning support from CSE-2 in order to get an optimized discovery result. FIG. 33A illustrates the example oneM2M procedure for augmenting IDB supported by reasoning and the detailed descriptions are as follows:

Step 361: AE-1 intends to initiate a semantic resource discovery operation.

Step 362: AE-1 sends a request to <CSEBase> of CSE-1 in order to initiate the semantic discovery operation, in which a SPARQL query statement is included.

Step 363: Based on the request sent from AE-1, CSE-1 starts to conduct semantic resource discovery processing. In particular, CSE-1 now start to evaluate whether <AE-2> resource should be included in the discovery result by examining the <semanticDescriptor-1> child resource of <AE-2>. However, the current data in <semanticDescriptor-1> cannot match the SPARQL query statement sent from AE-1. Therefore, CSE-1 decides reasoning should be further involved for processing this request.

Step 364: CSE-1 sends a request towards the <reasoningPortal> resource on CSE-2 (which has semantic reasoning capability) to require a reasoning process, along with the information stored in <semanticDescriptor-1>.

Step 365: CSE-2 further decides additional FS and RS should be added for this reasoning process. For example, CSE-1 retrieves <facts-1> from CSE-3 and <reasoningRules-1> from CSE-4 respectively.

Step 366: Based on information stored in <semanticDescriptor-1> (as IDB) and the additional <facts-1> and <reasoningRules-1>, CSE-1 executes a reasoning process and yield the inferred facts (denoted as InferredFS-1).

Step 367: CSE-2 sends back InferredFS-1 to CSE-1.

Step 368: CSE-1 integrates the InferredFS-1 with the data stored in <semanticDescriptor-1>, and applies the original SPARQL statement over the integrated data and match is obtained. As a result, <AE-2> will be included in the discvoery result. CSE-1 will continue to evaluate the next resource under <CSEBase> until it completes all the resource discovery processing.

Step 369: CSE-1 sends back the final discovery result to AE-1.

Discussed below is an alternative procedure of FIG. 33A, which may be considered a simplified version of what is shown in FIG. 33A. In this scenario, AE-1 (As an SU) may send a request to CSE-1 and intends to conduct semantic resource discovery. Note that, here semantic discovery is just an example and it may be another semantic operation, such as semantic query, etc. In particular, in this procedure, the Sematic Engine (SE) and Semantic Reasoner (SR) may be realized by CSE-1. Accordingly, during the resource discovery processing, CSE-1 may further utilize reasoning support in order to get an optimized discovery result.

FIG. 33B illustrates the alternative procedure of FIG. 33A and the detailed descriptions are as follows. At step 371: AE-1 intends to initiate a semantic resource discovery operation. At step 372: AE-1 may send a request to <CSEBase> of CSE-1 in order to initiate the semantic discovery operation, in which a SPARQL query statement is included. AE-1 may also indicate whether semantic reasoning may be used. For example, a new parameter may be carried in this request called useReasoning. There are multiple different ways of how to use this useReasoning parameter, such as the following cases:
Case 1: The first implementation is that useReasoning can be 0 or 1. When useReasoning=1, it means that AE-1 asks CSE-1 to apply semantic reasoning during the SPARQL processing, while useReasoning=0 (or when useReasoning parameter is not present in the request) means that AE-1 ask CSE-1 not to apply semantic reasoning. In this case, which reasoning rules to use is fully decided by the semantic engine or semantic reasoner, e.g., CSE-1 in this case).
Case 2: The second implementation is that useReasoning can be a URI (or a list of URIs), which refers one or more specific <reasoningRule> resource(s) that stores the reasoning rules to be used.
Case 3: The third implementation is that useReasoning can directly store a list of reasoning rules that AE-1 would like CSE-1 to use during the SPARQL processing.
Case 4: The forth implementation is that the useReasoning can be a string value, which indicates a specific standard SPARQL entailment regime. (Note that, SPARQL entailment is one type of semantic reasoning using standard reasoning rules as defined by different entailment regimes). For example, if useReasoning=“RDFS”, it means that AE-1 asks CSE-1 to apply the reasoning (which may be referred to as entailment herein) rules defined by RDFS entailment regime during the processing.

For the implementation choices, one can just implement one of above four cases, or can implement those four cases at the same time. For the latter case, a new parameter can be defined called typeofRulesRepresentation, which is a parameter included in the request and may have the following values and meanings:
typeofRulesRepresentation=1, the useReasoning parameter can be 0 or 1.
typeofRulesRepresentation=2, useReasoning parameter stores one or more URI(s).
typeofRulesRepresentation=3, useReasoning stores a list of reasoning rules.
typeofRulesRepresentation=4, useReasoning store a string value indicating a standard SPARQL entailment regime.

At step 373: Based on the request sent from AE-1, CSE-1 starts to conduct semantic resource discovery processing. For example, CSE-1 now starts to evaluate whether <AE-2> resource should be included in the discovery result by examining the <semanticDescriptor-1> child resource of <AE-2>. In particular, if CSE-1 have the capability to apply the semantic reasoning, CSE-1 may first decide whether semantic reasoning should be applied. Accordingly, it may also have the following operations based on the different cases as defined in step 372:
Case 1: When useReasoning=1, CSE-1 may decide an appropriate set of reasoning rules to be used.
Case 2: When useReasoning includes one or more URIs, CSE-1 may retrieve the reasoning rules stored in the related <reasoningRule> resources referenced by this parameter.
Case 3: When useReasoning directly stores a list of reasoning rules, then CSE-1 may use those reasoning rules for reasoning.
Case 4: When useReasoning is a string value, which may indicate a specific standard SPARQL entailment regime. Then, CSE-1 may use the reasoning rules defined by corresponding standard entailment regime during the processing.

In the case where AE-1 asks the certain type of reasoning while CSE-1 does not have such a capability, semantic reasoning operation may not be applied. For example, if AE-1 provides an error URI to CSE-1, CSE-1 may not apply reasoning since CSE-1 may not be able to retrieve the reasoning rules based on this error URI.

At step 374: Based on information stored in <semanticDescriptor-1> and the applied reasoning rules, CSE-1 may first execute a reasoning process and yields the inferred facts. Then, CSE-1 may integrate the inferred facts with the original data stored in <semanticDescriptor-1>, and then applies the original SPARQL statement over the integrated data. As a result, <AE-2> may be included in the discovery result. Then, CSE-1 may continue to evaluate next candidate resources until the discovery operations are completed. At step 375: CSE-1 may send back the final discovery result to AE-1.

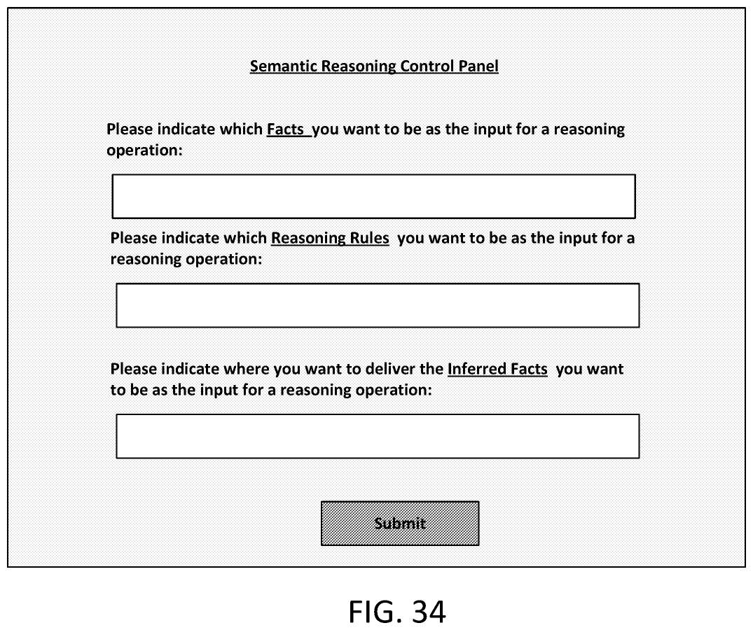

A GUI interface is provided in FIG. 34, which can be used for a user to view, configure, or trigger a semantic reasoning operation. For example, by using the UI as designed in FIG. 34, it allows a user to indicate which facts and which rules the user would like to use for a reasoning operation. For example, those facts and rules can be stored in the previously-defined <facts> or <reasoningRules> resources. The user may also indicate where to deliver the semantic reasoning rules (e.g., inferred facts). A user interface may be implemented for configuring or programming those parameters with default values, as well as control switches for enabling or disabling certain features for the semantic reasoning support.

The below Table 44 provides a description of the terminology used hereon.

TABLE 44

| | |
|---|---|
| Entailment | Entailment is the principle that under certain conditions |
| | the truth of one statement ensures the truth of a second |
| | statement. There are different “standard” entailment |
| | regimes as defined by W3C, e.g., RDF entailment, RDF |
| | Schema entailment, OWL 2 RDF-Based Semantics |
| | entailment, etc. In particular, each entailment regime |
| | defines a set of entailment rules W3C Entailment |
| | Regimes, https://www.w3.org/TR/sparq111-entailment/[8]. |
| Fact Consumer (FC) | This is a logical entity who retrieves a given FS that is |
| | available at SL. |
| Fact Host (FH) | This is a logical entity that can host a given FS. |
| Fact Modifier (FM) | This is a logical entity who makes modification/updates |
| | on an existing FS. |
| Fact Provider (FP) | This is a logical entity who creates a given FS and make it |
| | available at SL. |
| Fact Set (FS) | A Fact Set (FS) is a set of facts. When FS is involved with |
| | semantic reasoning, the FS can be further classified by |
| | InputFS and InferredFS. In particular, the InputFS is the |
| | FS which is used as input to a specific reasoning |
| | operation, and InferredFS is the semantic reasoning result |
| | (e.g., InferredFS includes the inferred facts). However, a |
| | given InferredFS generated by a reasoning operation A |
| | can be as an InputFS for a later reasoning operation B. |
| | InputFS can be further classified by Initial_InputFS and |
| | Addi_InputFS. For example, Initial_InputFS is provided |
| | by the Reasoning Initiator (RI) when it sends a request to |
| | Semantic Reasoner for triggering a semantic reasoning |
| | operation. Addi_InputFS is further provided/decided by |
| | the SR if additional facts should be used in the semantic |
| | reasoning operation. |
| Rule Consumer (RC) | This is a logical entity who retrieve a given Rule Set (RS) |
| | that is available at SL. |
| Rule Host (RH) | This is a logical entity that can host a given RS. |
| Reasoning | This is a logical entity/role, who can send a request to |
| Initiator (RI) | Semantic Reasoner in order to trigger a specific |
| | reasoning operation. |
| Rule Modifier (RM) | This is a logical entity who makes modification/updates |
| | on an existing RS. |
| Rule Provider (RP) | This is a logical entity who create a given RS and make it |
| | available at SL. |
| Rule Set (RS) | A Rule Set (RS) is a set of reasoning rules. RS can be |
| | further classified by Initial RS and Addi_RS. For |
| | example, Initial_RS is provided by the RI when it sends a |
| | request to SR for triggering a semantic reasoning |
| | operation. Addi_RS is further provided/decided by the SR |
| | if additional rules should be used in the semantic |
| | reasoning operation. |
| Semantic Operation | In this disclosure, the semantic operations are to refer to |
| | those operations other than the sematic reasoning |
| | operation. For example, it could refer to semantic resource |
| | discovery operation or semantic query operation. In |
| | oneM2M, semantic resource discovery is used to find |
| | resources in a CSE based on the semantic descriptions |
| | contained in the descriptor attribute of |
| | <semanticDescriptor> resources. Semantic queries enable |
| | the retrieval of both explicitly and implicitly derived |
| | information based on syntactic, semantic and structural |
| | information contained in data (such as RDF data). The |
| | result of a semantic query is the semantic |
| | information/knowledge for answering/matching the query. |
| | In this disclosure, it is considered that semantic reasoning |
| | is processed by a Semantic Reasoner (SR) while other |
| | semantic operations are processed by a Semantic Engine |
| | (SE). In particular, during the processing of a specific |
| | operation by SE, SE may further resort to an SR for |
| | reasoning support. |
| Semantic Reasoning | In general, semantic reasoning or inference means |
| | deriving facts that are not expressed in knowledge base |
| | explicitly. In other words, it is a mechanism to derive new |
| | implicit knowledge from existing knowledge base. |
| | Example: The data set (as initial facts/knowledge) to be |
| | considered may include the relationship (Flipper is-a |
| | Dolphin-A fact about an instance). An ontology may |
| | declare that “every Dolphin is also a Mammal-A fact |
| | about a concept”. If a Reasoning Rule is stating that “IF A |
| | is an instance of class B and B is a subclass of class C, |
| | THEN A is also an instance of class C”, then by applying |
| | this rule over the initial facts in terms of a reasoning |
| | operation, a new statement can be inferred: Flipper is-a |
| | Mammal, which is an implicit knowledge/fact derived |
| | based on reasoning, although that was not part of the |
| | initial facts. |
| Semantic | Typically, a Semantic Reasoner (SR) (reasoning engine, |
| Reasoner (SR) | rules engine, or simply a reasoner), is a piece of software |
| | able to infer logical consequences from a set of asserted |
| | facts using a set of reasoning rules. In addition, semantic |
| | reasoning or inference normally refers to the abstract |
| | process of deriving additional information while semantic |
| | reasoner refers to a specific code object that performs the |
| | reasoning tasks. When a SR receives a request for a |
| | specific reasoning operation, it will collect related facts |
| | (such as Initial_InputFS and Addi_InputFS) and related |
| | rules (such as Initial_RS and Addi_RS), conduct the |
| | reasoning process, and yield reasoning result, e.g., |
| | InferredFS. An SR (e.g., SR 232) may be a CSE |
| Semantic | This is a logical entity/role, who can send a request to SE |
| User (SU) | in order to trigger a semantic operation (such as a |
| | semantic resource discovery operation or a semantic |
| | query operation, etc.). |

Note that the disclosed subject matter may be applicable to other service layers. In addition, this disclosure uses SPARQL as an example language for specifying users' requirements/constraints. However, the disclosed subject matter may be applied for other cases where requirements or constraints of users are written using different languages other than SPARQL. As disclosed herein, “user” may be another device, such as server or mobile device.

Without in any way unduly limiting the scope, interpretation, or application of the claims appearing herein, a technical effect of one or more of the examples disclosed herein is to provide adjustments to semantic reasoning support operations. Generally, disclosed herein are systems, methods, or apparatuses that provide ways to trigger a reasoning operation at the service layer. When a semantic operation is triggered (such as a semantic resource discovery or semantic query), during the processing of a semantic operation (e.g., semantic resource discovery or semantic query), semantic reasoning may be leveraged as a background support (see FIG. 15) without a user device knowing (e.g., automatically without alerting a user device, such as an AE or CSE). In other words, for a given receiver (e.g., a CSE), when it receives requests from clients for semantic operations (such as sematnic discovery or query), the receiver may process those requests. In particular, during the processing, the receiver may further utilize semantic reasoning capabitly to optimize the processing (e.g., for discovery result to be more accurate).

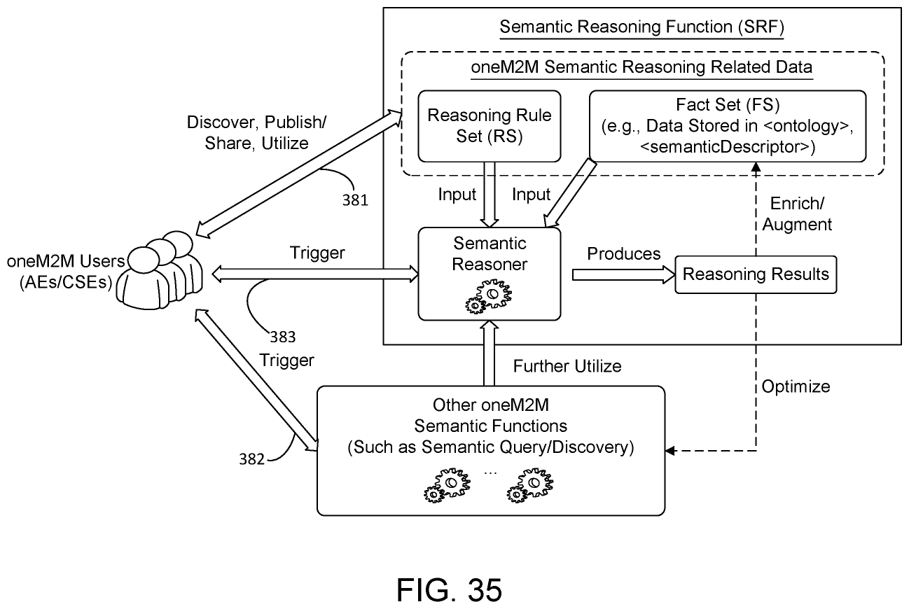

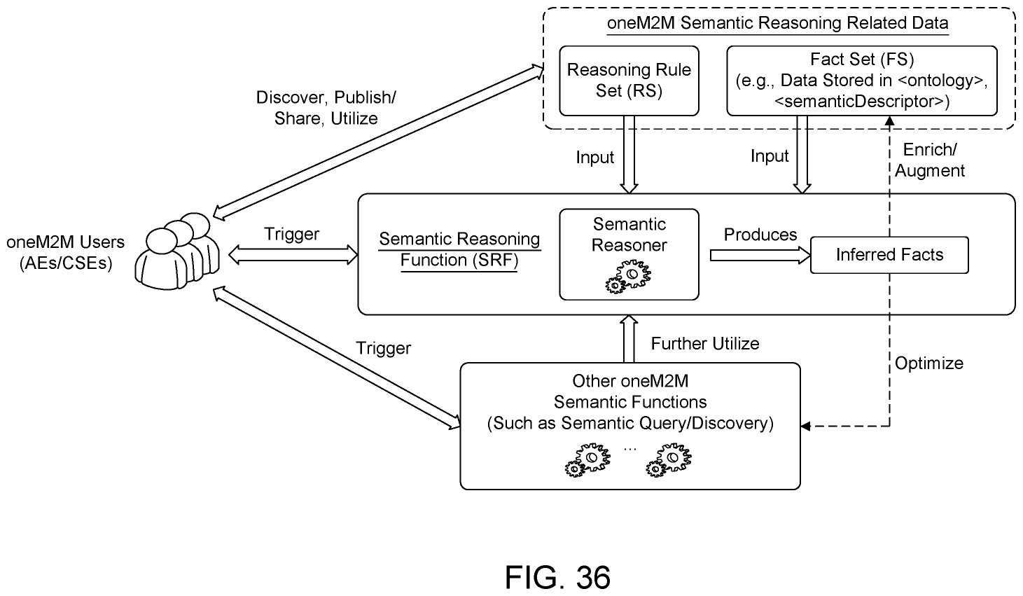

FIG. 35 shows an oneM2M example of FIG. 6. It can be seen that a new Semantic Reasoning Function (SRF) in oneM2M is defined and below is the detailed description of the key features of SRF and the different type of functionalities that SRF may support. FIG. 36 illustrates an alternative to FIG. 35. FIG. 36 is an alternative drawing of FIG. 35. The <facts> resource and <rules> resource out of the box of SRF (because <facts><rules> are resources, while SRF is a function).

Feature-1: Enabling semantic reasoning related data is discussed below. A functionality of Feature-1 may be to enable the semantic reasoning related data (referring to facts and reasoning rules) by making those data be discoverable, publishable (e.g., sharable) across different entities in oneM2M system (which is illustrated by arrow 381 in FIG. 35). The semantic reasoning related data can be a Fact Set (FS) or a Rule Set (RS). A FS refers to a set of facts. For example, each RDF triple can describe a fact, and accordingly a set of RDF triples stored in a <semanticDescriptor> resource is regarded as an FS. In general, a FS can be used as an input for a semantic reasoning process (e.g., an input FS) or it can be a set of inferred facts as the result of a semantic reasoning process (e.g., an inferred FS). A RS refers to a set of semantic reasoning rules.

To execute a specific semantic reasoning process A, the following two types of data inputs may be used: 1) An input FS (denoted as inputFS), and 2) A RS.

The output of the semantic reasoning process A may include: An inferred FS (denoted as inferredFS), which is the semantic reasoning results of reasoning process A.

Note that, the inferredFS generated by a reasoning process A may further be used as an inputFS for another semantic reasoning process B in the future. Therefore, in the following descriptions, the general term FS will be used if applicable.

The facts are not limited to semantic annotations of normal oneM2M resources (e.g., the RDF triples stored in <semanticDescriptor> resources). Facts may refer to any valuable information or knowledge that is made available in oneM2M system and may be accessed by others. For example, an ontology description stored in an oneM2M <ontology> resource can be a FS. Another case, a FS may also be an individual piece of information (such as the RDF triples describing hospital room allocation records as discussed in the previous use case in FIG. 5), and such a FS is not describing an ontology or not describing as semantic annotation of another resource (e.g., the FS describing hospital room allocation records can individually exist and not necessarily be as the semantic annotations of other resources).

With regard to the RS, users have needs to design many customized (or user-defined) semantic reasoning rules for supporting various applications, since oneM2M system is designed to be a horizontal platform that enables applications across different domains. Accordingly, various user-defined RSs may be made available in oneM2M system and not be accessed or shared by others. Note that, such user-defined semantic reasoning rules may improve the system flexibility since in many cases, the user-defined reasoning rules may just be used locally or temporarily (e.g., to define a new or temporary relationship between two classes in an ontology), which does not have to modify the ontology definition.

Overall, Feature-1 involves with enabling the publishing or discovering or sharing semantic reasoning related data (including both FSs and RSs) through appropriate oneM2M resources. The general flow of Feature-1 is that oneM2M users (as originator) may send requests to certain receiver CSEs in order to publish, discover, update, or delete the FS-related resources or RS-related resources through the corresponding CRUD operations. Once the processing is completed, the receiver CSE may send the response back to the originator.

Feature-2: Optimizing other semantic operations with background semantic reasoning support is disclosed below: As presented in the previous section associated with Feature-1, the existing semantic operations supported in oneM2M system (e.g., semantic resource discovery and semantic query) may not yield desired results without semantic reasoning support. A functionality of Feature-2 of SRF is to leverage semantic reasoning as a “background support” to optimize other semantic operations (which are illustrated by the arrows 382 in the FIG. 35). In this case, users trigger or initiate specific semantic operations (e.g., a semantic query). During the processing of this operation, semantic reasoning may be further triggered in the background, which is however fully transparent to the user. For example, a user may initiate a semantic query by submitting a SPARQL query to a SPARQL query engine. It is possible that the involved RDF triples (denoted as FS-1) cannot directly answer the SPARQL query. Accordingly, the SPARQL engine can further resort to a SR, which will conduct a semantic reasoning process. The SR shall determine and select the appropriate reasoning rule sets (as RS) and any additional FS if FS-1 (as inputFS) is insufficient, for instance, based on certain access rights. Finally, the semantic reasoning results in terms of inferredFS shall be delivered to the SPARQL engine, which can further be used to answer/match user's SPARQL query statement.

Still using the use case as presented in FIG. 5, the following two examples are discussed, which is to show how SRF can solved the issues as presented in those two examples in oneM2M system. The focused <Camera-11> resource is annotated with some metadata by adding a <semanticDescriptor> resource as its child resource. In particular, the <semanticDescriptor> child resource stores two RDF triples (as existing facts):
RDF Triple #1 (e.g. Fact-a): Camera-11 is-a ontologyA:VideoCamera (where

“VideoCamera” is a class defined by ontology A).
RFC Triple #2 (e.g. Fact-b): Camera-11 is-located-in Room-109-of-Building-1.

### Example 1

Consider that a user needs to retrieve real-time images from all the rooms. In order to so, the user first needs to first perform semantic resource discovery to identify the cameras using the following SPARQL Statement-I:

SELECT ?device
WHERE {
?device is-a ontologyB:VideoRecorder
}

In reality, it is very likely that the semantic annotation of <Camera-11> and SPARQL Statement-I may use different ontologies since they can be provided by different parties. For example, with respect to the semantic annotation of <Camera-11>, the ontology class “VideoCamera” used in Fact-a is from Ontology A. In comparison, the ontology class “VideoRecorder” used in SPARQL Statement-I is from another different Ontology B. Since semantic reasoning capability is missing, the system cannot figure out that ontologyA:VideoCamera is indeed as same as ontologyB:VideoRecorder. As a result, <Camera-11> resource cannot be identified as a desired resource during the semantic resource discovery process since the SPARQL processing is based on exact pattern matching (but in this example, the Fact-a cannot match the pattern “?device is-a ontologyB:VideoRecorder” in the SPARQL Statement-I).

### Example 2

A more complicated case is illustrated in this example, where the user just wants to retrieve real-time images from the rooms “belonging to a specific management zone (e.g., MZ-1)”. Then, the user may first perform semantic resource discovery using the following SPARQL Statement-II:

```
SELECT ?device
WHERE {
  ?device  is-a ontologyA:VideoCamera
  ?device  monitors-room-in  MZ-1
}
```

In Example-2 (similar to Example-1), due to the missing of semantic reasoning support, <Camera-11> resource cannot be identified as a desired resource either (at this time, Fact-a matches the pattern “?device is-a ontologyA:VideoCamera” in the SPARQL Statement-II, but Fact-b cannot match the pattern “?device monitors-room-in MZ-1”).

Example 2 also illustrates a critical semantic reasoning issue due to the lack of sufficient fact inputs for a reasoning process. For example, even if it is assumed that semantic reasoning is enabled and the following reasoning rule (e.g., RR-1) can be utilized:
RR-1: IF X is-located-in Y && Y is-managed-under Z, THEN X monitors-room-in Z

Still, no inferred fact can be derived by applying RR-1 over Fact-Y through a semantic reasoning process. The reason is that Fact-b may just match the “X is-located-in Y” part in RR-1 (e.g., to replace X with <Camera-11> and replace Y with “Room-109-of-Building-1”). However, in addition to Fact-a and Fact-b, there is no further fact can be utilized to match “Y is-managed-under Z” part in RR-1 (e.g., there is no sufficient facts for using RR-1). In fact, the fact missing here is about hospital room allocation. The hospital room allocation records could be a set of RDF triples defining which rooms belong to which MZs, e.g., the following RDF triple describes that Room-109 of Building-1 belongs to MZ-1:
Fact-c: Room-109-of-Building-1 is-managed-under MZ-1
. . .
Without Fact-c, semantic reasoning still cannot help in this example due to lack of sufficient facts as the inputs of reasoning process.

By leveraging Feature-2, SRF can address the issue as illustrated in Example-1 now. For example, a Reasoning Rule (RR-2) can be defined as:
RR-2: IF X is an instance of ontologyA:VideoCamera, THEN X is also an instance of ontologyB:VideoRecorder.

Here X is a variable and will be replaced by a specific instance (e.g., <Camera-11> in Example-1) during the reasoning process. When the SPARQL engine is processing the SPARQL Statement-I, it can further trigger a semantic reasoning process at the Semantic Reasoner (SR), which will apply the RR-2 (as RS) over the Fact-a (as inputFS). A inferredFS can be produced, which includes the following new fact:
Inferred Fact-a: Camera-11 is-a ontologyB:VideoRecorder

The SPARQL engine now is able to use Inferred Fact-a to match the pattern “?device is-a ontologyB:VideoRecorder” in the SPARQL Statement-I. As a result, with the help of SRF, <Camera-11> resource can now be identified as a desired resource during the semantic resource discovery.

The Feature-2 of SRF can also address the issue as illustrated in Example-2. For example, when the SPARQL engine processes SPARQL Statement-II, it can further trigger a semantic reasoning process at the SR. In particular, the SR determines that RR-1 (as RS) should be utilized. In the meantime, the local policy of SR may be configured that in order to successfully apply the RR-1, the existing Fact-b is not sufficient and additional Fact-c should also be used as the input of the reasoning process (e.g., Fact-c is a hospital room allocation record defining that Room-109 of Building-1 belongs to MZ-1). In this case, inputFS is further categorized into two parts: initial_InputFS (e.g., Fact-b) and additional InputFS (e.g., Fact-c). As a result, by applying RR-1 over “the combined inputFS” (e.g., Fact-b and Fact-c), an inferredFS can be produced, which includes the following new fact:
Inferred Fact-b: Camera-11 monitors-room-in MZ-1

The SPARQL engine now is able to further use Inferred Fact-c to match the query pattern “?device monitors-room-in MZ-1” in SPARQL Statement-II. As a result, <Camera-11> now can be successfully identified in the semantic resource discovery operation in Example-2.

Overall, the general flow of Feature-2 is that oneM2M users (as originator) can send requests to certain receiver CSEs for the desired semantic operations (such as semantic resource discovery, semantic query, etc.). During the request processing, the receiver CSE can further leverage reasoning capability. By using the reasoning result, the receiver CSE will further produce the final result for the semantic operation as requested by the originator (e.g., the semantic query result, or semantic discovery result) and then send the response back to the originator.

Feature-3: Enabling individual semantic reasoning process is disclosed below: In addition to the use cases as supported by Feature-2, semantic reasoning process may also be triggered individually by oneM2M users (which are illustrated by arrows 383 in the FIG. 35). In other words, the semantic reasoning process is not necessarily coupled with other semantic operations as considered in Feature-2). With Feature-3, oneM2M users may directly interact with SRF by triggering semantic reasoning process. In order to do so, oneM2M user shall first identify the interested facts (as initial_inputFS) as well as the desired reasoning rules (as RS) based on their application needs. When the inputFS and RS are identified, the oneM2M user shall send a request to SR for triggering a specific semantic reasoning process by specifying the reasoning inputs (e.g., the identified initial_inputFS and RS). The SR may initiate a semantic reasoning process based on the inputs as indicated by the user. Similar to Feature-2, the SR may also determine what additional FS or RS needs to be leveraged if the inputs from the user are insufficient. Once the SR works out the semantic reasoning result, it will be returned back to the oneM2M user for its need. Typically, the following cases can be supported by Feature-3.

In a first case (Case-1), the oneM2M user may use SRF to conduct semantic reasoning over the low-level data in order to obtain high-level knowledge. For example, a company sells a health monitoring product to the clients and this product in fact leverage semantic reasoning capability. In this product, one of the piece is a health monitoring app (acting as an oneM2M user). This app can ask SRF to perform a semantic reasoning process over the real-time vital data (such as blood pressure, heartbeat, etc.) collected from a specific patent A by using a heart-attack diagnosis/prediction reasoning rule. In this process, the heart-attack diagnosis/prediction reasoning rule is a user-defined rule, which can be highly customized based on patient A's own health profile and his/her past heart-attack history. In this way, the health monitoring application does not have to deal with the low-level vital data (e.g., blood pressure, heart beat, etc.), and can get away from the determination of patient A's heart-attack risk (since all the diagnosis/prediction business logics have already been defined in the reasoning rule used by SRF). As a result, the health monitoring app just needs to utilize the reasoning result (e.g., the patient A's current heart-attack risk, which is a “ready-to-use or high-level” knowledge) and send an alarm to doctor or call 911 for an ambulance if needed.

In a second case (Case-2), the oneM2M user may use SRF to conduct semantic reasoning to enrich the existing data. Still using the Example-1 as an example, an oneM2M user (e.g., the owner of the Camera-11) may proactive trigger a semantic reasoning process over the semantic annotation of <Camera-11> (e.g., Fact-a and Fact-b as existing facts) by using Feature-3 and RR-2. The semantic reasoning result (e.g., Inferred Fact-a) is also a low-level semantic metadata about <Camera-11> and is a long-term-effective fact; therefore, such new/inferred fact can be further added/integrated into the semantic annotations of <Camera-11>. In other words, the existing facts now is “enriched or augmented” by the inferred fact. As a result, <Camera-11> can get more chance to be discovered by future semantic resource discovery operations. Another advantage from such enrichment is that future semantic resource discovery operations do not have to further trigger semantic reasoning in the background every time as supported by Feature-2, which helps reduce processing overhead and response delay. However, it is worth noting that it might not be applicable for integrating the inferred facts with existing facts in all the use cases. Taking the Example-2 as an example, the Inferred Fact-b (e.g., “Camera-11 monitors-room-in MZ-1”) is relatively high-level knowledge, which may not be appropriate to be integrated with low-level semantic metadata (e.g., Fact-a and Fact-b). In the meantime, since the hospital room allocation may get re-arranged from time to time, the Inferred Fact-b may just be a short-term-effective fact. For instance, after a recent room re-allocation, Camera-11 does not monitor a room belonging to MZ-1 although Camera-11 is still located in Room-109 of Building-1 (e.g., Fact-a and Fact-b are still valid) but this room is now used for another purpose and then belongs to a different MZ (e.g., Inferred Fact-b is no longer valid anymore and needs to be deleted). Therefore, it does not make sense to directly integrate such type of inferred fact or knowledge into the semantic annotations of massive cameras, otherwise it potentially leads to considerable annotation update overhead. It can be seen that both Feature-2 and Feature-3 are the necessary features of SRF and each of them is to support different user cases respectively.

Overall, the general flow of Feature-3 is that oneM2M users (as originator) can send requests to certain receiver CSEs that has the reasoning capability. Accordingly, the receiver CSE will conduct a reasoning process by using the desired inputs (e.g., inputFS and RS) and produce the reasoning result and finally send the response back to the originator.

Disclosed herein is additional considerations associated with this disclosure. Many concepts, terms, names may have equivalent names. Therefore, below is an exemplary list in Table 45.

TABLE 45
Reasoning Rule Set (RS): Rule Inputs,
Fact Set (FS): Knowledge Set (KS)
Set: the term “Set” can be replaced with any term like a container, such as list, etc.
Fact: the term “Fact” can be replaced with a term describing a fact, such as a knowledge,
information, an observation, an assertion.
Input FS: Input Facts, Fact Inputs
Additional input FS: Complemental input FS.
Semantic Reasoning Function (SRF): Semantic Reasoning Service (SRS).
Inferred facts: Inferred Knowledge, Derived Knowledge, Derived Facts, Output Facts,
Reasoning Output, Reasoning Result.
Reasoning Process: Reasoning Instance, Reasoning Job, Reasoning Task.
Reasoning Initiator (RI): Reasoning User, SRF Customer, SRF Client, Reasoning Client,
Reasoning Requestor
Reasoning Rule: Inference Rule, Entailment Rule
Semantic Reasoner: Reasoning Engine, Entailment Engine

FIG. 37A is a diagram of an example machine-to machine (M2M), Internet of Things (IoT), or Web of Things (WoT) communication system 10 in which one or more disclosed concepts associated with enabling a semantics reasoning support operation may be implemented (e.g., FIG. 7-FIG. 15 and accompanying discussion). Generally, M2M technologies provide building blocks for the IoT/WoT, and any M2M device, M2M gateway or M2M service platform may be a component of the IoT/WoT as well as an IoT/WoT service layer, etc.

As shown in FIG. 37A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 37A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain includes M2M gateways 14 and terminal devices 18. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. The M2M gateway device 14 allows wireless M2M devices (e.g. cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN (e.g., Zigbee, 6LoWPAN, Bluetooth), direct radio link, and wireline for example.

Referring to FIG. 37B, the illustrated M2M service layer 22 in the field domain provides services for the M2M application 20, M2M gateway devices 14, and M2M terminal devices 18, and the communication network 12. It will be understood that the M2M service layer 22 may communicate with any number of M2M applications, M2M gateway devices 14, M2M terminal devices 18, and communication networks 12 as desired. The M2M service layer 22 may be implemented by one or more servers, computers, or the like. The M2M service layer 22 provides service capabilities that apply to M2M terminal devices 18, M2M gateway devices 14 and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices and M2M terminal devices. The M2M service layer 22′ may interact with a service layer by a different service provider. The M2M service layer 22′ may be implemented by one or more servers, computers, virtual machines (e.g., cloud/computer/storage farms, etc.) or the like.

Referring also to FIG. 37B, the M2M service layer 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

In some examples, M2M applications 20 and 20′ may include desired applications that communicate using semantics reasoning support operations, as disclosed herein. The M2M applications 20 and 20′ may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geofencing, device/service discovery, and legacy systems integration, and provides these functions as services to the M2M applications 20 and 20′.

The semantics reasoning support operation of the present application may be implemented as part of a service layer. The service layer is a middleware layer that supports value-added service capabilities through a set of application programming interfaces (APIs) and underlying networking interfaces. An M2M entity (e.g., an M2M functional entity such as a device, gateway, or service/platform that is implemented on hardware) may provide an application or service. Both ETSI M2M and oneM2M use a service layer that may include the semantics reasoning support operation of the present application. The oneM2M service layer supports a set of Common Service Functions (CSFs) (e.g., service capabilities). An instantiation of a set of one or more particular types of CSFs is referred to as a Common Services Entity (CSE), which can be hosted on different types of network nodes (e.g., infrastructure node, middle node, application-specific node). Further, the semantics reasoning support operation of the present application may be implemented as part of an M2M network that uses a Service Oriented Architecture (SOA) or a resource-oriented architecture (ROA) to access services such as the semantics reasoning support operation of the present application.

As disclosed herein, the service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications or various devices with access to a collection of or a set of the above mentioned capabilities or functionalities, supported by the service layer, which can be referred to as a CSE or SCL. A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware or software and that provides (service) capabilities or functionalities exposed to various applications or devices (e.g., functional interfaces between such functional entities) in order for them to use such capabilities or functionalities.

FIG. 37C is a system diagram of an example M2M device 30, such as an M2M terminal device 18 (which may include AE 331) or an M2M gateway device 14 (which may include one or more components of FIG. 13 through FIG. 15), for example. As shown in FIG. 37C, the M2M device 30 may include a processor 32, a transceiver 34, a transmit/receive element 36, a speaker/microphone 38, a keypad 40, a display/touchpad 42, non-removable memory 44, removable memory 46, a power source 48, a global positioning system (GPS) chipset 50, and other peripherals 52. It will be appreciated that the M2M device 30 may include any sub-combination of the foregoing elements while remaining consistent with the disclosed subject matter. M2M device 30 (e.g., CSE 332, AE 331, CSE 333, CSE 334, CSE 335, and others) may be an exemplary implementation that performs the disclosed systems and methods for semantics reasoning support operations.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, or any other functionality that enables the M2M device 30 to operate in a wireless environment. The processor 32 may be coupled with the transceiver 34, which may be coupled with the transmit/receive element 36. While FIG. 37C depicts the processor 32 and the transceiver 34 as separate components, it will be appreciated that the processor 32 and the transceiver 34 may be integrated together in an electronic package or chip. The processor 32 may perform application-layer programs (e.g., browsers) or radio access-layer (RAN) programs or communications. The processor 32 may perform security operations such as authentication, security key agreement, or cryptographic operations, such as at the access-layer or application layer for example.

The transmit/receive element 36 may be configured to transmit signals to, or receive signals from, an M2M service platform 22. For example, the transmit/receive element 36 may be an antenna configured to transmit or receive RF signals. The transmit/receive element 36 may support various networks and air interfaces, such as WLAN, WPAN, cellular, and the like. In an example, the transmit/receive element 36 may be an emitter/detector configured to transmit or receive IR, UV, or visible light signals, for example. In yet another example, the transmit/receive element 36 may be configured to transmit and receive both RF and light signals. It will be appreciated that the transmit/receive element 36 may be configured to transmit or receive any combination of wireless or wired signals.

In addition, although the transmit/receive element 36 is depicted in FIG. 37C as a single element, the M2M device 30 may include any number of transmit/receive elements 36. More specifically, the M2M device 30 may employ MIMO technology. Thus, in an example, the M2M device 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the M2M device 30, such as on a server or a home computer. The processor 32 may be configured to control lighting patterns, images, or colors on the display or indicators 42 in response to whether the semantics reasoning support operations in some of the examples described herein are successful or unsuccessful (e.g., obtaining semantic reasoning resources, etc.), or otherwise indicate a status of semantics reasoning support operation and associated components. The control lighting patterns, images, or colors on the display or indicators 42 may be reflective of the status of any of the method flows or components in the FIG.'s illustrated or discussed herein (e.g., FIG. 6-FIG. 36, etc). Disclosed herein are messages and procedures of semantics reasoning support operation. The messages and procedures may be extended to provide interface/API for users to request service layer related information via an input source (e.g., speaker/microphone 38, keypad 40, or display/touchpad 42). In an addition example, there may be a request, configure, or query of semantics reasoning support, among other things that may be displayed on display 42.

The processor 32 may receive power from the power source 48, and may be configured to distribute or control the power to the other components in the M2M device 30. The power source 48 may be any suitable device for powering the M2M device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled with the GPS chipset 50, which is configured to provide location information (e.g., longitude and latitude) regarding the current location of the M2M device 30. It will be appreciated that the M2M device 30 may acquire location information by way of any suitable location-determination method while remaining consistent with information disclosed herein.

The processor 32 may further be coupled with other peripherals 52, which may include one or more software or hardware modules that provide additional features, functionality or wired or wireless connectivity. For example, the peripherals 52 may include various sensors such as an accelerometer, biometrics (e.g., fingerprint) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The transmit/receive elements 36 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The transmit/receive elements 36 may connect to other components, modules, or systems of such apparatuses or devices via one or more interconnect interfaces, such as an interconnect interface that may comprise one of the peripherals 52.

FIG. 37D is a block diagram of an exemplary computing system 90 on which, for example, the M2M service platform 22 of FIG. 37A and FIG. 37B may be implemented. Computing system 90 (e.g., M2M terminal device 18 or M2M gateway device 14) may comprise a computer or server and may be controlled primarily by computer readable instructions by whatever means such instructions are stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 or coprocessor 81 may receive, generate, and process data related to the disclosed systems and methods for semantics reasoning support operation, such as obtaining semantic reasoning resources.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled with system bus 80 include random access memory (RAM) 82 and read only memory (ROM) 93. Such memories include circuitry that allows information to be stored and retrieved. ROMs 93 generally include stored data that cannot easily be modified. Data stored in RAM 82 can be read or changed by CPU 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may include peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include network adaptor 97 that may be used to connect computing system 90 to an external communications network, such as network 12 of FIG. 37A and FIG. 37B.

It is understood that any or all of the systems, methods and processes described herein may be embodied in the form of computer executable instructions (e.g., program code) stored on a computer-readable storage medium which instructions, when executed by a machine, such as a computer, server, M2M terminal device, M2M gateway device, or the like, perform or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not include signals per se. As evident from the herein description, storage media should be construed to be statutory subject matter. Computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which can be used to store the desired information and which can be accessed by a computer. A computer-readable storage medium may have a computer program stored thereon, the computer program may be loadable into a data-processing unit and adapted to cause the data-processing unit to execute method steps when semantics reasoning support operations of the computer program is run by the data-processing unit.

In describing preferred methods, systems, or apparatuses of the subject matter of the present disclosure—enabling a semantics reasoning support operation—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples to disclose the subject matter, including the best mode, and also to enable any person skilled in the art to practice the claimed subject matter, including making and using any devices or systems and performing any incorporated methods. The patentable scope of the subject matter is defined by the claims, and may include other examples that occur to those skilled in the art (e.g., skipping steps, combining steps, or adding steps between exemplary methods disclosed herein). For example, step 344 may be skipped. In another example, steps 204 and steps 205 may be skipped or added. Such other examples are intended to be within the scope of the claims if they have structural elements that do not differ from the literal language of the claims, or if they include equivalent structural elements with insubstantial differences from the literal languages of the claims.

Methods, systems, and apparatuses, among other things, as described herein may provide for means for providing or managing service layer semantics with reasoning support. A method, system, computer readable storage medium, or apparatus has means for obtaining a message comprising a semantic reasoning request and information about a first fact set and information about a first rule set; based on the message, retrieving the first fact set and the first rule set; inferring an inferred fact based on the first fact set and the first rule set; and providing instructions to store the inferred fact set on the apparatus for a subsequent semantic operations. The information about the first fact set may include a uniform resource identifier to the first fact set. The information about the first fact set may include the ontology associated with the first fact set. The determining whether to use a second fact set or a second rule set may be further based on the information about the first fact set matching an ontology associated with the first rule set. The determining whether to use a second fact set or a second rule set may be further based on the information about the first fact set matching a keyword in a configuration table of the apparatus. The operations may further include inferring an inferred fact based on the first fact set and the first rule set. The subsequent semantic operation may include a semantic resource discovery. The subsequent semantic operation may include a semantic query. The apparatus may be a semantic reasoner (e.g., a common service entity). All combinations in this paragraph (including the removal or addition of steps) are contemplated in a manner that is consistent with the other portions of the detailed description.

1. An apparatus for semantics reasoning in a service layer, the apparatus comprising:
a processor; and
a memory coupled with the processor, the memory comprising executable instructions stored thereon that when executed by the processor cause the processor to effectuate operations comprising:
obtaining a message comprising a semantic reasoning request and information about a first fact set and information about a first rule set;
based on the message, retrieving the first fact set and the first rule set;
inferring an inferred fact based on the first fact set and the first rule set; and
providing instructions to store the inferred fact set on the apparatus for a subsequent semantic operation.

2. The apparatus of claim 1, wherein the information about the first fact set comprises a uniform resource identifier to the first fact set.

3. The apparatus of claim 1, wherein the information about the first fact set comprises an ontology associated with the first fact set.

4. The apparatus of claim 1, the operations further comprising based on the retrieved first fact set and the first rule set, determining whether to use a second fact set or a second rule set.

5. The apparatus of claim 1, the operations further comprising based on information about the first fact set matching an ontology associated with the first rule set, determining whether to use a second fact set or a second rule set.

6. The apparatus of claim 1, the operations further comprising based on information about the first fact set matching a keyword in a configuration table of the apparatus, determining whether to use a second fact set or a second rule set.

7. The apparatus of claim 1, wherein the subsequent semantic operation comprises a semantic resource discovery.

8. The apparatus of claim 1, wherein the subsequent semantic operation comprises a semantic query.

9. The apparatus of claim 1, wherein the apparatus is a semantic reasoner.

10. A method for semantics reasoning in a service layer, the method comprising:
obtaining, by a common service entity, a message comprising a semantic reasoning request and information about a first fact set and information about a first rule set;
based on the message, retrieving the first fact set and the first rule set;
inferring an inferred fact based on the first fact set and the first rule set; and
providing instructions to store the inferred fact set on the common service entity for a subsequent semantic operation.

11. The method of claim 10, wherein the information about the first fact set comprises an ontology associated with the first fact set.

12. The method of claim 10, further comprising based on the retrieved first fact set and the first rule set, determining whether to use a second fact set or a second rule set.

13. The method of claim 10, further comprising based on information about the first fact set matching an ontology associated with the first rule set, determining whether to use a second fact set or a second rule set.

14. The method of claim 10, further comprising based on information about the first fact set matching a keyword in a configuration table of the common service entity, determining whether to use a second fact set or a second rule set.

15. A system comprising:
one or more processors; and
memory coupled with the one or more processors, the memory comprising executable instructions stored thereon that when executed by the one or more processors cause the one or more processors to effectuate operations comprising:
obtaining a message comprising a semantic reasoning request and information about a first fact set and information about a first rule set;
based on the message, retrieving the first fact set and the first rule set;
inferring an inferred fact based on the first fact set and the first rule set; and
providing instructions to store the inferred fact set on the apparatus for a subsequent semantic operation.

16. The system of claim 15, wherein the information about the first fact set comprises a uniform resource identifier to the first fact set.

17. The system of claim 15, wherein the information about the first fact set comprises an ontology associated with the first fact set.

18. The system of claim 15, the operations further comprising based on the retrieved first fact set and the first rule set, determining whether to use a second fact set or a second rule set.

19. The system of claim 15, the operations further comprising based on information about the first fact set matching an ontology associated with the first rule set, determining whether to use a second fact set or a second rule set.

20. The system of claim 15, the operations further comprising based on information about the first fact set matching a keyword in a configuration table of the apparatus, determining whether to use a second fact set or a second rule set.
